(19) United States
(12) Patent Application Publication
(10) Pub. No.: US 2015/0011668 A1
(43) Pub. Date: Jan. 8, 2015

(54) NANOSTRUCTURED MATERIALS AND METHODS OF MAKING THE SAME

(71) Applicant: 3M INNOVATION PROPERTIES COMPANY, St. Paul, MN (US)

(72) Inventors: William B. Kolb, West Lakeland, MN (US); Brant U. Kolb, St. Paul, MN (US); Samuel J. Carpenter, St. Paul, MN (US); Lindsay E. Corcoran, St. Paul, MN (US); Taylor K. Hodne, St. Paul, MN (US); Hui Luo, St. Paul, MN (US); Kari A. McGee, New Brighton, MN (US); Ta-Hua Yu, Woodbury, MN (US)

(73) Assignee: 3M INNOVATIVE PROPERTIES COMPANY, St. Paul, MN (US)

(21) Appl. No.: 14/375,143

(22) PCT Filed: Jan. 25, 2013
(86) PCT No.: PCT/US2013/023141

§ 371 Date: Jul. 29, 2014

Related U.S. Application Data
(60) Provisional application No. 61/593,666, filed on Feb. 1, 2012.

(51) Int. Cl. C08K 9/06; C09D 5/00; C09D 7/12; G02B 1/11; G02B 1/10

(52) U.S. Cl. CPC C08K 9/06; G02B 1/111; G02B 1/105; C09D 7/1225; C09D 5/006; C08K 2201/005
USPC 522/172; 524/547

(57) ABSTRACT

Material comprising submicrometer particles dispersed in a polymeric matrix. The materials are useful in article, for example, for numerous applications including display applications (e.g., liquid crystal displays (LCD), light emitting diode (LED) displays, or plasma displays); light extraction; electromagnetic interference (EMI) shielding, ophthalmic lenses; face shielding lenses or films; window films; antireflection for construction applications; and construction applications or traffic signs.

### CROSS REFERENCE TO RELATED APPLICATION

This application claims the benefit of U.S. Provisional Patent Application No. 61/593,666, filed Feb. 1, 2012, the disclosure of which is incorporated by reference herein in its entirety.

### BACKGROUND

A wide range of uses for coatings possessing a surface nanostructure has been envisioned. Potential applications range from creation of low reflection transparent films, superhydrophilc or superhydrophobic coatings, antifog coatings, coatings to alter the coefficient of friction of a surface, and coatings with increased scratch resistance. Affected industries include fast growing markets such as consumer electronics, renewable energy and energy conservation. The interaction of surface structure and intrinsic material properties also allows for the creation of coatings that combine several of these applications together.

When light travels from one medium to another, some portion of the light is reflected from the interface between the two media. For example, typically about 4-5% of the light shining on a clear plastic substrate is reflected at the top surface.

The back lighting for mobile hand held and laptop devices are not effective to provide desired display quality in the presence of the reflection of the external lighting from the top surface and internal interfaces of the display devices, which in turn reduces contrast ratio and can downgrade viewing quality from the interfering image of external objects.

Different approaches have been employed to reduce the reflection of the top surface of display devices. One approach is to use antireflective coatings such as multilayer reflective coatings consisting of transparent thin film structures with alternating layers of contrasting refractive index to reduce reflection. However, it can be difficult to achieve broadband antireflection using the multilayer antireflective coating technology.

Another approach involves using subwavelength surface structure (e.g. subwavelength scale surface gratings) for broadband antireflection. Methods for creating the subwavelength surface structure (e.g., by lithography) tend to be relatively complicated and expensive. Additionally, it can be challenging to obtain durable antireflection surface from the subwavelength scale surface gratings for front surface applications.

Antireflective and antiglare solutions had been developed to reduce the specular reflection of display devices. However, the hybrid antireflective antiglare surface has a structural dimension close to the wavelengths of visible light spectrum and therefore can induce higher haze (i.e., >4%) to reduce display quality.

### SUMMARY

A subwavelength structured surface gradient solution is therefore desired. Preferably, the solution provides a relatively low reflection (i.e., average reflection over the visible range less than, less than 2.0 (in some embodiments, less than 1.5, or even less than 1.0) percent) and durable characteristics to enhance the viewing quality of display devices.

In one aspect, the present disclosure describes a material comprising submicrometer particles dispersed in a polymeric matrix, the material having a thickness, at least first and second integral regions across the thickness, the first region having the outer major surface wherein at least the outer most submicrometer particles are partially conformally coated by (and optionally covalently bonded to) the polymeric matrix, wherein the first and second regions have first and second average densities, respectively, and wherein the first average density is less than the average second density. In some embodiments, the difference between the first and second average densities is in a range from 0.1 g/cm³ to 0.8 g/cm³ (in some embodiments, 0.2 g/cm³ to 0.7 g/cm³, or even 0.3 g/cm³ to 0.6 g/cm³). In some embodiments, the second region is substantially free of closed porosity (i.e., free of than closed pores greater than 200 nm (in some embodiments, greater than 150 nm, 100 nm, or even greater than 50 nm) in diameter). In some embodiments, the submicrometer particles each have an outer surface, and wherein at least 50 (in some embodiments, at least 60, 70, 75, 80, 90, 95, 99, or even 100) percent by volume of the submicrometer particles have their outer surface is free of fluorine. In some embodiments, the material having a Steel Wool Scratch Test value of at least 1 (in some embodiments, of at least 2, 3, 4, or even 5). In some embodiments, the submicrometer particles dispersed in the polymeric matrix has an average particle size, and the first region has a thickness less than (in some embodiments equal to; in some embodiments, greater than; in some embodiments, at least twice; in some embodiments three to five times) the average particle size of the submicrometer particles.

In another aspect, the present disclosure describes a material comprising submicrometer particles dispersed in a polymeric matrix, the material having a thickness, at least first and second integral regions across the thickness, wherein the first and second regions have first and second densities, respectively, and wherein the first average density is less than the second average density, and wherein the material having a Steel Wool Scratch Test value of at least 1 (in some embodiments, of at least 2, 3, 4, or 5). In some embodiments, the first region having the outer major surface, wherein at least the outer most submicrometer particles are partially conformally coated with the polymeric matrix. In some embodiments, the submicrometer particles are covalently bonded to the polymeric matrix. In some embodiments, the second region is substantially free of closed porosity. In some embodiments, the submicrometer particles each have an outer surface, and wherein at least 50 (in some embodiments, at least 60, 70, 75, 80, 90, 95, 99, or even 100) percent by volume of the submicrometer particles have their outer surface is free of fluorine. In some embodiments, the submicrometer particles dispersed in the polymeric matrix has an average particle size, and the first region has a thickness less than (in some embodiments equal to; in some embodiments, greater than; in some embodiments, at least twice; in some embodiments three to five times) the average particle size of the submicrometer particles.

In another aspect, method of making a material having a structured surface (including materials described in the preceding paragraphs, and variations thereof described herein), the method comprising:

providing a free radical curable layer having submicrometer particles dispersed therein; and

actinic radiation curing (e.g., UV curing and e-beam curing) the free radical curable layer in the presence of a sufficient amount of inhibitor gas (e.g., oxygen and air) to inhibit the curing of a major surface region of the layer

to provide a layer having a bulk region with a first degree of cure and a major surface region having a second degree of cure, wherein the first degree of cure is greater than the second degree of cure, and wherein the material has a structured surface that includes a portion of the submicrometer particles.

Optionally, articles described herein further comprise a functional layer (e.g., at least one of a transparent conductive layer, a gas barrier layer, antistatic layer, or primer layer) disposed between the first major surface of a substrate and a layer of material described herein. Optionally, articles described herein further comprise a functional layer (e.g., at least one of a transparent conductive layer, a gas barrier layer, antistatic layer, or primer layer) disposed on a layer of material described herein.

Optionally, articles described herein further comprise a (second) layer of material (including a described herein and those described in PCT Appl. Nos. US2011/026454, filed Feb. 28, 2011, and U.S. Pat. Appl. Nos. 61/452,403 and 61/452,430, filed Mar. 14, 2011, the disclosures of which are incorporated herein by reference) on the second major surface of a substrate. Optionally, articles described herein further comprise a functional layer (i.e., at least one of a transparent conductive layer or a gas barrier layer) disposed between the second major surface of a substrate and a (second) layer of material. Optionally, articles described herein further comprise a functional layer (i.e., at least one of a transparent conductive layer or a gas barrier layer) disposed on a (second) layer of material.

Articles described herein can be used, for example, for creating high performance, low fringing, antireflective optical articles. When a functional layer is disposed on a layer of material described herein, articles described herein may have, for example, further desired optical properties.

Embodiments of articles described herein are useful for numerous applications including display applications (e.g., liquid crystal displays (LCD), light emitting diode (LED) displays, or plasma displays); light extraction; electromagnetic interference (EMI) shielding, ophthalmic lenses; face shielding lenses or films; window films; antireflection for construction applications; and construction applications or traffic signs. Articles described herein are also useful for solar applications (e.g., solar films). They may also be useful, for example, as the front surface of solar thermal hot liquid/air heat panels or any solar energy absorbing device; for solar thermal absorbing surfaces having micro- or macro-columns with additional nano-scale surface structure; for the front surface of flexible solar photovoltaic cells made with amorphous silica photovoltaic cells or CIGS photovoltaic cells; and for the front surface of a film applied on top of flexible photovoltaic cells.

### BRIEF DESCRIPTION OF THE DRAWINGS

FIG. 1 is a schematic view of an exemplary process for making an exemplary nanostructured material described herein;

FIG. 2 is a scanning electron microscope (SEM) digital photomicrograph of an exemplary nanostructured material described herein;

FIG. 3A is a schematic view of an exemplary process for making an exemplary nanostructured material described herein;

FIG. 3B is a schematic view of a polymerization section of FIG. 3A;

FIG. 3C is a schematic view of two uncoupled polymerization sections in series of FIG. 3A;

FIG. 3D is a schematic view of two coupled polymerization sections in of FIG. 3A;

FIG. 4A is a scanning electron microscope digital photomicrograph at (top view) of Comparative Example 1-1;

FIG. 4B is a scanning electron microscope digital photomicrograph at (cross section view) of Comparative Example 1-1;

FIG. 5A is a scanning electron microscope digital photomicrograph at (top view) of Example 1-6;

FIG. 5B is a scanning electron microscope digital photomicrograph at (cross section view) of Example 1-6;

FIG. 6A is a scanning electron microscope (top view) digital photomicrograph of Comparative Example 12A-1;

FIG. 6B is a scanning electron microscope digital photomicrograph (top view) of Example 12A-3;

FIG. 7 is a plot of % Reflection versus wavelength for Example 15;

FIG. 8A is a stitch surface profile of a two scale microstructure and nanostructured material (Example 16A-3); and

FIG. 8B is a scanning electron microscope digital photomicrograph of a two scale microstructure and nanostructure material (Example 16A-3).

### DETAILED DESCRIPTION

An exemplary process and apparatus for making nanostructured articles described herein is described. The process is directed to polymerization of curable resin and submicrometer particle mixtures in a controlled inhibitor gas environment. The material can be polymerized using actinic radiation. A solution including radically curable prepolymers, submicrometer particles and solvent (optional) can be particularly well suited to the production of a surface structured article. The solvent can be a mixture of solvents. During the polymerization (first cure) a surface layer is inhibited by the presence of an inhibitor gas (e.g., oxygen and air) while the bulk of the coating is cured. A surface structure comprising protruding submicrometer particles results. The surface region is subsequently polymerized (second cure) yielding a cured structured coating. The subsequent polymerization of the surface layer can occur in the same curing chamber or in at least one additional curing chamber. The time between the first cure and the subsequent cure may be, for example, less 60 seconds (or even less than 45, 30, 25, 20, 15, 10, or ever less than 5 seconds); in some embodiments almost instantaneous.

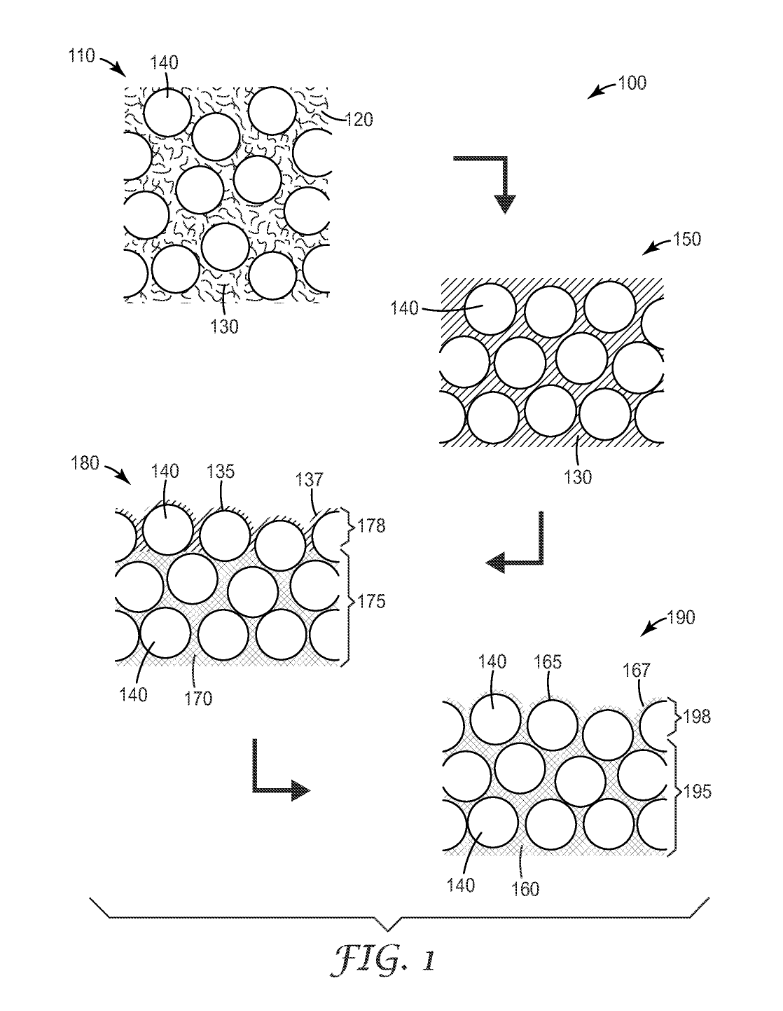

FIG. 1 is a schematic of exemplary process 100 for forming nanostructured article 180 and 190 according to one aspect of the disclosure. First solution 110 that includes polymerizable material 130 and submicrometer particles 140 in an optional solvent 120. A major portion of the solvent 120 is removed from first solution 110 to form second solution 150 containing substantially polymerizable material 130 and submicrometer particles 140. Solution 150 is polymerized by actinic radiation curing in the presence of an inhibitor gas to a form nanostructured material 180. Nanostructured material 180 includes first and second integral regions. First nanostructured region 178 includes polymerizable material 135 and submicrometer particles 140. Second region 175 includes substantially polymerized matrix material 170 and submicrometer particles 140. First region 178 has outer major surface 137 wherein at least the outer most submicrometer particles are partially conformally coated by polymerizable material 135. By “partially conformally coated” it is understood and evident, for example, from FIG. 1 that while polymerizable material 135 conformally coats a portion of the outer surface of some submicrometer particles, some portions of these submicrometer particles have an excess amount of polymerizable material 135 beyond that that conformally coats their outer surfaces. Material 180 is further polymerized by actinic radiation to form the nanostructured material 190. Nanostructured material 190 includes first and second integral regions. First nanostructured region 198 includes polymerized material 165 and submicrometer particles 140. Second region 195 includes polymerized matrix material 160 and submicrometer particles 140. First region 198 has outer major surface 167 wherein at least outer most submicrometer particles are partially conformally coated by and optionally covalently bonded to polymer material 165. First and second regions 198 and 195, respectively, have first and second average densities, respectively, and the first average density is less than the second average density. Although not shown in FIG. 1, it is to be understood that first solution 110 can be coated on a substrate (not shown), to form a nanostructured coating on the substrate.

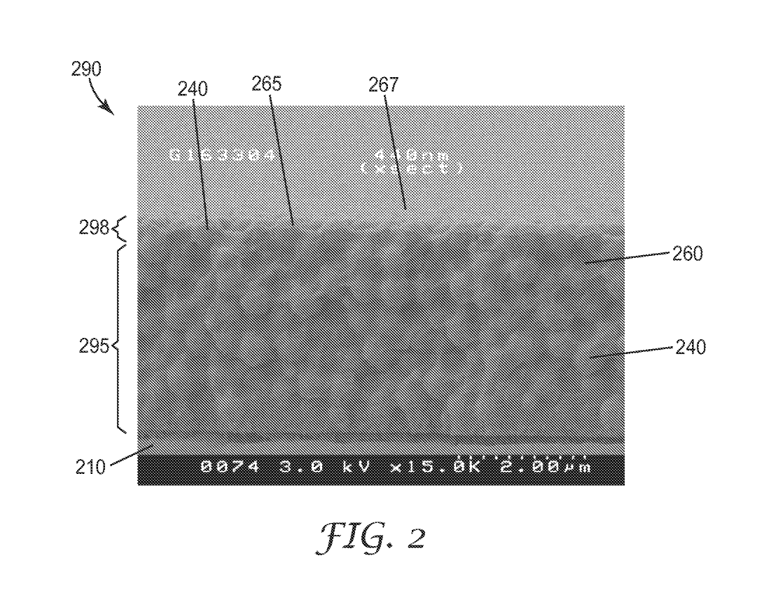

FIG. 2 is a digital SEM photomicrograph of exemplary material 290 described herein applied to substrate 210. Nanostructured material 290 includes first and second integral regions across the thickness. First nanostructured region 298 includes polymerized material 265 and submicrometer particles 240. Second region 295 includes polymerized matrix material 260 and submicrometer particles 240. First region 298 having outer major surface 267, wherein at least the outer most submicrometer particles 240 are partially conformally coated by and covalently bonded to polymer material 265. First and second regions 298 and 295, respectively, have first and second average densities, respectively, and the first average density is less than the second average density.

In some embodiments the coating can form an array of close packed partially conformally coated submicrometer particles with up to 10% (in some embodiments, up to 20%, 30%, 40%, 50%, 60%, 70%, 80%, or even at least 90%) of the submicrometer particles protruding.

In some embodiments, the average submicrometer particle center to center spacing is 1.1 (in some embodiments, at least 1:2, 1.3, 1:5, or even at least 2) diameters apart.

In some embodiments, articles described herein (e.g., some embodiments having desirable antireflection properties) have surface gradient density thickness in a range from 50 nm to 200 nm (in some embodiments, 75 nm to 150 nm). A substantially close packed (highly packed) array of protruding submicrometer particles cured into a polymer matrix can result in a durable gradient index surface layer giving rise to anti reflection.

In some embodiments, the process for creating the nanostructured coatings generally includes (1) providing a coating solution comprising surface modified submicrometer particles, radically curable prepolymers and solvent (optional); (2) supplying the solution to a coating device; (3) applying the coating solution to a substrate by one of many coating techniques; (4) substantially removing the solvent (optional) from coating; (5) polymerizing the material in the presence of a controlled amount of inhibitor gas (e.g., oxygen) to provide a structured surface; and (6) optionally post-processing the dried polymerized coating, for example, by additional thermal, visible, ultraviolet (UV), or e-beam curing.

Polymerizable material (e.g., 130 in FIG. 1) (i.e., contained in the continuous phase) described herein comprises free radical curable prepolymers. Exemplary free radical curable prepolymers include monomers, oligomers, polymers and resins that will polymerize (cure) via radical polymerization. Suitable free radical curable prepolymers include (meth)acrylates, polyester (meth)acrylates, urethane (meth)acrylates, epoxy (meth)acrylates and polyether (meth)acrylates, silicone (meth)acrylates and fluorinated meth(acrylates). Exemplary radically curable groups include (meth)acrylate groups, olefinic carbon-carbon double bonds, allyloxy groups, alpha-methyl styrene groups, styrene groups, (meth)acrylamide groups, vinyl ether groups, vinyl groups, allyl groups and combinations thereof. Typically the polymerizable material comprises free radical polymerizable groups. In some embodiments, polymerizable material (e.g., 130 in FIG. 1) comprises acrylate and methacrylate monomers, and in particular, multifunctional (meth)acrylate, difunctional (meth)acrylates, monofunctional (meth)acrylate, and combinations thereof.

As used herein, the term “monomer” means a relatively low molecular weight material (i.e., having a molecular weight less than about 500 g/mole) having one or more radically polymerizable groups. “Oligomer” means a relatively intermediate molecular weight material having a molecular weight in a range from about 500 g/mole to about 10,000 g/mole. “Polymer” means a relatively high molecular weight material having a molecular weight of at least about 10,000 g/mole (in some embodiments, in a range from 10,000 g/mole to 100,000 g/mole). The term “molecular weight” as used throughout this specification means number average molecular weight unless expressly noted otherwise.

In some exemplary embodiments, the polymerizable compositions include at least one monomeric or oligomeric multifunctional (meth)acrylate. Typically, the multifunctional (meth)acrylate is a tri(meth)acrylate and/or a tetra(meth)acrylate. In some embodiments, higher functionality monomeric and/or oligomeric (meth)acrylates may be employed. Mixtures of multifunctional (meth)acrylates may also be used.

Exemplary multifunctional (meth)acrylate monomers include polyol multi(meth)acrylates. Such compounds are typically prepared from aliphatic triols, and/or tetraols containing 3-10 carbon atoms. Examples of suitable multifunctional (meth)acrylates are trimethylolpropane triacrylate, di(trimethylolpropane) tetraacrylate, pentaerythritol tetraacrylate, pentaerythritol triacrylate, the corresponding methacrylates and the (meth)acrylates of alkoxylated (usually ethoxylated) derivatives of said polyols. Examples of multi-functional monomers include those available under the trade designations “SR-295,” “SR-444,” “SR-399,” “SR-355,” “SR494,” “SR-368” “SR-351,” “SR492,” “SR350,” “SR415,” “SR454,” “SR499,” “501,” “SR502,” and “SR9020” from Sartomer Co., Exton, Pa., and “PETA-K,” “PETIA.,” and “TMPTA-N” from Surface Specialties, Smyrna, Ga. The multi-functional (meth)acrylate monomers may impart durability and hardness to the structured surface.

In some exemplary embodiments, the polymerizable compositions include at least one monomeric or oligomeric difunctional (meth)acrylate. Exemplary difunctional (meth)acrylate monomers include diol difunctional(meth)acrylates. Such compounds are typically prepared from aliphatic diols containing 2-10 carbon atoms. Examples of suitable difunctional (meth)acrylates are ethylene glycol diacrylate, 1,6-hexanediol diacrylate, 1,12-dodecanediol dimethacrylate, cyclohexane dimethanol diacrylate, 1,4 butanediol diacrylate, diethylene glycol diacrylate, diethylene glycol dimethacrylate, 1,6-hexanediol dimethacrylate, neopentyl glycol diacrylate, neopentyl glycol dimethacrylate, and dipropylene glycol diacrylate. Difunctional (meth)acrylates from difunctional polyethers are also useful. Examples include polyethylenglycol di(meth)acrylates and polypropylene glycol di(meth)acrylates.

In some exemplary embodiments, the polymerizable compositions include at least one monomeric or oligomeric monofunctional (meth)acrylate. Exemplary monofunctional (meth)acrylates and other free radical curable monomers include styrene, alpha-methylstyrene, substituted styrene, vinyl esters, vinyl ethers, N-vinyl-2-pyrrolidone, (meth)acrylamide, N-substituted (meth)acrylamide, octyl (meth)acrylate, iso-octyl (meth)acrylate, nonylphenol ethoxylate (meth)acrylate, isononyl (meth)acrylate, isobornyl (meth)acrylate, 2-(2-ethoxyethoxy)ethyl (meth)acrylate, 2-ethylhexyl (meth)acrylate, lauryl (meth)acrylate, butanediol mono(meth)acrylate, beta-carboxyethyl (meth)acrylate, isobutyl (meth)acrylate, 2-hydroxyethyl (meth)acrylate, (meth)acrylonitrile, maleic anhydride, itaconic acid, isodecyl (meth)acrylate, dodecyl (meth)acrylate, n-butyl (meth)acrylate, methyl (meth)acrylate, hexyl (meth)acrylate, (meth)acrylic acid, N-vinylcaprolactam, stearyl (meth)acrylate, hydroxy functional polycaprolactone ester (meth)acrylate, hydroxyethyl (meth)acrylate, hydroxymethyl (meth)acrylate, hydroxypropyl (meth)acrylate, hydroxyisopropyl (meth)acrylate, hydroxybutyl (meth)acrylate, hydroxyisobutyl (meth)acrylate, tetrahydrofurfuryl (meth)acrylate, and combinations thereof. The monofunctional (meth)acrylates are useful, for example, for adjusting the viscosity and functionality of the prepolymer composition.

Oligomeric materials are also useful in making the material comprising submicrometer particles described herein. The oligomeric material contributes bulk optical and durability properties to the cured composition. Representative difunctional oligomers include ethoxylated (30) bisphenol A diacrylate, polyethylene glycol (600) dimethacrylate, ethoxylated (2) bisphenol A dimethacrylate, ethoxylated (3) bisphenol A diacrylate, ethoxylated (4) bisphenol A dimethacrylate, ethoxylated (6) bisphenol A dimethacrylate, polyethylene glycol (600) diacrylate. Typical useful difunctional oligomers and oligomeric blends include-those available under the trade designations “CN-120,” “CN-104,” “CN-116,” “CN-117,” from Sartomer Co. and “EBECRYL 1608,” “EBECRYL 3201,” “EBECRYL 3700,” “EBECRYL 3701,” and “EBECRYL 608” from Cytec Surface Specialties, Smyrna, Ga. Other useful oligomers and oligomeric blends include-those available under the trade designations “CN-2304,” “CN-115,” “CN-118,” “CN-119,” “CN-970A60,” “CN-972,” “CN-973A80,” and “CN-975” from Sartomer Co and “EBECRYL 3200,” “EBECRYL 3701,” “EBECRYL 3302,” “EBECRYL 3605,” and “EBECRYL 608” from Cytec Surface Specialties.

The polymeric matrix can be made from functionalized polymeric materials such as weatherable polymeric materials, hydrophobic polymeric materials, hydrophilic polymeric materials, antistatic polymeric materials, antistaining polymeric materials, conductive polymeric materials for electromagnetic shielding, antimicrobial polymeric materials, or antiwearing polymeric materials. Functional hydrophilic or antistatic polymeric matrix comprises the hydrophilic acrylates such as hydroxyethyl methacrylate (HEMA), hydroxyethyl acrylate (HEA), poly(ethylene glycol) acrylates with different polyethyle glycol (PEG) molecular weights, and other hydrophilic acrylates (e.g., 3-hydroxy propyl acrylate, 3-hydroxy propyl methacrylate, 2-hydroxy-3-methacryloxy propyl acrylate, and 2-hydroxy-3-acryloxy propyl acrylate).

In some embodiments, solvent (see, e.g., 120 in FIG. 1A) can be removed from the composition 110 by drying, for example, at temperatures not exceeding the decomposition temperature of either the radiation curable prepolymer (see, e.g., 130 in FIG. 1A), or the substrate (if included). In one exemplary embodiment, the temperature during drying is kept below a temperature at which the substrate is prone to deformation (e.g., a warping temperature or a glass-transition temperature of the substrate). Exemplary solvents include linear, branched, and cyclic hydrocarbons, alcohols, ketones, and ethers, including propylene glycol ethers (e.g., 1-methoxy-2-propanol), isopropyl alcohol, ethanol, toluene, ethyl acetate, 2-butanone, butyl acetate, methyl isobutyl ketone, methyl ethyl ketone, cyclohexanone, acetone, aromatic hydrocarbons, isophorone, butyrolactone, N-methylpyrrolidone, tetrahydrofuran, esters (e.g., lactates, acetates, propylene glycol monomethyl ether acetate (PM acetate), diethylene glycol ethyl ether acetate (DE acetate), ethylene glycol butyl ether acetate (EB acetate), dipropylene glycol monomethyl acetate (DPM acetate), iso-alkyl esters, isohexyl acetate, isoheptyl acetate, isooctyl acetate, isononyl acetate, isodecyl acetate, isododecyl acetate, isotridecyl acetate, and other iso-alkyl esters), water and combinations thereof.

The first solution (see. e.g., 110 in FIG. 1) may also include a chain transfer agent. The chain transfer agent is preferably soluble in the monomer mixture prior to polymerization. Examples of suitable chain transfer agents include triethyl silane and mercaptans.

In some embodiments, the polymerizable composition comprises a mixture of the above described prepolymers. Desirable properties of the radically curable composition typically include viscosity, functionality, surface tension, shrinkage and refractive index. Desirable properties of the cured composition include mechanical properties (e.g. modulus, strength, and hardness), thermal properties (e.g., glass transition temperature and melting point), and optical properties (e.g., transmission, refractive index, and haze).

The surface structure obtained has been observed to be influenced by the curable prepolymer composition. For example, different monomers result in different surface nanostructure when cured under the same conditions. The different surface structure can result, for example, in different % reflection, haze, and transmission.

The surface nanostructure obtained has been observed to be facilitated by the free radical curable prepolymer composition. For examples, incorporation of certain mono-, di-, and multi-meth(acrylates) can result in surface nanostructures that exhibit preferable coating properties (e.g., % reflection, haze, transmission, steel wool scratch resistance, etc.) when processed under the same conditions. Conversely, different ratios and/or different prepolymers can also result inability to form surface nanostructures under similar processing conditions.

Constituent proportions in the radically curable prepolymers can vary. The composition may depend, for example, on the desired coating surface properties, bulk properties, and the coating and curing conditions.

In some embodiments, the radically curable prepolymer is a hardcoat material. The combination of close packed protruding submicrometer particles cured into a hardcoat formulation can result in for example, abrasion resistant gradient density (i.e., gradient refractive index) anti reflection coatings.

While not wanting to be bound by theory, it is believed that the surface structure is obtained by the oxygen inhibition of the radical cure of the first region (see, e.g., 178 of FIG. 1), thus allowing it to be “fluid” during the bulk cure. Lower viscosity in the first region during the structure formation can lead to higher degrees of surface structure.

The functionality of a radically curable prepolymer is defined as:

Functionality=Moles double bonds/Mole of molecules.

The gel point of a prepolymer composition is reached when a continuous crosslinked network is formed. Higher functionality prepolymer compositions reach the gel point (and increase more in viscosity) at lower conversion. The higher functionality also yields a higher viscosity at lower conversion. Acrylate materials with high functionality can gel at low conversions thus giving minimal surface structure under some conditions. Acrylate material with low functionality may not bulk cure with oxygen present. In some embodiments, a functionality of 1.25 to 2.75 (in some embodiments, or 1.5 to 2.5, or even 1.75 to 2.25) is beneficial.

The rate of polymerization, for example, may also affect the first region viscosity and thus the resulting surface structure. Methacrylate functional groups polymerize slower than acrylate groups. This slower rate can result in a more fluid surface region under the same conditions, and thus more surface structure. Multi and difuctional methacrylates can be used to adjust the surface structure and the cured crosslink density independently.

In some embodiments, a mixture of mutifuctional, difuctional, and monofunction (meth)acrylates can yield a desirable surface structure. A mixture of multi-functional, di-functional, and mono-functional acrylate monomers in some weight ratios (e.g., 4:4:2, 3:4:3, or 5:2:3) effectively promotes the structure formation of protruding submicrometer particles on the surface that results in a low reflection.

In one exemplary embodiment, a prepolymer composition having a weight ratio of about 4:4:2 pentaerythritol tetraiacrylate, 1,6-hexanediol diacrylate and isobornyl (meth)acrylate, respectively, has been observed to promote the structure formation of protruding submicrometer particles on the surface that result in durable low reflection coatings.

In one exemplary embodiment, a prepolymer composition having a weight ratio of about 4:4:2 propoxylated trimethylolpropane triacrylate, 1,6 hexanediol diacrylate, and isooctyl acrylate, respectively, have been observed to promote the structure formation of protruding submicrometer particles on the surface that results in durable low reflection coatings.

In some exemplary embodiments, the prepolymer contains both methacrylate and acrylate functionality.

The curable prepolymer compositions are polymerizable using conventional techniques such as thermal cure, photocure (cure by actinic radiation), or e-beam cure. In one exemplary embodiment, the resin is photopolymerized by exposing it to ultraviolet (UV) or visible light. Conventional curatives or catalysts may be used in the polymerizable compositions, and selected based on the functional group(s) in the composition. Multiple curatives or catalysts may be needed if multiple cure functionality is being used. Combining one or more cure techniques, such as thermal cure, photocure, and e-beam cure, is within the scope of the present disclosure.

An initiator, such as a photoinitiator, can be used in an amount effective to facilitate polymerization of the prepolymers present in the second solution (see, e.g., 150 in FIG. 1). The amount of photoinitiator can vary depending upon, for example, the type of initiator, the molecular weight of the initiator, the intended application of the resulting nanostructured material (see, e.g., 180 and 190 in FIG. 1) and the polymerization process including, the temperature of the process and the wavelength of the actinic radiation used. Useful photoinitiators include, for example, those available from Ciba Specialty Chemicals under the trade designations “IRGACURE” and “DAROCURE,” including “IRGACUR 184” and “IRGACUR 819,” respectively.

In some embodiments, a mixture of initiators and initiator types can be used, for example, to control the polymerization in different sections of the process. In one embodiment, optional post-processing polymerization may be a thermally initiated polymerization that requires a thermally generated free-radical initiator. In other embodiments, optional post-processing polymerization may be an actinic radiation initiated polymerization that requires a photoinitiator. The post-processing photoinitiator may be the same or different than the photoinitiator used to polymerize the polymer matrix in solution.

The photoinitiator concentration has been observed to have an influence on the surface structure of the coating. The photoinitiator has been observed to affect the rate of polymerization. The time required to reach the gel point and corresponding increase in viscosity of this first region is affected. In some embodiments photoinitiator concentration is in a range from 0.25-10 wt. % of total solids (in some embodiments, 0.5-5 wt. %, or even 1-4 wt. %).

The surface nanostructure has been observed to be facilitated by the amount of photoinitiator added to the free radical curable prepolymer composition. For example, incorporation of different amounts of photoinitiator can result in surface nanostructures that exhibit preferable coating properties (e.g., % reflection, haze, transmission, steel wool scratch resistance, etc.) when processed under the same conditions.

The method for forming surface nanostructure has been observed to be facilitated by the amount of photoinitiator added to the free radical curable prepolymer composition. For example, incorporation of different amounts of photoinitiator can result in surface nanostructures that exhibit preferable processing conditions (e.g., web speed, inhibition gas concentration, actinic radiation, etc.).

Surface leveling agents may be added to the material (solution) (see, e.g., 110 or 130 in FIG. 1). The leveling agent is preferably used for smoothing the matrix resin. Examples include silicone-leveling agents, acrylic-leveling agents and fluorine-containing-leveling agents. In one exemplary embodiment, the silicone-leveling agent includes a polydimethyl siloxane backbone to which polyoxyalkylene groups are added.

The surface nanostructure obtained has been observed to be facilitated by additives to the free radical curable prepolymer composition. For example, incorporation of certain low surface energy materials can result in surface nanostructures that exhibit preferable coating properties (e.g., % reflection, haze, transmission, steel wool scratch resistance, etc.).

In some embodiments, low surface energy additives (e.g., that available under the trade designation “TEGORAD 2250” from Evonik Goldschimdt Corporation, Hopewell, Va. and a perfluoropolyether containing copolymer (HFPO) prepared as Copolymer B in U.S. Pat. Pub. No. 2010/0310875 A1 (Hao et. al.)(the disclosure of which is incorporated by reference) may be added, for example, in a range from 0.01 wt. % to 5 wt. % (in some embodiments, 0.05 wt. % to 1 wt. %, or even 0.01 wt. % to 1 wt. %).

It is desirable that the resin matrix result in a defect-free coating. In some embodiments, defects that can manifest during the coating process may include optical quality, haze, roughness, wrinkling, dimpling, dewetting, etc. These defects can be minimized with employment of surface leveling agents. Exemplary leveling agents include those available under the trade designation “TEGORAD” from Evonik Goldschimdt Corporation. Surfactants such as fluorosurfactants can be included in the polymerizable composition, for example, to reduce surface tension, improve wetting, allowing smoother coating, and fewer coating defects.

Polymerizable compositions described herein can also contain one or more other useful components that, as will be appreciated by those of skill in the art, can be useful in such a polymerizable composition. For example, the polymerizable composition can include one or more surfactants, pigments, fillers, polymerization inhibitors, antioxidants, anti-static agents, and other possible ingredients. Such components can be included in amounts known to be effective.

Other useful ingredients include cure accelerators, catalysts, tackifiers, plasticizers, dyes, flame retardants, coupling agents, impact modifiers including thermoplastic or thermoset polymers, flow control agents, foaming agents, glass and polymer microspheres and microparticles.

Submicrometer particles dispersed in the matrix have a largest dimension less than 1 micrometer. Submicrometer particles include nanoparticles (e.g., nanospheres, and nanotubes). The submicrometer particles can be associated or unassociated or both. The submicrometer particles can have spherical, or various other shapes. For example, submicrometer particles can be elongated and have a range of aspect ratios. In some embodiments, the submicrometer particles can be inorganic submicrometer particles, organic (e.g., polymeric) submicrometer particles, or a combination of organic and inorganic submicrometer particles. In one exemplary embodiment, submicrometer particles can be porous particles, hollow particles, solid particles, or a combination thereof.

In some embodiments, the submicrometer particles are in a range from 5 nm to 1000 nm (in some embodiments, 20 nm to 750 nm, 50 nm to 500 nm, 75 nm to 300 nm, or even 100 nm to 200 nm). Submicrometer particles have a mean diameter in the range from about 10 nm to about 1000 nm. The term “submicrometer particle” can be further defined herein to mean colloidal (primary particles or associated particles) with a diameter less than about 1000 nm. The term “associated particles” as used herein refers to a grouping of two or more primary particles that are aggregated and/or agglomerated. The term “aggregated” as used herein is descriptive of a strong association between primary particles which may be chemically bound to one another. The breakdown of aggregates into smaller particles is difficult to achieve. The term “agglomerated” as used herein is descriptive of a weak association of primary particles which may be held together by charge or polarity and can be broken down into smaller entities. The term “primary particle size” is defined herein as the size of a non-associated single particle. The dimension or size of the submicrometer dispersed phase can be determined by electron microscopy (e.g., transmission electron microscopy (TEM)).

The submicrometer (including nanometer sized) particles can comprise, for example, carbon, metals, metal oxides (e.g., SiO₂, ZrO₂, TiO₂, ZnO, magnesium silicate, indium tin oxide, and antimony tin oxide), carbides (e.g., SiC and WC), nitrides, borides, halides, fluorocarbon solids (e.g., poly(tetrafluoroethylene)), carbonates (e.g., calcium carbonate), and mixtures thereof. In some embodiments, submicrometer particles comprises at least one of SiO₂ particles, ZrO₂ particles, TiO₂ particles, ZnO particles, Al₂O₃ particles, calcium carbonate particles, magnesium silicate particles, indium tin oxide particles, antimony tin oxide particles, poly(tetrafluoroethylene) particles, or carbon particles. Metal oxide particles can be fully condensed. Metal oxide particles can be crystalline.

In some embodiments, the submicrometer particles have a multimodal distribution. In some embodiments, the submicrometer particles have a bimodal distribution.

Exemplary silicas are available, for example, from Nalco Chemical Co., Naperville, Ill., under the trade designation “NALCO COLLOIDAL SILICA,” such as products “2326,” “2727,” “2329,” “2329K,” and “2329 PLUS.” Exemplary fumed silicas include those available, for example, from Evonik Degusa Co., Parsippany, N.J., under the trade designation, “AEROSIL series OX-50,” as well as product numbers -130, -150, and -200; and from Cabot Corp., Tuscola, Ill., under the designations “CAB-O-SPERSE 2095,” “CAB-O-SPERSE A105,” and “CAB-O-SIL M5.” Other exemplary colloidal silica is available, for example, from Nissan Chemicals under the designations “MP1040,” “MP2040,” “MP3040,” and “MP4540.”

In some embodiments, the submicrometer particles are surface modified. Preferably, the surface-treatment stabilizes the submicrometer particles so that the submicrometer particles are well dispersed in the polymerizable resin, and result in a substantially homogeneous composition. In some embodiments, the submicrometer particles can be modified over at least a portion of its surface with a surface treatment agent so that the stabilized submicrometer particles can copolymerize or react with the polymerizable resin during curing.

In some embodiments, the submicrometer particles are treated with a surface treatment agent. In general, a surface treatment agent has a first end that will attach to the particle surface (covalently, ionically or through strong physisorption) and a second end that imparts compatibility of the particle with the resin and/or reacts with the resin during curing. Examples of surface treatment agents include alcohols, amines, carboxylic acids, sulfonic acids, phosphonic acids, silanes, and titanates. The preferred type of treatment agent is determined, in part, by the chemical nature of the metal oxide surface. Silanes are preferred for silica and other siliceous particles. Silanes and carboxylic acids are preferred for metal oxides, such as zirconia. The surface modification can be done either subsequent to mixing with the monomers or after mixing. It is preferred in the case of silanes to react the silanes with the submicrometer particles or submicrometer particle surface before incorporation into the resins. The required amount of surface modifier is dependent on several factors such as particle size, particle type, molecular weight of the modifier, and modifier type.

Exemplary embodiments of surface treatment agents that do not have radically copolymerizable groups include compounds such as isooctyl tri-methoxy-silane, N-(3-triethoxysilylpropyl)methoxyethoxy-ethoxyethyl carbamate, N-(3-triethoxysilylpropyl)methoxyethoxyethoxyethyl carbamate, pheyltrimethoxysilane, n-octyltrimethoxysilane, dodecyltrimethoxysilane, octadecyltrimethoxysilane, propyltrimethoxysilane, hexyltrimethoxysilane, 3-glycidoxypropyltrimethoxysilane, oleic acid, stearic acid, dodecanoic acid, 2-(2-(2-methoxyethoxy)ethoxy)acetic acid (MEEAA), 2-(2-methoxyethoxy)acetic acid, methoxyphenyl acetic acid, and mixtures thereof. One exemplary silane surface modifier is available, for example, from Momentive Performance Materials, Wilton, Conn., under the trade designation “SILQUEST A1230.”

Exemplary embodiments of surface treatment agents that radically copolymerize with the curable resin include compounds 3-(methacryloyloxy)propyltrimethoxysilane, 3-acryloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, vinyldimethylethoxysilane, vinylmethyldiactoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, acrylic acid, methacrylic acid, beta-carboxyethylacrylate and mixtures thereof.

A variety of methods are available for modifying the surface of submicrometer particles including adding a surface modifying agent to submicrometer particles (e.g., in the form of a powder or a colloidal dispersion) and allowing the surface modifying agent to react with the submicrometer particles. Other useful surface modification processes are described, for example, in U.S. Pat. No. 2,801,185 (Iler) and U.S. Pat. No. 4,522,958 (Das et al.), the disclosures of which are incorporated herein by reference.

Surface modification of the submicrometer particles in the colloidal dispersion can be accomplished in a variety of ways. Typically the process involves the mixture of an inorganic dispersion with surface modifying agents. Optionally, a co-solvent can be added at this point (e.g., 1-methoxy-2-propanol, ethanol, isopropanol, ethylene glycol, N,N-dimethylacetamide, and 1-methyl-2-pyrrolidinone). The co-solvent can enhance the solubility of the surface modifying agents as well as the dispersion of the surface modified submicrometer particles. The mixture comprising the inorganic dispersion and surface modifying agents is subsequently reacted at room or an elevated temperature, with or without mixing. In one exemplary method, the mixture can be reacted at about 85-100° C. for about 16 hours, resulting in the surface modified dispersion. In another exemplary method, where metal oxides are surface modified, the surface treatment of the metal oxide can involve the adsorption of acidic molecules to the particle surface. Surface modification of the heavy metal oxide preferably takes place at room temperature.

Surface modification of ZrO₂ with silanes can be accomplished under acidic conditions or basic conditions. In one example, the silanes are heated under acid conditions for a suitable period of time. At which time the dispersion is combined with aqueous ammonia (or other base). This method allows removal of the acid counter ion from the ZrO₂ surface as well as reaction with the silane. In another exemplary method, the submicrometer particles are precipitated from the dispersion and separated from the liquid phase.

The surface modified submicrometer particles can then be incorporated into the radically curable prepolymer in various methods. In some embodiments, a solvent exchange procedure is utilized whereby the resin is added to the surface modified dispersion, followed by removal of the water and co-solvent (if used) via evaporation, thus leaving the surface modified submicrometer particles dispersed in the radically curable prepolymer. The evaporation step can be accomplished for example, via distillation, rotary evaporation or oven drying.

In some embodiments, the surface modified submicrometer particles can be extracted into a water immiscible solvent followed by solvent exchange, if so desired.

Another exemplary method for incorporating the surface modified submicrometer particles in the radically curable prepolymer involves the drying of the surface modified submicrometer particles into a powder, followed by the addition of the radically curable prepolymer material into which the submicrometer particles are dispersed. The drying step in this method can be accomplished by conventional means suitable for the system (e.g., oven drying, gap drying, spray drying, and rotary evaporation).

In some embodiments the coating solution is produced by combining radically curable prepolymer and surface modified submicrometer particles with a solvent or solvent mixture. The coating solution facilitates the coating of the radically curable composition.

A coating solution can be obtained, for example, by adding the desired coating solvents to a radically curable prepolymer and submicrometer particle composition prepared as described above.

In one exemplary embodiment a coating solution can be prepared by solvent exchange of the surface modified submicrometer particles into the coating solvent, followed by addition of the radically curable prepolymer.

In another exemplary embodiment a coating solution can be prepared by drying the surface modified submicrometer particles into a powder. The powder is then dispersed in the desired coating solvent. The drying step in this method can be accomplished by conventional means suitable for the system (e.g., oven drying, gap drying, spray drying, and rotary evaporation). The dispersion can be facilitated, for example, by mixing sonication, milling, and microfluidizing.

The surface modifiers have been observed to influence the surface structure obtained. Further, the submicrometer particle surface modifiers have been observed to influence the coating bulk properties and surface structure. The surface modifiers can be used to adjust the compatibility of the submicrometer particles with the radically curable prepolymer and the solvent system. This has been observed to affect, for example, the clarity and the viscosity of the radiation curable composition. In addition, the ability of the modified submicrometer particle to cure into the polymer coating has been observed to affect the rheology of the first region during cure. The viscosity and gel point affect the surface structure obtained.

In some embodiments, a combination of surface modifying agents may be useful. In some embodiments, a combination of surface modifying agents may be useful, for example, wherein at least one of the agents has a functional group co-polymerizable with a radically curable prepolymer. Useful ratios of radically polymerizable and non-radically polymerizable include 100:0, thru 0:100. An exemplary combination of radically polymerizable and non-radically polymerizable surface modifiers is 3-(methacryloyloxy)propyltrimethoxysilane (MPS) and a silane surface modifier available, for example, from Momentive Performance Materials, under the trade designation “SILQUEST A1230”. Exemplary surface modifier combinations include MPS:A1230 with molar ratios of 100:0, 75:25, 50:50, and 25:75.

In one exemplary embodiment, the sub micrometer particles are surface modified with surface treatment agents that have radically polymerizable functional groups.

In another exemplary embodiment, the submicrometer particles are modified with surface treatment agents that do not have radically polymerizable functional groups.

In one exemplary embodiment, the submicrometer particles are surface modified with combination of surface treatment agents that have radically polymerizable functional groups and surface treatment agents that do not have radically polymerizable functional groups (in some embodiments, the molar ratio of these radically polymerizable and radically nonpolymerizable can be in the range of 100:0 to 0:100).

In one exemplary embodiment, the sub micrometer particles are surface modified with a combination of at least two surface treatment agents.

In one exemplary embodiment, mixtures of at least two different populations (e.g., composition, size, etc.) of surface modified submicrometer particles with different surface modification agents can be used.

In another embodiment, the submicrometer particles have a mixture of surface treatment agents that that have a functional group will cure into the polymer matrix and ones that that have a functional group will not cure into the polymer matrix.

The weight ratio of the submicrometer particles to radically curable prepolymers has been observed to influence the surface structure. The surface structure can be formed at ratios below the critical binder concentration. That is, binder lean compositions are not needed to obtain the surface structure. This allows greater latitude in formulation and also gives greater durability over the systems where the polymer binder is limited. This also has been observed to allow easy access to a range of coating thicknesses.

The surface nanostructure obtained has been observed to be affected by the weight ratio of submicrometer particles to radical curable prepolymer in the composition. For example, adjusting the weight ratio (e.g., 10:90, 30:70, 50:50, 70:30, etc.) may result in surface nanostructures that exhibit preferable coating properties (e.g., % reflection, haze, transmission, steel wool scratch resistance, surface roughness, etc.) when processed under the same conditions.

The weight ratio of surface modified submicrometer silica particles to radically curable prepolymer is a measure of the particle loading. Typically, surface modified submicrometer particles are present in the matrix in an amount in a range from about 10:90 to 80:20 (in some embodiments, for example, 20:80 to 70:30).

In some embodiments, the weight ratio of surface modified submicrometer silica particles to radically curable prepolymer is in a range from about 10:90 to 80:20 (in some embodiments, for example, 20:80 to 70:30, or 45:65 to 65:35).

In some embodiments, the weight ratio of surface modified submicrometer silica particles to radically curable prepolymer is in a range from about 50:50 to 75:25 (in some embodiments, for example, 60:40 to 75:25 or 65:35 to 75:25).

The volume fraction (based on total volume of the curable composition) of surface modified submicrometer particles in the radically curable prepolymer is typically in the range from 0.5 to 0.7 (in some embodiments, for example, 0.1 to 0.6 or 0.2 to 0.55).

In some embodiments, the volume fraction (based on total volume of the curable composition) of surface modified submicrometer particles in the radically curable prepolymer is in a range from about 0.05 to 0.7 (in some embodiments, for example, 0.1 to 0.60 or 0.25 to 0.50).

In some embodiments, the volume fraction (based on total volume of the curable composition) of surface modified submicrometer particles in the radically curable prepolymer is in a range from about 0.34 to 0.51 (in some embodiments, for example, 0.45 to 0.51 or 0.47 to 0.55).

The percent of a partially conformally coated submicrometer particle protruding from the second region can be determined by viewing a cross-section of an article described herein with a scanning electron microscope or transmission electron microscope. The percent of a partially conformally coated submicrometer particle that protrudes from the second region is the specified percent from where the respective submicrometer particle protrudes from the first and second region “interface.”

Exemplary substrates include polymeric substrates, glass substrates or windows, and functional devices (e.g., organic light emitting diodes (OLEDs), displays, and photovoltaic devices). Typically, the substrates have thicknesses in a range from about 12.7 micrometers (0.0005 inch) to about 762 micrometers (0.03 inch), although other thicknesses may also be useful.

Exemplary polymeric materials for the substrates include polyethylene terephthalate (PET), polystyrene, acrylonitrile butadiene styrene, polyvinyl chloride, polyvinylidene chloride, polycarbonate, polyacrylates, thermoplastic polyurethanes, polyvinyl acetate, polyamide, polyimide, polypropylene, polyester, polyethylene, poly(methyl methacrylate), polyethylene naphthalate, styrene acrylonitrile, silicone-polyoxamide polymers, fluoropolymers, triacetate cellulose, cyclic olefin copolymers, and thermoplastic elastomers. Semicrystalline polymers (e.g., polyethylene terephthalate (PET)) may be particularly desirable for the applications requiring good mechanical strength and dimensional stability. For other optical film applications, low birefringent polymeric substrates, such as triacetate cellulose, poly(methyl methacrylate), polycarbonate, and cyclic olefin copolymers, may be particularly desirable to minimize or avoid orientation induced polarization or dichroism interference with other optical components, such as polarizer, electromagnetic interference, or conductive touch functional layer in the optical display devices.

The polymeric substrates can be formed, for example, by melt extrusion casting, melt extrusion calendaring, melt extrusion with biaxial stretching, blown film processes, and solvent casting optionally with biaxial stretching. In some embodiments, the substrates are highly transparent (e.g., at least 90% transmittance in the visible spectrum) with low haze (e.g., less than 1%) and low birefringence (e.g., less than 50 nanometers optical retardance). In some embodiments, the substrates have a microstructured surface or fillers to provide hazy or diffusive appearance.

Optionally, the substrate is a polarizer (e.g., a reflective polarizer or an absorptive polarizer). A variety of polarizer films may be used as the substrate, including multilayer optical films composed, for example, of some combination of all birefringent optical layers, some birefringent optical layers, or all isotropic optical layers. The multilayer optical films can have ten or less layers, hundreds, or even thousands of layers. Exemplary multilayer polarizer films include those used in a wide variety of applications such as liquid crystal display devices to enhance brightness and/or reduce glare at the display panel. The polarizer film may also be the type used in sunglasses to reduce light intensity and glare. The polarizer film may comprise a polarizer film, a reflective polarizer film, an absorptive polarizer film, a diffuser film, a brightness enhancing film, a turning film, a mirror film, or a combination thereof. Exemplary reflective polarizer films include those reported in U.S. Pat. No. 5,825,543 (Ouderkirk et al.) U.S. Pat. No. 5,867,316 (Carlson et al.), U.S. Pat. No. 5,882,774 (Jonza et al.), U.S. Pat. No. 6,352,761 B1 (Hebrink et al.), U.S. Pat. No. 6,368,699 B1 (Gilbert et al.), and U.S. Pat. No. 6,927,900 B2 (Liu et al.), U.S. Pat. Appl. Pub. Nos. 2006/0084780 A1 (Hebrink et al.), and 2001/0013668 A1 (Neavin et al.), and PCT Pub. Nos. WO95/17303 (Ouderkirk et al.), WO95/17691 (Ouderkirk et al), WO95/17692 (Ouderkirk et al.), WO95/17699 (Ouderkirk et al.), WO96/19347 (Jonza et al.), WO97/01440 (Gilbert et al.), WO99/36248 (Neavin et al.), and WO99/36262 (Hebrink et al.), the disclosures of which are incorporated herein by reference. Exemplary reflective polarizer films also include those commercially available from 3M Company, St. Paul, Minn., under the trade designations “VIKUITI DUAL BRIGHTNESS ENHANCED FILM (DBEF),” “VIKUITI BRIGHTNESS ENHANCED FILM (BEF),” “VIKUITI DIFFUSE REFLECTIVE POLARIZER FILM (DRPF),” “VIKUITI ENHANCED SPECULAR REFLECTOR (ESR),” and “ADVANCED POLARIZER FILM (APF).” Exemplary absorptive polarizer films are commercially available, for example, from Sanritz Corp., Tokyo, Japan, under the trade designation of “LLC2-5518SF.”

The optical film may have at least one non-optical layer (i.e., a layer(s) that does not significantly participate in the determination of the optical properties of the optical film). The non-optical layers may be used, for example, to impart or improve mechanical, chemical, or optical, properties; tear or puncture resistance; weatherability; or solvent resistance.

Exemplary glass substrates include sheet glass (e.g., soda-lime glass) such as that made, for example, by floating molten glass on a bed of molten metal. In some embodiments (e.g., for architectural and automotive applications), it may be desirable to include a low-emissivity (low-E) coating on a surface of the glass to improve the energy efficiency of the glass. Other coatings may also be desirable in some embodiments to enhance the electro-optical, catalytic, or conducting properties of glass.

Materials described herein having articles described herein comprising the surface modified submicrometer particles dispersed in the polymeric matrix can exhibit at least one desirable property, such as antireflective properties, light absorbing properties, antifogging properties, improved adhesion, and durability.

For example, in some embodiments, the surface reflectivity of the submicrometer structured surface is about 50% or less than the surface reflectivity of an untreated surface. As used herein with respect to comparison of surface properties, the term “untreated surface” means the surface of an article comprising the same matrix material and the same submicrometer dispersed phase (as the submicrometer structured surface to which it is being compared), but without a sub-micron structured surface.

Some embodiments further comprise a layer or coating comprising, for example, ink, encapsulant, adhesive, or metal attached to the surface of the material comprising submicrometer particles dispersed in a polymeric matrix. The layer or coating can have improved adhesion to the surface than to an untreated surface. Ink or encapsulant coatings can be applied on the substrates, for example, by solvent, electrostatic deposition, and powder printing processes and cured by UV radiation or thermal treatment. Pressure sensitive adhesives or structural adhesives can be applied on the substrates, for example, by solvent and hot melt coating processes. For metallization of plastics, the surface is typically pre-treated by oxidation and coated with electroless copper or nickel before further plating with silver, aluminum, gold, or platinum. For vacuum metallization, the process typically involves heating (e.g., resistance, electron beam, or plasma heating) the coating metal to its boiling point in a vacuum chamber, then letting condensation deposit the metal on the substrate's surface.

For articles described herein, the first layer and optional second layer of material comprising submicrometer particles dispersed in a polymeric matrix independently have a thickness of at least 500 nm (in some embodiments, at least 1 micrometer, 1.5 micrometer, 2 micrometer, 2.5 micrometers, 3 micrometers, 4 micrometers, 5 micrometers, 7.5 micrometers, or even at least 10 micrometers).

Material described herein can be made, for example, by a method comprising:

providing a free radical curable layer having submicrometer particles dispersed therein; and

actinic radiation curing the free radical curable layer in the presence of a sufficient amount of inhibitor gas (e.g., oxygen and air) to inhibit the curing of a major surface region of the layer

to provide a layer having a major surface region with a first degree of cure and a bulk region having a second degree of cure, wherein the first degree of cure is less than the second degree of cure, and wherein the material having a structured surface that includes a portion of the surface modified submicrometer particles. The material (see, e.g., 180 in FIG. 1) may optionally be the final material to be post-processed in a subsequent step.

Optionally, the layer is additionally cured to provide the layer with a bulk region with a second degree of cure and a major surface region having a second degree of cure.

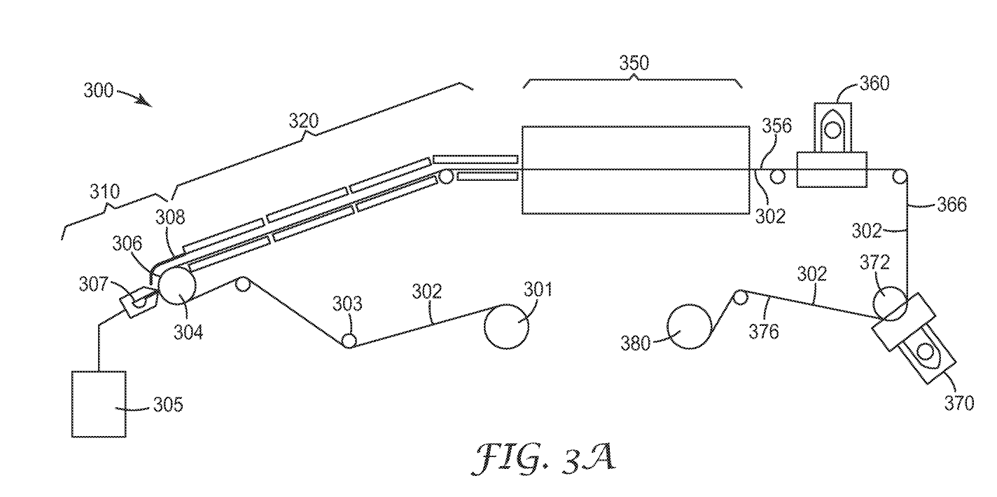

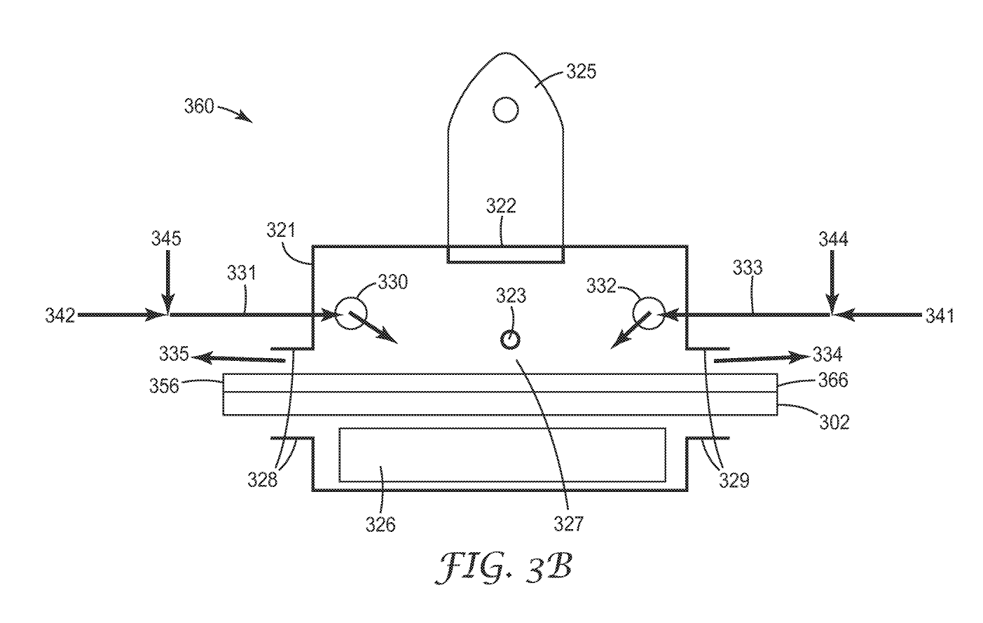

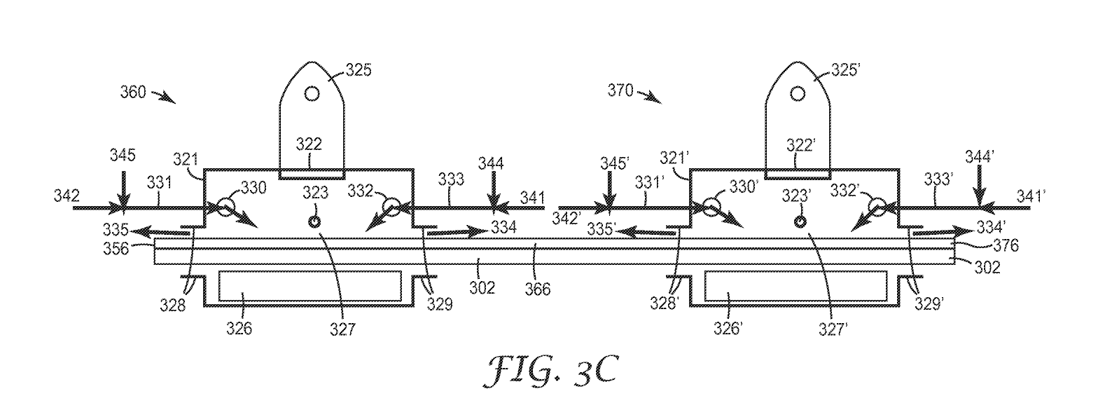

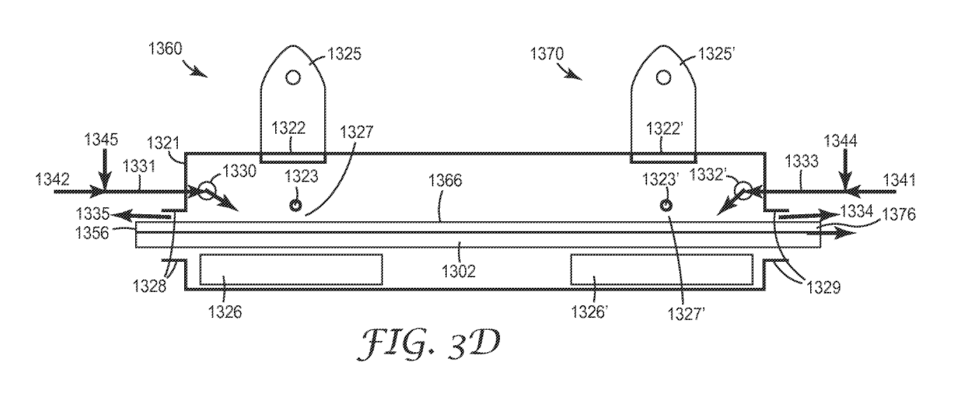

FIG. 3A shows a schematic view of exemplary process 300 for making nanostructured coatings 366 and 376 on substrate 302. Process 300 shown in FIG. 3A is a continuous process, although it is to be understood that the process can instead be performed in a stepwise manner (i.e., the steps of coating, removing solvent (optional), and polymerizing described below can be performed on individual substrate pieces in discrete operations to form a nanostructured coating (material).

Process 300 shown in FIG. 3A passes substrate 302 through coating section 310. Process 300 has optional first solvent removal section 320, and optional second solvent removal section 350 to form coating 356 on substrate 302. Coating 356 on substrate 302 then passes through polymerization section 360 to form nanostructured coating 366 on substrate 302, and optional second polymerization section 370 to form nanostructured coating 376 on substrate 302 which is then wound up as output roll 380. Optional polymerization section 370 can be provided with temperature controlled backup roll 372. In some embodiments, process 300 includes additional processing equipment common to the production of web-based materials, including idler rolls; tensioning rolls; steering mechanisms; surface treaters (e.g., corona or flame treaters); and lamination rolls. In some embodiments, process 300 utilizes different web paths, coating techniques, polymerization apparatus, positioning of polymerization apparatus, and drying ovens, where some of the sections described are optional.

Substrate 302 can be any known substrate suitable for roll-to-roll web processing in a webline, including polymeric substrates, metalized polymeric substrates, metal foils, paper substrates, and combinations thereof. In one exemplary embodiment, substrate 302 is an optical quality polymeric substrate, suitable for use in an optical display (e.g., a liquid crystal display).

Substrate 302 is unwound from input roll 301, passes over idler rolls 303 and contacts coating roll 304 in coating section 310. First solution 305 passes through coating die 307 to form first coating 306 of first solution 305 on substrate 302. First solution 305 can include solvents, polymerizable (radiation curable) materials, submicrometer particles photoinitiators, and any of the other first solution components described herein. Shroud 308 positioned between coating die 307 in coating section 310, and first solvent removal section 320 protects coating 306 from ambient conditions in the room and reduces any undesirable effects on the coating. Shroud 308 can be, for example, a formed aluminum sheet that is positioned in close proximity to first coating 306 and provides a seal around coating die 307 and coating roll 304. In some embodiments, shroud 308 can be optional.

Coating die 307 can include any known coating die and coating technique, and is not to be limited to any specific die design or technique of coating thin films. Examples of coating techniques include knife coating, gravure coating, slide coating, slot coating, slot-fed knife coating, and curtain coating. Several applications of the nanostructured materials can include the need for precise thickness and defect-free coatings, and may require the use of precise slot coating die 307 positioned against precision coating roll 304 as shown in FIG. 3A. First coating 306 can be applied at any thickness; however thin coatings are generally preferred (e.g., less than 1000 micrometers (in some embodiments, less than about 500 micrometers, less than about 100 micrometers or even less than about 10 micrometers thick) can provide nanostructured articles having desirable properties.

First optional solvent removal section, can be a gap dryer apparatus described, for example, in U.S. Pat. No. 5,694,701 (Huelsman et al.) and U.S. Pat. No. 7,032,324 (Kolb et al.). A gap dryer can provide greater control of the drying environment, which may be desired in some applications. Optional second solvent removal section 350 can further be used to ensure that a major portion (i.e., greater than 90% (in some embodiments, greater than 80%, 70%, 60%, or even greater than 50%) by weight of the solvent is removed. Solvent can be removed, for example, by drying in a thermal oven that can include, for example, air floatation/convection, vacuum drying, gap drying, or a combination of drying techniques. The choice of drying technique may depend, for example, on the desired process speed, extent of solvent removal, and expected coating morphology.

FIG. 3B is a schematic view of polymerization section 360 (and 370) of process 300 shown in FIG. 3A. FIG. 3B shows a cross-section of polymerization section 360 (and 370) as viewed along an edge of substrate 302. Polymerization section 360 includes housing 321 and quartz plate 322 that provide boundaries between radiation source 325 and cure chamber environment 327. Cure chamber environment 327 partially surrounds first coating 356 and (at least partially) polymerized coating 366 on substrate 302. At least partially polymerized coating 366 includes nanostructures described herein.

Controlled cure chamber environment 327 will now be described. Housing 321 includes entrance aperture 328 and exit aperture 329 that can be adjusted to provide any desired gap between substrate 302, coating 356 on substrate 302, and the respective aperture. Controlled cure chamber environment 327 and first and second coatings 356 and 366 temperatures can be controlled by the temperature of platen 326 (or temperature controlled roll for cure chamber 370) (which can be fabricated from metal that is cooled by, for example, either air or water to control the temperature by removing the generated heat) and appropriate control of the temperature, composition, pressure and flow rate of first input gas 331, second input gas 333, first output gas 335 and second output gas 334. Appropriate adjustment of the sizes of entrance and exit apertures 328, 329, respectively, can aid control of the pressure and flow rate of first and second output gases 335, 334, respectively. The inhibitor gas content is monitored through port 323 in chamber housing 321.

First input gas manifold 330 is positioned within housing 321 proximate entrance aperture 328, to distribute first input gas 331 uniformly across the width of first coating 356. Second input gas manifold 332 is positioned within housing 321 proximate exit aperture 329, to distribute second input gas 333 uniformly across the width of second coating 366. First and second input gases 331, 333, respectively, can be the same or they can be different, and can include inert gasses 341 and 342 (e.g., nitrogen and carbon dioxide) combined with inhibition gasses 344 and 345 (e.g., oxygen and air), which can be combined to control the concentration of inhibition gas in input gas 331 and 333. The relative compositions, flow rates, flow velocities, flow impingement or orientation on the coating, and temperature of each of first and second input gases 331, 333, respectively, can be controlled independently, and can be adjusted to achieve the desired environment in the radiation cure chamber. In some embodiments, only one of first and second input gases 331, 333, respectively, may be flowing. Other configurations of input gas manifolds are also possible.

Nanostructured coating 366 on substrate 302 exits polymerization section 360 and then passes through optional second polymerization section 370 to form an optionally second nanostructured coating 376 on substrate 302. Optional second polymerization section can increase the extent of cure of nanostructured coating 366. In some embodiments, increasing the extent of cure can include polymerizing remaining polymerizable material (i.e., remaining polymerizable material (see, e.g., 135 in FIG. 1)). Nanostructured coating 376 on substrate 302 exits optional second polymerization section 370 and is then wound up as an output roll 380. In some embodiments, output roll 380 can have other desired films (not shown) laminated to the nanostructured coating and simultaneously wound on the output roll 380. In other embodiments, additional layers (not shown) can be coated, cured, and dried on either nanostructured coating 366 and 376 or substrate 302.

Radiation source 325 can be any of a variety of actinic radiation sources (e.g., UV LEDs, visible LEDs, lasers, electron beams, mercury lamps, xenon lamps, carbon arc lamps, tungsten filament lamps, flashlamps, sunlight, and low intensity ultraviolet light (black light)). In some embodiments, radiation source 325 is capable of producing UV radiation. A combination of radiation sources emitting at different wavelengths can be used to control the rate and extent of the polymerization reaction. The radiation sources can generate heat during operation, and heat extractor 326 can be fabricated from aluminum that is cooled by either air or water to control the temperature by removing the generated heat.

Processing parameters can affect the resulting nanostructured material (e.g., web speed, coating thickness, actinic radiation intensity, dose, light spectrum, inhibitor gas content (in the cure chamber), coating (356 and 366 FIG. 3A) temperature, and composition of the coating during polymerization). Environmental control including gas phase composition, gas flow fields, gas temperature, and gas flow rates. The composition during polymerization is affected by the drying process prior to polymerization.

Actinic radiation cure chamber design can affect the resulting nanostructured material (e.g., chamber dimensions, location, design and number of input gas manifolds, location and type of temperature control platens/roll, and distance between substrate entrance aperture 328 and radiation source 325).

In some embodiments of methods described herein, all actinic radiation curing is conducted in a single chamber as shown in FIG. 3B. For this embodiment the single actinic radiation cure chamber provides both nanostructure formation and final cure of the coated substrate as it is transported through the cure chamber.

Two chamber actinic curing provides the ability to use the first chamber primarily for nanostructure formation and the second actinic chamber primarily for the final curing of the nanostructured coating. Advantages of the two chamber cure include: enable controlling the inhibition gas content and actinic radiation (e.g., level and spectrum) for desired nanostructure formation in first actinic radiation chamber and controlling the inhibition gas content and actinic radiation (e.g., level and spectrum) for the desired final cure of the nanostructured coating. The two actinic radiation chambers may be uncoupled (physically separated and not in fluid communication) as shown in FIG. 3C and the two actinic radiation chambers may be optionally coupled (physically joined and in fluid communication) as shown in FIG. 3D.

Uncoupled two chamber actinic radiation, as shown in FIG. 3C, provides for independent control of (all process and equipment parameters) polymerization sections 360 and 370. This is indicated by the prime designation for polymerization section 370. FIG. 3C is a schematic view of polymerization section 360 and 370 of process 300 shown in FIG. 3A. FIG. 3C shows a cross-section of polymerization section 360 and 370 as viewed along an edge of substrate 302. Polymerization section 360 includes housing 321 and quartz plate 322 that provide boundaries between the radiation source 325 and cure chamber environment 327. Cure chamber environment 327 partially surrounds first coating 356 and (at least partially) polymerized coating 366 on substrate 302. At least partially polymerized coating 366 includes nanostructures described herein.

Controlled cure chamber environment 327 will now be described. Housing 321 includes entrance aperture 328 and exit aperture 329 that can be adjusted to provide any desired gap between substrate 302, coating 356 on substrate 302, and the respective aperture. Controlled cure chamber environment 327 and first and second coatings 356 and 366 temperatures can be maintained by control of the temperature of platen 326 (or temperature controlled roll for cure chamber 370) (which can be fabricated from metal that is cooled by for example either air or water to control the temperature by removing the generated heat) and appropriate control of the temperature, composition, pressure and flow rate of first input gas 331, second input gas 333, first output gas 335 and second output gas 334. Appropriate adjustment of the sizes of the entrance and exit apertures 328, 329 can aid control of the pressure and flow rate of first and second output gases 335, 334, respectively. The inhibitor gas content is monitored through port 323 in chamber housing 321.

First input gas manifold 330 is positioned within housing 321 proximate entrance aperture 328, to distribute first input gas 331 uniformly across the width of first coating 356. Second input gas manifold 332 is positioned within housing 321 proximate exit aperture 329, to distribute second input gas 333 uniformly across the width of second coating 366. First and second input gases 331, 333 can be the same or they can be different, and can include inert gasses 341 and 342 (e.g., nitrogen and carbon dioxide) combined with inhibition gasses 344 and 345 (e.g., oxygen and air) which can be combined to control the concentration of inhibition gas in input gas 331 and 333. The relative compositions, flow rates, flow velocities, flow impingement or orientation on the coating, and temperature of each of first and second input gases 331, 333 can be controlled independently, and can be adjusted to achieve the desired environment in the radiation cure chamber. In some embodiments, only one of first and second input gases 331, 333 may be flowing. Other configurations of input gas manifolds are also possible.

Polymerization section 370 includes housing 321′ and quartz plate 322′ that provide boundaries between the radiation source 325′ and cure chamber environment 327′. Cure chamber environment 327′ partially surround first coating 366 and (at least partially) polymerized coating 376 on substrate 302. At least partially polymerized coating 366 includes nanostructures as described herein.

Controlled cure chamber environment 327′ will now be described. Housing 321′ includes entrance aperture 328′ and exit aperture 329′ that can be adjusted to provide any desired gap between substrate 302, first and second coatings 366 and 376 on substrate 302, and the respective aperture. Controlled cure chamber environment 327′ and first and second coatings 366 and 376 temperatures can be maintained by control of the temperature of platen 326′ (or temperature controlled roll for cure chamber 370) (which can be fabricated from metal that is cooled by for example either air or water to control the temperature by removing the generated heat) and appropriate control of the temperature, composition, pressure and flow rate of first input gas 331′, second input gas 333′, first output gas 335′ and second output gas 334′. Appropriate adjustment of the sizes of entrance and exit apertures 328′, 329′ can aid control of the pressure and flow rate of first and second output gases 335′, 334′, respectively. The inhibitor gas content is monitored through port 323′ in chamber housing 321′.

First input gas manifold 330′ is positioned within housing 321′ proximate entrance aperture 328′, to distribute first input gas 331′ uniformly across the width of first coating 366. Second input gas manifold 332′ is positioned within housing 321′ proximate exit aperture 329′, to distribute second input gas 333′ uniformly across the width of second coating 376. First and second input gases 331′, 333′ can be the same or they can be different, and can include inert gasses 341′ and 342′ (e.g., nitrogen and carbon dioxide) combined with inhibition gasses 344′ and 345′ (e.g., oxygen and air) which can be combined to control the concentration of inhibition gas in input gas 331′ and 333′. The relative compositions, flow rates, flow velocities, flow impingement or orientation on the coating, and temperature of each of first and second input gases 331′, 333′ can be controlled independently, and can be adjusted to achieve the desired environment in the radiation cure chamber. In some cases, only one of first and second input gases 331′, 333′ may be flowing. Other configurations of input gas manifolds are also possible.

Coupled two chamber actinic radiation curing system, as shown in FIG. 3D, limits the ability to independently control cure environments 1327 and 1327′ in polymerization sections 1360 and 1370.

360 and 370 in FIGS. 3A and 3C are replaced with 1360 and 1370, respectfully. FIG. 3D is a schematic view of the polymerization sections 1360 and 1370 of process 300 shown in FIG. 3A. FIG. 3D shows a cross-section of polymerization section 1360 and 1370 as viewed along an edge of substrate 1302. Polymerization section 1360 includes housing 1321 and quartz plate 1322 that provide boundaries between radiation source 1325 and cure chamber environment 1327. Cure chamber environment 1327 partially surrounds first coating 1356 and (at least partially) polymerized intermediate coating 1366 on substrate 1302. At least partially polymerized coating 1366 includes nanostructures described herein.

Controlled cure chamber environment 1327 will now be described. Housing 1321 includes entrance aperture 1328 and exit aperture 1329 that can be adjusted to provide any desired gap between substrate 1302, coating 1356 on substrate 1302, and the respective aperture. Controlled cure chamber environment 1327 and first coating 1356 and intermediate coating 1366 temperatures can be maintained by control of the temperature of platen 1326 (which can be fabricated from metal that is cooled by for example either air or water to control the temperature by removing the generated heat) and appropriate control of the temperature, composition, pressure and flow rate of first input gas 1331, second input gas 1333, first output gas 1335 and second output gas 1334. Appropriate adjustment of the sizes of entrance and exit apertures 1328, 1329, respectively can aid control of the pressure and flow rate of first and second output gases 1335, 1334, respectively. The inhibitor gas content is monitored through port 1323 in chamber housing 1321.

First input gas manifold 1330 is positioned within housing 1321 proximate entrance aperture 1328, to distribute first input gas 1331 uniformly across the width of first coating 1356. Second input gas manifold 1332 is positioned within housing 1321 proximate exit aperture 1329, to distribute second input gas 1333 uniformly across the width of second coating 1376. First and second input gases 1331, 1333 can be the same or they can be different, and can include inert gasses 1341 and 1342 (e.g., nitrogen carbon dioxide) combined with inhibition gasses 1344 and 1345 (e.g., oxygen and air) which can be combined to control the concentration of inhibition gas in input gas 1331 and 1333. The relative compositions, flow rates, flow velocities, flow impingement or orientation on the coating, and temperature of each of first and second input gases 1331, 1333, respectively can be controlled independently, and can be adjusted to achieve the desired environment in the radiation cure chamber. In some cases, only one of first and second input gases 1331, 1333, respectively, may be flowing. Other configurations of input gas manifolds are also possible.

Polymerization section 1370 includes housing 1321 and quartz plate 1322′ that provide boundaries between radiation source 1325′ and cure chamber environment 1327′. Cure chamber environment 1327′ partially surrounds first coating 1366 and (at least partially) polymerized coating 1376 on substrate 1302. At least partially polymerized intermediate coating 1366 includes nanostructures described herein.

Controlled cure chamber environment 1327′ will now be described. Housing 1321 includes entrance aperture 1328 and exit aperture 1329 that can be adjusted to provide any desired gap between substrate 1302, first and second coating 1366 and 1376 on substrate 1302, and the respective aperture. Controlled cure chamber environment 1327′ and intermediate coating 1366 and second coating 1376 temperatures can be maintained by control of the temperature of platen 1326′ (which can be fabricated from metal that is cooled by, for example, either air or water to control the temperature by removing the generated heat) and appropriate control of the temperature, composition, pressure and flow rate of first input gas 1331, second input gas 1333, first output gas 1335 and second output gas 1334. Appropriate adjustment of the sizes of entrance and exit apertures 1328, 1329, respectively, can aid control of the pressure and flow rate of first and second output gases 1335, 1334, respectively. The inhibitor gas content is monitored through port 1323′ in chamber housing 1321.

First input gas manifold 1330 is positioned within housing 1321 proximate entrance aperture 1328, to distribute first input gas 1331 uniformly across the width of first coating 1366. Second input gas manifold 1332 is positioned within housing 1321 proximate exit aperture 1329, to distribute second input gas 1333 uniformly across the width of second coating 1376. First and second input gases 1331, 1333 can be the same or they can be different, and can include inert gasses 1341 and 1342 (e.g., nitrogen and carbon dioxide) combined with inhibition gasses 1344 and 1345 (e.g., oxygen and air) which can be combined to control the concentration of inhibition gas in input gas 1331 and 1333. The relative compositions, flow rates, flow velocities, flow impingement or orientation on the coating, and temperature of each of first and second input gases 1331, 1333, respectively, can be controlled independently, and can be adjusted to achieve the desired environment in the radiation cure chamber. In some cases, only one of first and second input gases 1331, 1333 may be flowing. Other configurations of input gas manifolds are possible too.

In some embodiments of methods described herein, a portion of the actinic radiation curing is conducted in a first chamber having a first inhibitor gas and a first actinic radiation level, and a portion of the actinic radiation curing is conducted in a second chamber having a second inhibitor gas and a second actinic radiation level, wherein the first inhibitor gas has a lower oxygen content than the second inhibitor gas, and wherein the first actinic radiation level is higher than the second actinic radiation level. In some embodiments, the first inhibitor gas has an oxygen content in a range from 100 ppm to 100,000 ppm, and the second inhibitor gas has an oxygen content in a range from 100 ppm to 100,000 ppm. In some embodiments, the final curing of the free radical curable layer is conducted in the second chamber. For nanostructure formation this would not be the preferred mode having first chamber radiation level high and oxygen low. However we can operate as described and provide nanostructure.

In some embodiments of methods described herein, a portion of the actinic radiation curing is conducted in a first chamber having a first inhibitor gas and a first actinic radiation level, and a portion of the actinic radiation curing is conducted in a second chamber having a second inhibitor gas and a second actinic radiation level, wherein the first inhibitor gas has a higher oxygen content than the second inhibitor gas, and wherein the first actinic radiation level is lower than the second actinic radiation level. In some embodiments, the first inhibitor gas has an oxygen content in a range from 100 ppm to 100,000 ppm, and the second inhibitor gas has an oxygen content in a range from 100 ppm to 100,000 ppm. In some embodiments, the final curing of the free radical curable layer is conducted in the second chamber.

In some embodiments of methods described herein, a portion of the actinic radiation curing is conducted in a first chamber having a first inhibitor gas and a first actinic radiation level, and a portion of the actinic radiation curing is conducted in a second chamber having a second inhibitor gas and a second actinic radiation level, wherein the first and second inhibitor gases have substantially the same oxygen content, and may even be the same gas (i.e., the same type of gas), and wherein the first actinic radiation level is higher than the second actinic radiation level. In some embodiments, the inhibitor gas has an oxygen content in a range from 100 ppm to 100,000 ppm. In some embodiments, the final curing of the free radical curable layer is conducted in the second chamber. In this embodiment, two actinic radiation sources are located in a single (or the two chambers are physically connected and in fluid communication) actinic radiation cure chamber as shown in FIG. 3D.

In some embodiments of methods described herein, a portion of the actinic radiation curing is conducted in a first chamber having a first inhibitor gas and a first actinic radiation level, and a portion of the actinic radiation curing is conducted in a second chamber having a second inhibitor gas and a second actinic radiation level, wherein the first and second inhibitor gases have substantially the same oxygen content, and may even be the same gas (i.e., the same type of gas), and wherein the first actinic radiation level is lower than the second actinic radiation level. In some embodiments, the inhibitor gas has an oxygen content in a range from 100 ppm to 100,000 ppm. In some embodiments, the final curing of the free radical curable layer is conducted in the second chamber. In this embodiment two actinic radiation sources are located in a single actinic radiation cure chamber as shown in FIG. 3D.

In some embodiments, of methods described herein, prior to the actinic curing, further comprising at least one of passing the free radical curable layer having submicrometer particles dispersed therein through a nip or embossing the free radical curable layer having submicrometer particles dispersed therein to provide a two scale structure with combinations of (submicrometer) nanostructure and microstructure surface properties on the free radical curable layer. Nipping uncured coating (e.g., WO2009/014901 A2, (Yapel et. al.), published Jan. 29, 2009, the disclosure of which is incorporated herein by reference) generates primary structure (e.g., micrometer size) and inhibitor gas controlled cure generates secondary structure (e.g., nanostructure) on primary structure.

In some embodiments of methods described herein, prior to completing the actinic curing, further comprising at least one of passing the free radical curable layer having submicrometer particles dispersed therein through a nip or embossing the free radical curable layer having submicrometer particles dispersed therein to provide a two scale structure with combinations of nanostructure and microstructure surface properties on the free radical curable layer. Partial actinic radiation curing (in 02 controlled atmosphere) before nip or embossing can provide additional control of the final structure.

Typically, material described herein is in the form of a layer. In some embodiments, the layer has a thickness of at least 500 nm (in some embodiments, at least 1 micrometer, 1.5 micrometer, 2 micrometer, 2.5 micrometers, 3 micrometers, 4 micrometers, 5 micrometers, 7.5 micrometers, or even at least 10 micrometers).

In some embodiments, material described herein comprises particles (and beads (e.g., polymer beads)) in a range from 1 micrometer to 100 micrometer in size protruding from the major surface (in some embodiments 2 micrometers to 50 micrometers, or even 3 micrometers to 25 micrometers). In some embodiments the particle protrudes by up to 50 percent of their respective particle sizes.

In some embodiments, material described herein the portion of the submicrometer particles protruding from the major surface protrudes in a range from 60 nm to 300 nm (in some embodiments, 75 nm to 250 nm, or even 75 nm to 150 nm).

In some embodiments, material described herein there is an average spacing between the protruding submicrometer particles in a range from 40 nm to 300 nm (in some embodiments, 50 nm to 275 nm, 75 nm to 250 nm, or even 100 nm to 225 nm).

In another aspect, materials described herein have a reflection less than 3 percent (in some embodiments, less than 3.5 (in some embodiments, less than 3, 2.5, 2, 1.5, or even less than 1) percent as measured by Test Method 1 in the Examples below. The materials described herein can have a haze less than 5 (in some embodiments, less than 4, 3, 2.5, 2, 1.5, or even less than 1) percent as measured by Test Method 2 in the Examples below. In another aspect, materials described herein have a visible light transmission of at least 90 percent (in some embodiments, at least 94 percent, 95 percent, 96 percent, 97 percent, or even 98 percent) as measured by Test Method 2.

In some embodiments, submicrometer structured articles described herein comprise additional layers. For example, the article may comprise an additional fluorochemical layer to give the article improved water and/or oil repellency properties. The submicrometer structured surface may also be post treated (e.g., with an additional plasma treatment). Plasma post treatments may include surface modification to change the chemical functional groups that might be present on the submicrometer structure or for the deposition of thin films that enhance the performance of the submicrometer structure. Surface modification can include the attachment of methyl, fluoride, hydroxyl, carbonyl, carboxyl, silanol, amine, or other functional groups. The deposited thin films can include fluorocarbons, glass-like, diamond-like, oxide, carbide, and nitride. When the surface modification treatment is applied, the density of the surface functional groups is high due to the large surface area of the submicrometer structured surface. When amine functionality is used, biological agents (e.g., antibodies, proteins, and enzymes) can be easily grafted to the amine functional groups. When silanol functionality is used, silane chemistries can be easily applied to the submicrometer structured surface due to the high density of silanol groups. Antimicrobial, easy-clean, and anti-fouling surface treatments that are based on silane chemistry are commercially available. Antimicrobial treatments may include quaternary ammonium compounds with silane end group. Easy-clean compounds may include fluorocarbon treatments, such as perfluoropolyether silane, and hexafluoropropyleneoxide (HFPO) silane. Anti-fouling treatments may include polyethyleneglycol silane. When thin films are used, these thin films may provide additional durability to the submicrometer structure or provide unique optical effects depending upon the refractive index of the thin film. Specific types of thin films may include diamond-like carbon (DLC), diamond-like glass (DLG), amorphous silicon, silicon nitride, plasma polymerized silicone oil, aluminum, silver, gold, and copper.

Optionally, a functional layer(s) can be provided as generally described in application having U.S. Ser. No. 61/524,406, filed Aug. 17, 2011, the disclosure of which is incorporated herein by reference.

In some embodiments, submicrometer structured articles described herein comprises etching at least a portion of the polymer matrix using plasma. The methods can be carried out at moderate vacuum conditions (e.g., in a range from about 5 mTorr to about 1000 mTorr) or atmospheric pressure environment.

In some embodiments, the surface of the matrix comprising the submicrometer particles may be microstructured. For example, a transparent conductive oxide-coated substrate, with a v-groove microstructured surface can be coated with polymerizable matrix materials comprising the submicrometer particles and treated by plasma etching to form nanostructures on v-groove microstructured surface. Other examples include a fine micro-structured surface resulting from controlling the solvent evaporation process from multi-solvent coating solutions, reported as in U.S. Pat. No. 7,378,136 (Pokorny et al.); or the structured surface from the micro-replication method reported in U.S. Pat. No. 7,604,381 (Hebrink et al.); or any other structured surface induced, for example, by electrical and magnetic fields.

Optionally, articles described herein further comprise an optically clear adhesive disposed on the second surface of the substrate. The optically clear adhesives that may be used in the present disclosure preferably are those that exhibit an optical transmission of at least about 90%, or even higher, and a haze value of below about 5% or even lower, as measured on a 25 micrometer thick sample in the matter described below in the Example section under the Haze and Transmission Tests for optically clear adhesive. Suitable optically clear adhesives may have antistatic properties, may be compatible with corrosion sensitive layers, and may be able to be released from the substrate by stretching the adhesive. Illustrative optically clear adhesives include those described in PCT Pub. No. WO 2008/128073 (Everaerts et al.) relating to antistatic optically clear pressure sensitive adhesive; U.S. Pat. Appl. Pub. No. US 2009/0229732A1 (Determan et al.) relating to stretch releasing optically clear adhesive; U.S. Pat. Appl. Pub. No. US 2009/0087629 (Everaerts et al.) relating to indium tin oxide compatible optically clear adhesive; U.S. Pat. Appl. Pub. No. US 2010/0028564 (Everaerts et al.) relating to antistatic optical constructions having optically transmissive adhesive; U.S. Pat. Appl. Pub. No. 2010/0040842 (Everaerts et al.) relating to adhesives compatible with corrosion sensitive layers; PCT Pub. No. WO 2009/114683 (Determan et al.) relating to optically clear stretch release adhesive tape; and PCT Pub. No. WO 2010/078346 (Yamanaka et al.) relating to stretch release adhesive tape. In one embodiment, the optically clear adhesive has a thickness of up to about 5 micrometer.

In some embodiments, articles described herein further comprise a hardcoat comprising at least one of SiO₂ nanoparticles or ZrO₂ nanoparticles dispersed in a crosslinkable matrix comprising at least one of multi(meth)acrylate, polyester, epoxy, fluoropolymer, urethane, or siloxane (which includes blends or copolymers thereof). Commercially available liquid-resin based materials (typically referred to as “hardcoats”) may be used as the matrix or as a component of the matrix. Such materials include that available from California Hardcoating Co., San Diego, Calif., under the trade designation “PERMANEW;” and from Momentive Performance Materials, Albany, N.Y., under the trade designation “UVHC.” Additionally, commercially available nanoparticle filled matrix may be used such as those available from Nanoresins AG, Geesthacht Germany, under the trade designations “NANOCRYL” and “NANOPDX.”

In some embodiments, the articles described herein further comprises a surface protection adhesive sheet (laminate premasking film) having a releasable adhesive layer formed on the entire area of one side surface of a film, such as a polyethylene film, a polypropylene film, a vinyl chloride film, or a polyethylene terephthalate film to the surface of the articles, or by superimposing the above-mentioned polyethylene film, a polypropylene film, a vinyl chloride film, or a polyethylene terephthalate film on the surface of articles.

### Exemplary Embodiments

1A. A material comprising submicrometer particles dispersed in a polymeric matrix, the material having a thickness, at least first and second integral regions across the thickness, the first region having the outer major surface, wherein at least the outer most submicrometer particles are partially conformally coated by and, wherein the first and second regions have first and second average densities, respectively, and wherein the first average density is less than the second average density.

2A. The material of Embodiment 1A, wherein, the difference between the first and second average densities is in a range from 0.1 g/cm³ to 0.8 g/cm³ (in some embodiments, 0.2 g/cm³ to 0.7 g/cm³, or even 0.3 g/cm³ to 0.6 g/cm³).

3A. The material of any preceding Embodiment A, wherein the second region is free of substantially closed porosity.

4A. The material of any preceding Embodiment A, wherein at least the outer most submicrometer particles are covalently bonded to the polymeric matrix.

5A. The material of any preceding Embodiment A, wherein the submicrometer particles each have an outer surface, and wherein at least 50 (in some embodiments, at least 60, 70, 75, 80, 90, 95, 99, or even 100) percent by volume of the submicrometer particles have their outer surface is free of fluorine.

6A. The material of any preceding Embodiment A having a Steel Wool Scratch Test value of at least 1 (in some embodiments, of at least 2, 3, 4, or even 5).

7A. The material of any preceding Embodiment A, wherein at least a portion of the polymer matrix is made from a prepolymer comprising free radically curable prepolymer.

8A. The material of Embodiment 7A, wherein at least a portion of the prepolymer comprises at least one of a monomeric or oligomeric multifunctional (meth)acrylate.

9A. The material of Embodiment 7A, wherein at least a portion of the prepolymer comprises at least one of a monomeric or oligomeric difunctional (meth)acrylate.

10A. The material of Embodiment 7A, wherein at least a portion of the prepolymer comprises at least one of a monomeric or oligomeric monofunctional (meth)acrylate.

11A. The material of Embodiment 7A, wherein at least a portion of the prepolymer comprises a mixture of mutifuctional, difuctional, and mono function (meth)acrylates.

12A. The material of any of Embodiments 7A to 11A, wherein the prepolymer composition has a functionality of 1.25 to 2.75 (in some embodiments, 1.5 to 2.5 or 1.75 to 2.25).

13A. The material of any preceding Embodiment A, wherein the radically curable prepolymer comprises a hardcoat.

14A. The material of any preceding Embodiment A, wherein the submicrometer particles comprise surface modified submicrometer particles.

15A. The material of any preceding Embodiment A, wherein the submicrometer surface modified particles are modified with a surface modifiers that have a functional group that radically cured into the polymer matrix.

16A. The material of any of Embodiments 1A to 14A, wherein the submicrometer surface modified particles are modified with a surface modifiers that have a functional group that did not radically cure into the polymer matrix.

17A. The material of any of Embodiments 1A to 14A, wherein the submicrometer surface modified particles comprise (a) surface modified particles modified with a surface modifiers that have a functional group that radically cured into the polymer matrix and (b) submicrometer surface modified particles modified with a surface modifiers that have a functional group that did not radically cure into the polymer matrix.

18A. The material of any of Embodiments 1A to 14A, wherein the submicrometer surface modified particles are modified with at least two different surface modifiers.

19A. The material of any of Embodiments 1A to 14A, wherein the submicrometer particles comprise first surface modified particles modified with a first surface modifier and second surface modified particles modified with a surface modifier.

20A. The material of any preceding Embodiment A, wherein the submicrometer particles have particle sizes of at least 5 nm to 1000 nm (in some embodiments, in a range from 20 nm to 750 nm (in some embodiments, 50 nm to 500 nm, 75 nm to 300 nm, or even 100 nm to 200 nm)).

21A. The material of any preceding Embodiment A, wherein the submicrometer particles comprise at least one of carbon, metal, metal oxide, metal carbide, metal nitride, or diamond.

22A. The material of any preceding Embodiment A, wherein the submicrometer particles comprise silica.

23A. The material of any preceding Embodiment A, wherein the submicrometer particles have particle sizes in a range from 5 nm to 10 micrometer (in some embodiments, from 25 nm to 5 micrometer, from 50 nm to 1 micrometer, or even if from 75 nm to 500 nm).

24A. The material of any preceding Embodiment A further comprising particles (e.g., polymer beads) having particles sizes in the range 3 micrometer to 100 micrometer (in some embodiments 3 micrometers to 50 micrometers).

25A. The material of any preceding Embodiment A, wherein the submicrometer particles have a bimodal (in some embodiments, tri-modal) distribution.

26A. The material of any preceding Embodiment A, wherein there is an average spacing between the protruding submicrometer particles in a range from 40 nm to 300 nm (in some embodiments, 50 nm to 275 nm, 75 nm to 250 nm, or even 100 nm to 225 nm).

27A. The material of any preceding Embodiment A, wherein the submicrometer particles dispersed in the polymeric matrix has an average particle size, and wherein the first region has a thickness less than the average particle size of the submicrometer particles.

28A. The material of any of Embodiments 1A to 26A, wherein the submicrometer particles dispersed in the polymeric matrix has an average particle size, and wherein the first region has a thickness greater than the average particle size of the submicrometer particles.

29A. The material of any of Embodiments 1A to 26A, wherein the submicrometer particles dispersed in the polymeric matrix has an average particle size, and wherein the first region has a thickness at least twice the average particle size of the submicrometer particles.

30A. The material of any preceding Embodiment A that is a layer.

31A. The layer of Embodiment 30A, wherein the layer has a thickness, wherein the submicrometer particles dispersed in the polymeric matrix has an average particle size, and wherein the layer has a thickness in a range from 3 to 5 times the average particle size of the submicrometer particles.

32A. The layer of Embodiment 31A having a thickness of at least 500 nm (in some embodiments, at least 1 micrometer, 1.5 micrometer, 2 micrometer, 2.5 micrometers, 3 micrometers, 4 micrometers, 5 micrometers, 7.5 micrometers, or even at least 10 micrometers).

33A. An article comprising a substrate having first and second generally opposed major surfaces with the layer of any of Embodiments 30A to 32A on the first major surface.

34A. The article of Embodiment 33A, wherein the substrate is a polarizer (e.g., reflective polarizer or absorptive polarizer).

35A. The article of either Embodiment 33A or 34A further comprising a hardcoat comprising at least one of SiO₂ nanoparticles or ZrO₂ nanoparticles dispersed in a crosslinkable matrix comprising at least one of multi(meth)acrylate, epoxy, fluoropolymer, urethane, or siloxane.

36A. The article of any of Embodiments 33A to 35A having a reflection less than 3.5 (in some embodiments, less than 3, 2.5, 2, 1.5%, or even less than 1) percent.

37A. The article of any of Embodiments 33A to 36A having a haze less than 5 (in some embodiments, less than 4, 3, 2.5, 2 percent, 1.5 percent, or even less than 1) percent.

38A. The article of any of Embodiments 33A to 37A having a visible light transmission of at least 90 percent (in some embodiments, at least 94 percent, 95 percent, 96 percent, 97 percent, or even 98 percent).

39A. The article of any of Embodiments 33A to 38A further comprising a functional layer disposed between the first major surface of the substrate and the layer.

40A. The article of any of Embodiments 33A to 39A, further comprising a pre-mask film disposed on the layer.

41A. The article of any of Embodiments 33A to 40A, further comprising a functional layer disposed on the layer.

42A. The article of any of Embodiments 33A to 38A or 41A further comprising a functional layer disposed on the second major surface of the substrate.

43A. The article of any of Embodiments 33A to 38A, further comprising an optically clear adhesive disposed on the second surface of the substrate, the optically clear adhesive having at least 90% transmission in visible light and less than 5% haze.

44A. The article of Embodiment 43A further comprising a major surface of a glass substrate attached to the optically clear adhesive.

45A. The article of Embodiment 44A, further comprising a major surface of a polarizer substrate attached to the optically clear adhesive.

46A. The article of Embodiment 44A further comprising a major surface of a touch sensor attached to the optically clear adhesive.

47A. The article of Embodiment 44A further comprising a release liner disposed on the second major surface of the optically clear adhesive.

1B. A material comprising submicrometer particles dispersed in a polymeric matrix, the material having a thickness, at least first and second integral regions across the thickness, wherein the first and second regions have first and second average densities, respectively, and wherein the first average density is less than the second average density, and wherein the material has a Steel Wool Scratch Test value of at least 1 (in some embodiments, at least 2, 3, 4, or even 5).

2B. The material of Embodiment 2B, the first region having the outer major surface wherein at least the outer most submicrometer particles are partially conformally coated with the polymeric matrix.

3B. The material of either Embodiment 1B or 2B, wherein the submicrometer particles are covalently bonded to the polymeric matrix.

4B. The material of any preceding Embodiment B, wherein, the difference between the first and second average densities is in a range from 0.1 g/cm³ to 0.8 g/cm³ (in some embodiments, 0.2 g/cm³ to 0.7 g/cm³, or even 0.4 g/cm³ to 0.6 g/cm³).

5B. The material of any preceding Embodiment B, wherein the second region is free of substantially closed porosity.

6B. The material of any preceding Embodiment B, wherein the submicrometer particles each have an outer surface, and wherein at least 50 (in some embodiments, at least 60, 70, 75, 80, 90, 95, 99, or even 100) percent by volume of the submicrometer particles have their outer surface is free of fluorine.

7B. The material of any preceding Embodiment B, wherein at least a portion of the polymer is made from a prepolymer comprising free radically curable prepolymer.

8B. The material of Embodiment 7B, wherein at least a portion of the prepolymer comprises at least one of a monomeric or oligomeric multifunctional (meth)acrylate.

9B. The material of Embodiment 7B, wherein at least a portion of the prepolymer comprises at least one of a monomeric or oligomeric difunctional (meth)acrylate.

10B. The material of Embodiment 7B, wherein at least a portion of the prepolymer comprises at least one of a monomeric or oligomeric monofunctional (meth)acrylate.

11B. The material of Embodiment 7B, wherein at least a portion of the prepolymer comprises a mixture of mutifuctional, difuctional, and mono function (meth)acrylates.

12B. The material of any of Embodiments 7B to 11B, wherein the prepolymer composition has a functionality of 1.25 to 2.75 (in some embodiments, 1.5 to 2.5 or 1.75 to 2.25).

13B. The material of any preceding Embodiment B, wherein the radically curable prepolymer comprises a hardcoat.

14B. The material of any preceding Embodiment B, wherein the submicrometer particles comprise surface modified submicrometer particles.

15B. The material of any preceding Embodiment B, wherein the submicrometer surface modified particles are modified with a surface modifiers that have a functional group that radically cured into the polymer matrix.

16B. The material of any of Embodiments 1B to 14B, wherein the submicrometer surface modified particles are modified with a surface modifiers that have a functional group that did not radically cure into the polymer matrix.

17B. The material of any of Embodiments 1B to 14B, wherein the submicrometer surface modified particles comprise (a) surface modified particles modified with a surface modifiers that have a functional group that radically cured into the polymer matrix and (b) submicrometer surface modified particles modified with a surface modifiers that have a functional group that did not radically cure into the polymer matrix.

18B. The material of any of Embodiments 1B to 14B, wherein the submicrometer surface modified particles are modified with at least two different surface modifiers.

19B. The material of any of Embodiments 1B to 14B, wherein the submicrometer particles comprise first surface modified particles modified with a first surface modifier and second surface modified particles modified with a surface modifier.

20B. The material of any preceding Embodiment B, wherein the submicrometer particles have particle sizes of at least 5 nm to 1000 nm (in some embodiments, in a range from 20 nm to 750 nm (in some embodiments, 50 nm to 500 nm, 75 nm 300 nm, or even 100 nm to 200 nm)).

21B. The material of any preceding Embodiment B, wherein the submicrometer particles are present in a range from 10 percent to 70 percent (in some embodiments, 30 percent to 60 percent, or even 35 percent to 55 percent) by volume, based on the total volume of the material.

22B. The material of any preceding Embodiment B, wherein the submicrometer particles comprise at least one of carbon, metal, metal oxide, metal carbide, metal nitride, or diamond.

23B. The material of any preceding Embodiment B, wherein the submicrometer particles comprise silica.

24B. The material of any preceding Embodiment B, wherein the submicrometer particles have particle sizes in a range from 5 nm to 10 micrometer (in some embodiments, from 25 nm to 5 micrometer, from 50 nm to 1 micrometer, or even if from 75 nm to 500 nm).

25B. The material of any preceding Embodiment B further comprising particles (e.g., polymer beads) having particles sizes in the range 3 micrometer to 100 micrometer (in some embodiments 3 micrometers to 50 micrometers).

26B. The material of any preceding Embodiment B, wherein the submicrometer particles have a bimodal (in some embodiments, tri-modal) distribution.

27B. The material of any preceding Embodiment B, wherein there is an average spacing between the protruding submicrometer particles in a range from 40 nm to 300 nm (in some embodiments, 50 nm to 275 nm, 75 nm to 250 nm, or even 100 nm to 225 nm).

28B. The material of any preceding Embodiment B, wherein the submicrometer particles dispersed in the polymeric matrix has an average particle size, and wherein the first region has a thickness less than the average particle size of the submicrometer particles.

29B. The material of any Embodiments 1B to 27B, wherein the submicrometer particles dispersed in the polymeric matrix has an average particle size, and wherein the first region has a thickness greater than the average particle size of the submicrometer particles.

30B. The material of any Embodiments 1B to 27B, wherein the submicrometer particles dispersed in the polymeric matrix has an average particle size, and wherein the first region has a thickness at least twice the average particle size of the submicrometer particles.

31B. The material of any preceding Embodiment B that is a layer.

32B. The layer of Embodiment 31B, wherein the layer has a thickness, wherein the submicrometer particles dispersed in the polymeric matrix has an average particle size, and wherein the layer has a thickness in a range from 3 to 5 times the average particle size of the submicrometer particles.

33B. The layer of Embodiment 32B having a thickness of at least 500 nm (in some embodiments, at least 1 micrometer, 1.5 micrometer, 2 micrometer, 2.5 micrometers, 3 micrometers, 4 micrometers, 5 micrometers, 7.5 micrometers, or even at least 10 micrometers).

34B. An article comprising a substrate having first and second generally opposed major surfaces with the layer of any of Embodiments 31B to 33B on the first major surface.

35B. The article of Embodiment 34B, wherein the substrate is a polarizer (e.g., reflective polarizer or absorptive polarizer).

36B. The article of either Embodiment 34B or 35B further comprising a hardcoat comprising at least one of SiO₂ nanoparticles or ZrO₂ nanoparticles dispersed in a crosslinkable matrix comprising at least one of multi(meth)acrylate, epoxy, fluoropolymer, urethane, or siloxane.

37B. The article of any of Embodiments 34B to 36B having a reflection less than 3.5 (in some embodiments, less than 3, 2.5, 2, 1.5, or even less than 1) percent.

38B. The article of any of Embodiments 34B to 37B having a haze less than 5 (in some embodiments, less than 4, 3, 2.5, 2 percent, 1.5 percent, or even less than 1) percent.

39B. The article of any of Embodiments 34B to 38B having a visible light transmission of at least 90 percent (in some embodiments, at least 94 percent, 95 percent, 96 percent, 97 percent, or even 98 percent).

40B. The article of any of Embodiments 34B to 39B further comprising a functional layer disposed between the first major surface of the substrate and the layer, wherein the functional layer is at least one of a transparent conductive layer or a gas barrier layer.

41B. The article of any of Embodiments 34B to 40B, further comprising a pre-mask film disposed on the layer.

42B. The article of any of Embodiments 34B to 41B, further comprising a functional layer disposed on the layer, wherein this functional layer is at least one of a transparent conductive layer or a gas barrier layer.

43B. The article of any of Embodiments 33B to 39BA or 42B further comprising a functional layer disposed on the second major surface of the substrate, wherein this functional layer is at least one of a transparent conductive layer or a gas barrier layer.

44B. The article of any of Embodiments 34B to 39B, further comprising an optically clear adhesive disposed on the second surface of the substrate, the optically clear adhesive having at least 90% transmission in visible light and less than 5% haze.

45B. The article of Embodiment 44B further comprising a major surface of a glass substrate attached to the optically clear adhesive.

46B. The article of Embodiment 45B, further comprising a major surface of a polarizer substrate attached to the optically clear adhesive.

47B. The article of Embodiment 45B further comprising a major surface of a touch sensor attached to the optically clear adhesive.

48B. The article of Embodiment 45B further comprising a release liner disposed on the second major surface of the optically clear adhesive.

1C. A method of making a material having a structured surface (including any materials of any of Embodiments 1A to 32A or 1 to 33B), the method comprising:

providing a free radical curable layer having particles dispersed therein; and

actinic radiation curing the free radical curable layer in the presence of a sufficient amount of inhibitor gas (e.g., oxygen and air), to inhibit the curing of a major surface region of the layer

to provide a layer having a bulk region with a first degree of cure and a major surface region having a second degree of cure, wherein the first degree of cure is greater than the second degree of cure, and wherein the material having a structured surface that includes a portion of the particles.

2C. The method of Embodiment 1C further comprising additionally curing the layer such that the major surface region (and optionally the bulk region) has a second degree of cure.

3C. The method of either Embodiment 1C or 2C, wherein the inhibiting gas has an oxygen content is 100 ppm to 100,000 ppm.

4C. The method of any of Embodiments 1C to 3C, wherein all actinic radiation curing is conducted in a single chamber.

5C. The method of any of Embodiments 1C to 4C, wherein a portion of the actinic radiation curing is conducted in a first chamber having a first inhibitor gas and a first actinic radiation level, and a portion of the actinic radiation curing is conducted in a second chamber having a second inhibitor gas and a second actinic radiation level, wherein the first inhibitor gas has a lower oxygen content than the second inhibitor gas, and wherein the first actinic radiation level is higher than the second actinic radiation level.

6C. The method of Embodiment 5C, wherein the first inhibitor gas has an oxygen content in a range from 100 ppm to 100,000 ppm, and wherein the second inhibitor gas has an oxygen content in a range from 100 ppm to 100,000 ppm.

7C. The method of either Embodiment 5C or 6C, wherein final curing of the free radical curable layer is conducted in the second chamber.

8C. The method of any of Embodiments 1C to 7C, wherein a portion of the actinic radiation curing is conducted in a first chamber having a first inhibitor gas and a first actinic radiation level, and a portion of the actinic radiation curing is conducted in a second chamber having a second inhibitor gas and a second actinic radiation level, wherein the first inhibitor gas has a higher oxygen content than the second inhibitor gas, and wherein the first actinic radiation level is lower than the second actinic radiation level.

9C. The method of embodiment 8C, wherein the first inhibitor gas has an oxygen content in a range from 100 ppm to 100,000 ppm, and wherein the second inhibitor gas has an oxygen content in a range from 100 ppm to 100,000 ppm.

10C. The method of either Embodiment 8C or 9C, wherein final curing of the free radical curable layer is conducted in the second chamber.

11C. The method of any of Embodiments 1C to 10C, wherein the free radical curable layer comprises at least one of methacrylate, acryalate, styrenic compound, unsaturated hydrocarbon, or vinyl compound.

12C. The method of any of Embodiments 1C to 11C, wherein the free radical curable layer includes solvent (e.g., isopropyl alcohol methylethylketone, 1 methoxy 2 propanol, acetone, ethanol, and water), and wherein the method further comprises at least partially drying the free radical curable layer to remove the solvent prior to the curing.

13C. The method of any of Embodiments 1C to 11C, wherein the free radical curable layer includes a blend of at least two different solvents.

14C. The method of any of Embodiments 1C to 13C, wherein the free radical curable layer further comprises a photoinitiator.

15C. The method of any of Embodiments 1C to 14C, prior to the actinic curing, further comprising at least one of passing the free radical curable layer having particles dispersed therein through a nip or embossing the free radical curable layer having particles dispersed therein to provide at least one of a nanostructured or microstructured surface on the free radical curable layer.

16C. The method of any of Embodiments 1C to 15C, prior to completing the actinic curing, further comprising at least one of passing the free radical curable layer having particles dispersed therein through a nip or embossing the free radical curable layer having particles dispersed therein to provide at least one of a nanostructured or microstructured surface on the free radical curable layer.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Test Method 1—% Reflection

Black vinyl tape (obtained from Yamato International Corporation, Woodhaven, Mich., under the trade designation “#200-38”) was applied to the backside of the sample to be tested using a roller to ensure there were no air bubbles trapped between the black tape and the sample. The same black vinyl tape was similarly applied to a clear glass slide of which reflection from both sides were predetermined in order to have a control sample to establish the % reflection from the black vinyl tape in isolation. The non-taped side of first the taped sample and then the control was then placed against the aperture of a color guide sphere (obtained from BYK-Gardiner, Columbia, Md., under the trade designation “SPECTRO-GUIDE”) to measure the front surface total % reflection (specular and diffuse). The % reflection was then measured at a 10° incident angle for the wavelength range of 400-700 nm, and average % reflection, % R, calculated by subtracting out the % reflection of the control.

### Test Method 2—Transmission, Haze and Clarity

The measurement of average % transmission, haze and clarity was conducted with a haze meter (obtained under the trade designation “BYK HAZEGARD PLUS” from BYK Gardiner) according to ASTM D1003-11 (2011), the disclosures of which are incorporated herein by reference.

### Test Method 3—Steel Wool Scratch Test Treatment

The abrasion resistance of the cured films was tested using a mechanical device (obtained under the trade designation “TABER ABRASER 5900” from Taber Industries, North Tonawanda, N.Y.) capable of oscillating steel wool sheets (#0000 steel wool sheets; obtained under the trade designation “MAGIC SAND-SANDING SHEETS” from Hut Products, Fulton, Mo.) adhered to one of three styluses which are oscillated across the film's surface. The stylus was oscillated over a 55.6 mm wide sweep width at a rate of 75 mm/sec. A “rub” is defined as a single traverse of 50.8 mm. The stylus had a flat, cylindrical base geometry with a diameter of 2.54 cm. The stylus was designed for attachment of weights to increase the force exerted by the steel wool normal to the film's surface. A 307 gram weight was attached to each stylus. 3.3 cm steel wool discs were die cut from the #0000 steel wool sanding sheets and adhered to the 2.54 cm stylus base with tape (obtained under the trade designation “3M BRAND SCOTCH PERMANENT ADHESIVE TRANSFER TAPE” 3M Company, St. Paul, Minn.). One of the stylus performed 24 rubs, one performed 50, and one performed 100 rubs on the sample to be tested. An individual steel wool rating was given for each of the three rubbed locations on the sample. Table 1 (below) provides a description of the steel wool ratings. The three individual ratings were then averaged to produce an overall steel wool rating for the sample.

TABLE 1
Steel Wool Rating

| Rating | Abbreviation | Description |
|---|---|---|
| 5 | NS | No scratches |
| 4 | VLS | Very Light Scratches |
| 3 | LS | Light Scratches |
| 2 | S | Scratches |
| 1 | VS | Very Scratched |
| 0 | HS | Heavy Scratches |

### Test Method 4—Refractive Index

The refractive index of the coatings was measured at 632.8 nm using a prism coupler (obtained as MODEL 2010 from Metricon Corporation Inc., Pennington, N.J.).

TABLE 2

| Abbreviation or | |
|---|---|
| Trade | |
| Designation | Description |
| MPS | 3-(methacryloyloxy)propyltrimethoxy silane obtained from Alfa Aesar, Ward Hill, MA |
| A1230 | Nonionic silane dispersing agent with no radically reactive double bond functionality; |
| | obtained under the trade designation “SILQUEST A1230” obtained from Momentive |
| | Performance Materials, Wilton, CT |
| DI water | De-ionized water |
| Radical | A radical inhibitor obtained under the trade designation PROSTAB 5198” from BASF |
| Inhibitor | Corporation, Tarrytown, NY |
| 1-methoxy-2- | Alcohol obtained from Aldrich Chemical, Milwaukee, WI |
| propanol | |
| NALCO 2326 | Colloidal silica having a nominal particle size of 5 nm particle size obtained under the |
| | trade designation “NALCO 2326” from Nalco Company, Bedford Park, IL |
| NALCO 2327 | Colloidal silica having a nominal particle size of 20 nm particle size obtained under the |
| | trade designation “NALCO 2327” from Nalco Company |
| NALCO 2329 | Colloidal silica nominal particle size of 75 nm particle size obtained under the trade |
| | designation “NALCO 2329” from Nalco Company |
| MP4540 | Colloidal silica having a nominal particle size of 440 nm particle size obtained under |
| | the trade designation “MP4540” from Nissan Chemical, Houston, TX |
| MP2040 | Colloidal silica nominal having a particle size of 190 nm obtained under the trade |
| | designation “MP2040” from Nissan Chemical |
| MP1040 | Colloidal silica having a nominal particle size of 100 nm obtained under the trade |
| | designation “MP1040” from Nissan Chemical |
| SR444 | Pentaerythritol triacrylate obtained under the trade designation “SR444” from |
| | Sartomer, Exton, PA |
| SR238 | 1,6 hexanediol diacrylate obtained under the trade designation “SR238” from Sartomer |
| SR506 | isobornyl acrylate obtained under the trade designation “SR506” from Sartomer |
| SR295 | Pentaerythritol tetraacrylate obtained under the trade designation “SR295” from |
| | Sartomer |
| SR492 | Propoxylated trimethylolpropane triacrylate obtained under the trade designation |
| | “SR492” from Sartomer |
| SR494 | Ethoxylated pentaerythritol tetraacrylate obtained under the trade designation “SR494” |
| | from Sartomer |
| SR440 | Isooctyl acrylate obtained under the trade designation “SR440” from Sartomer |
| SR350 | Trimethylolpropane trimethacrylate obtained under the trade designation “SR350” |
| | from Sartomer |
| SR239 | 1,6 hexanediol dimethacrylate obtained under the trade designation “SR239” from |
| | Sartomer |
| IR 184 | A photoinitiator obtained under the trade designation “IGACURE 184” from BASF |
| | Corporation, Tarrytown, NY |
| IPA | Isopropyl alcohol obtained from Aldrich Chemical |
| EA | Ethyl Acetate obtained from Aldrich Chemical |
| MEK | Methyl ethyl ketone obtained from Aldrich Chemical |
| TEGORAD | Silicone polyether acrylate obtained under the trade designation “TEGORAD 2250” |
| 2250 | from Evonik Goldschmidt Corp., Hopewell, VA |
| HFPO | Prepared as Copolymer B in US2010/0310875 A1 (Hao et. al.) |

### Preparation Surface Modified Silica Submicrometer Particle Dispersions

The particles were modified with different ratios of two silane coupling agents, “MPS” and “A1230.” The MPS has carbon/carbon double bonds that can cure into the prepolymer system and the A1230 does not. Changing the ratio of these two silanes changes the number of double bonds on the particle surface. Four different surface modifier combinations were used. The molar ratios of MPS:A1230 silane coupling agents used were: 100:0, 75:25, 50:50, and 25:75.

### Measurement of Solids Content

The silane modified dispersions were prepared by first mixing aqueous colloidal silica with 1-methoxy-2-propanol and the silane coupling agents. The mixture was then heated to facilitate reaction of the silane with the silica particles. This resulted in a surface modified dispersion with a solids content of about 10-21 weight % solids and a 1-methoxy-2-propanol:water weight ratio of about 65:35 to 5:43. The dispersions were further processed in one of two ways to increase the solids content and increase the 1-methoxy-2-propanol/water weight ratio.

In one procedure a solvent exchange process was used where the dispersion was concentrated via distillation, then additional 1-methoxy-2-propanol was added and the dispersion was concentrated again. In a second procedure the water and 1-methoxy-2-propanol were evaporated to provide a powder. This powder was then dispersed in a 1-methoxy-2-propanol:water (88:12 weight ratio) mixture to be used for coating formulations. In both cases the solids content of the final dispersion was somewhat variable. In the case of the solvent exchange procedure, the variability is believed to be dependent on the amount of 1-methoxy-2-propanol and water that was removed in the final distillation step. In the case of the powder dispersion the variability is believed to be due to residual solvent content of the powder from batch to batch.

Because the desired particle solids content was calculated based upon the assumption that the powder was completely dry, the actual solids did not correlate with the theoretical solids calculation. This discrepancy does not adversely affect the coating solutions and examples because the particle solids content was gravimetrically determined prior to preparation of the coating formulations. A known amount of dispersion (1-4 grams) was charged to a small glass dish (of known weight). The dish was placed in a forced air oven (120° C.) for 45 minutes. The dish was then weighed again.

% solids=dry weight/wet weight

### Preparation of Surface Modified 5 nm Silica Particles

### Preparatory Example 1

### MS5-1

The 5 nm silica was surface modified (25:75 MPS/A1230 molar ratio) as follows. 1-methoxy-2-propanol (450 grams), MPS (6.93 grams), A1230 (41.94 grams), and radical inhibitor solution (0.3 gram of a 5% solution in DI water) were mixed with a dispersion of spherical silica submicrometer particles (400.0 grams with a silica content of 15.98%; NALCO 2326) while stirring. The solution was sealed and heated to 80° C. and held at temperature for 16 hours in a 1 liter glass jar. The surface modified colloidal dispersion was further processed to remove water and increase the silica concentration. A 500 ml RB flask was charged with the surface modified dispersion (400 grams). Water and 1-methoxy-2-propanol were removed via rotary evaporation to give a weight of 152.63 grams. Additional surface modified dispersion (400 grams) was charged to the flask and water and 1-methoxy-2-propanol were removed via rotary evaporation to give a final weight of 273 grams. Additional surface modified dispersion (89.7 grams) and 1-methoxy-2-propanol (200.03 grams) were charged to the flask and water and 1-methoxy-2-propanol were removed via rotary evaporation to give a final weight of 145.49 grams. 1-methoxy-2-propanol (100 grams) was charged to the flask and water and 1-methoxy-2-propanol were removed via rotary evaporation to give a final weight of 162.06 grams. The solution was filtered with 1 micrometer filter. The resulting solids content was 61.10 wt. %.

### Preparation of Surface Modified 20 nm Silica Particles

### Preparatory Example 2

### MS20-1

The 20 nm silica was surface modified (100:0 MPS:A1230) molar ratio as follows. 1-methoxy-2-propanol (450.12 grams), MPS (25.27 grams), and radical inhibitor solution (0.2 gram of a 5% solution in DI water) were mixed with a dispersion of spherical silica submicrometer particles (400 grams with a silica content of 41.05%; NALCO 2327) while stirring. The solution was sealed and heated to 80° C. and held at temperature for 16 hours in a 1 liter glass jar. The surface modified colloidal dispersion was further processed to remove water and increase the silica concentration. A 500 ml RB flask was charged with the surface modified dispersion (450 grams) and 1-methoxy-2-propanol (50 grams). Water and 1-methoxy-2-propanol were removed via rotary evaporation to give a weight of 206 grams. 1-methoxy-2-propanol (250 grams) was charged to the flask and water and 1-methoxy-2-propanol were removed via rotary evaporation to give a final weight of 176 grams. The solution was filtered with 1 micrometer filter. The resulting solids content was 50.99 wt. %.

### Preparation of Surface Modified 75 nm Silica Particles

### Preparatory Example 3

### MS75-1

The 75 nm silica was surface modified (75:25 MPS:A1230 molar ratio) as follows. 1-methoxy-2-propanol (450 grams), MPS (4.53 grams), A1230 (3.03 grams), and radical inhibitor solution (0.2 gram of a 5% solution in DI water) were mixed with a dispersion of spherical silica submicrometer particles (400.03 grams with a silica content of 40.52%; NALCO 2329) while stirring. The solution was sealed and heated to 80° C. and held at temperature for 16 hours in a 1 liter glass jar. The water and 1-methoxy-2-propanol were removed from the mixture via rotary evaporation to obtain a powder. A portion of the powder (48.01 grams) was dispersed in 1-methoxy-2-propanol (51.61 grams) and D.I. water (7.04 grams). The mixture was charged to a 118.3 ml (4 oz.) glass jar and processed for 43 minutes (level 90, 50% power) using an ultrasonic processor (obtained from Sonic and Materials Inc., Newtown, Conn.; equipped with a probe under the trade designation “SM 07 92”)). The solution was filtered with 1 micrometer filter. The resulting solids content was 42.37 wt. %.

### Preparatory Example 4

### MS75-2

The 75 nm silica was surface modified (100:0 MPS:A1230 molar ratio) as described for MS75-1, except the full molar charge was all MPS. The resulting solids content was 41.80 wt. %.

### Preparatory Example 5

### MS75-3

The 75 nm silica was surface modified (50:50 MPS:A1230 molar ratio) as described for MS75-1, except a molar ratio of 50:50 (MPS:A1230) was used. The resulting solids content was 45.10 wt. %.

### Preparatory Example 6

### MS75-4

The 75 nm silica was surface modified (50:50 MPS:A1230 molar ratio) as described for MS75-1, except a molar ratio of 50:50 (MPS:A1230) was used. The resulting solids content was 44.98 wt. %.

### Preparatory Example 7

### MS75-5

The 75 nm silica was surface modified (100:0 MPS:A1230 molar ratio) as follows. 1-methoxy-2-propanol (450 grams), MPS (6.04 grams), and radical inhibitor solution (0.2 gram of a 5% solution in DI water) were mixed with a dispersion of spherical silica submicrometer particles (400 grams with a silica content of 40.52%; NALCO 2329) while stirring. The solution was sealed and heated to 80° C. and held at temperature for 16 hours in a 1 liter glass jar. The surface modified colloidal dispersion was further processed to remove water and increase the silica concentration. A 500 ml RB flask was charged with the surface modified dispersion (450 grams). Water and 1-methoxy-2-propanol were removed via rotary evaporation to give a weight of 202.85 grams. 1-methoxy-2-propanol (183 grams) was charged to the flask and water and 1-methoxy-2-propanol were removed via rotary evaporation to give a final weight of 188.6 grams. The solution was filtered with 1 micrometer filter. The resulting solids content was 51.1 wt. %.

### Preparation of Surface Modified 100 nm Silica Particles

### Preparatory Example 8

### MS100-1

The 100 nm silica was surface modified (75:25 MPS:A1230 molar ratio) as follows. 1-methoxy-2-propanol (452 grams), of MPS (4.78 grams), A1230 (3.21 grams), and radical inhibitor solution (0.06 gram of as 5% solution in DI water) were mixed with a dispersion of spherical silica submicrometer particles (399.9 grams with a silica content of 42.9; MP1040) while stirring. The solution was sealed and heated to 80° C. and held at temperature for 16 hours in a 1 liter glass jar. The water and 1-methoxy-2-propanol were removed from the mixture via rotary evaporation to obtain a powder. A portion of the powder (169.33 grams) was dispersed in 1-methoxy-2-propanol (185.10 grams), and D.I. water (21.95 grams). The mixture was charged to a 473 ml (16 oz.) glass jar and processed for 63 minutes (level 90, 50% power) using the ultrasonic processor referenced in Preparatory Example 3, above. The solution was filtered with 1 micrometer filter. The resulting solids content was 42.08 wt. %.

### Preparation of Surface Modified 190 nm Silica Particles

### Preparatory Example 9

### MS190-1

The 190 nm silica was surface modified (100:0 MPS:A1230 molar ratio) as follows. 1-methoxy-2-propanol (843 grams), MPS (16.43 grams), and radical inhibitor solution (0.45 gram of a 5% solution in DI water) were mixed with a dispersion of spherical silica submicrometer particles (750.8 grams with a silica content of 44.15%; MP2040″) while stirring. The solution was sealed and heated to 87° C. and held at temperature for 16 hours in 2000 ml RB flask fitted with a reflux condenser and a mechanical stirrer. The water and 1-methoxy-2-propanol were removed from the mixture via rotary evaporation to obtain a dry powder. The powder (340.5 gram) was dispersed in -methoxy-2-propanol (324.24 grams) and D.I. water (44.21 grams). The mixture was charged to a liter glass jar and processed for 83 minutes (level 90, 50% power) using the ultrasonic processor referenced in Preparatory Example 3. The solution was filtered with 1 micrometer filter. The resulting solids content was 42.79 wt. %.

### Preparatory Example 10

### MS190-2

The 190 nm silica was surface modified (100:0 MPS:A1230 molar ratio) as described for MS190-1. The resulting solids content was 41.02 wt. %.

### Preparatory Example 11

### MS190-3

The 190 nm silica was surface modified (100:0 MPS:A1230 molar ratio) as described for MS190-1. The resulting solids content was 42.20 wt. %.

### Preparatory Example 12

### MS190-4

The 190 nm silica was surface modified (100:0 MPS:A1230 molar ratio) as described for MS190-1. The resulting solids content was 41.86 wt. %.

### Preparatory Example 13

### MS190-5

The 190 nm silica was surface modified (100:0 MPS:A1230 molar ratio) as described for MS190-1. The resulting solids content was 44.27 wt. %.

### Preparatory Example 14

### MS190-6

The 190 nm silica was surface modified (100:0 MPS:A1230 molar ratio) as described for MS190-1. The resulting solids content was 44.45 wt. %.

### Preparatory Example 15

### MS190-7

The 190 nm silica was surface modified (100:0 MPS:A1230 molar ratio) as described for MS190-1. The resulting solids content was 46.02 wt. %.

### Preparatory Example 16

### MS190-8

The 190 nm silica was surface modified (100:0 MPS:A1230 molar ratio) as described for MS190-1. The resulting solids content was 41.79 wt. %.

### Preparatory Example 17

### MS190-8

The 190 nm silica was surface modified (100:0 MPS:A1230 molar ratio) as described for MS190-1. The resulting solids content was 43.99 wt. %.

### Preparation of Surface Modified 440 nm Silica Particles

### Preparatory Example 18

### MS440-1

The 440 nm silica was surface modified (100:0 MPS:A1230 molar ratio) as follows. 1-methoxy-2-propanol (450 grams), MPS (3.62 grams), and radical inhibitor solution (0.31 gram of a 5% solution in DI water) were mixed with a dispersion of spherical silica submicrometer particles (400 grams with a silica content of 45.7 wt. %; MP4540) while stirring. The solution was sealed and heated to 98° C. and held at temperature for 16 hours in a 1000 ml RB flask fitted with a reflux condenser and mechanical stirrer. The water and 1-methoxy-2-propanol were removed from the mixture via rotary evaporation to obtain a dry powder. The powder (186.755 grams) was dispersed in 1-methoxy-2-propanol (200.86 grams) and D. I. water (27.42 grams). The mixture was charged to a 1 liter glass jar and processed for 63 minutes (level 90, 50% power) using the ultrasonic processor referenced in Preparatory Example 3. The solution was filtered with a 5 micrometer filter. The resulting solids content was 44.85 wt. %.

### Example 1

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particles dispersion to form a 65:35 particle:prepolymer weight ratio. The functionality of the prepolymer blend was 2.09. The MS 190-1 modified particle solution (43.02 grams @ 42.79 wt. % solids), the above prepolymer blend (10.60 grams), a 50:50 mixture (weight ratio) of 1-methoxy-2-propanol/IPA (17.87 grams) and IR 184 (0.287 gram) were mixed together to form the coating solution (about 40 wt. % total solids and 1 wt. % PI, based on total solids).

A schematic drawing of the general process is shown in FIG. 3A. The first coating solution was delivered at a rate of 5.25 cm³/min. to a 4 inch (10.2 cm) wide slot-type coating die. After the solution was coated on a 0.002 inch (0.051 mm) thick primed polyester (obtained under the trade designation “MELINEX 617” from DuPont Teijin Films, Chester, Va.), the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft./min. (305 cm/min.) to achieve a wet coating thickness of about 10 micrometers. Finally, the dried coating entered a UV chamber equipped with a UV light source (Model I300P from Fusion UV Systems Inc., Gaithersburg, Md.) where H-bulb was used. The UV chamber was purged by a gas stream pre-mixed with nitrogen and a small volume of air. The flow rate of nitrogen was fixed at 314 liters/min. (11 scfm), and the flow rate of compressed air was adjusted to control the oxygen concentration in the UV cure chamber. The oxygen concentration in the cure chamber was measured using an oxygen analyzer (obtained as Series 3000 Trace Oxygen Analyzer from Alpha Omega Industries, Chicago, Ill.). The flow rate and cure chamber oxygen levels are reported in Table 3, below.

TABLE 3

| | | Oxygen | | | | | |
|---|---|---|---|---|---|---|---|
| | Air | concentration | | | | | |
| | Flow rate | in UV chamber | Reflection | Transmission | Haze | Clarity | Steel Wool |
| Example | (liters/min.) | (ppm) | (%) | (%) | (%) | (%) | Rating |
| Comp. 1-1 | 0 | 8 | 4.37 | 92.4 | 0.87 | 99.6 | 4.67 |
| 1-1 | 2 | 700 | 3.02 | 93 | 1.27 | 99.6 | NA |
| 1-2 | 5 | 1800 | 2.42 | 93.2 | 1.43 | 99.5 | NA |
| 1-3 | 10 | 4200 | 2.10 | 93.7 | 1.98 | 99.4 | NA |
| 1-4 | 14. | 6400 | 1.94 | 93.5 | 1.75 | 99.3 | NA |
| 1-5 | 19 | 8700 | 1.80 | 93.9 | 2.28 | 99.3 | NA |
| 1-6 | 24 | 10000 | 1.78 | 93.7 | 2.59 | 99.4 | 5.00 |

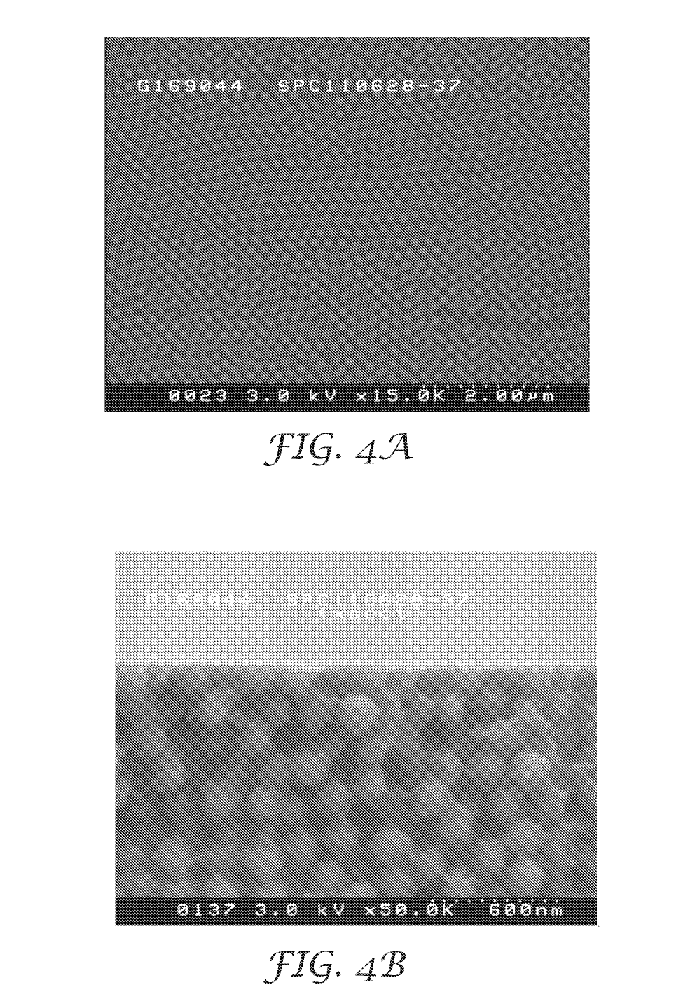

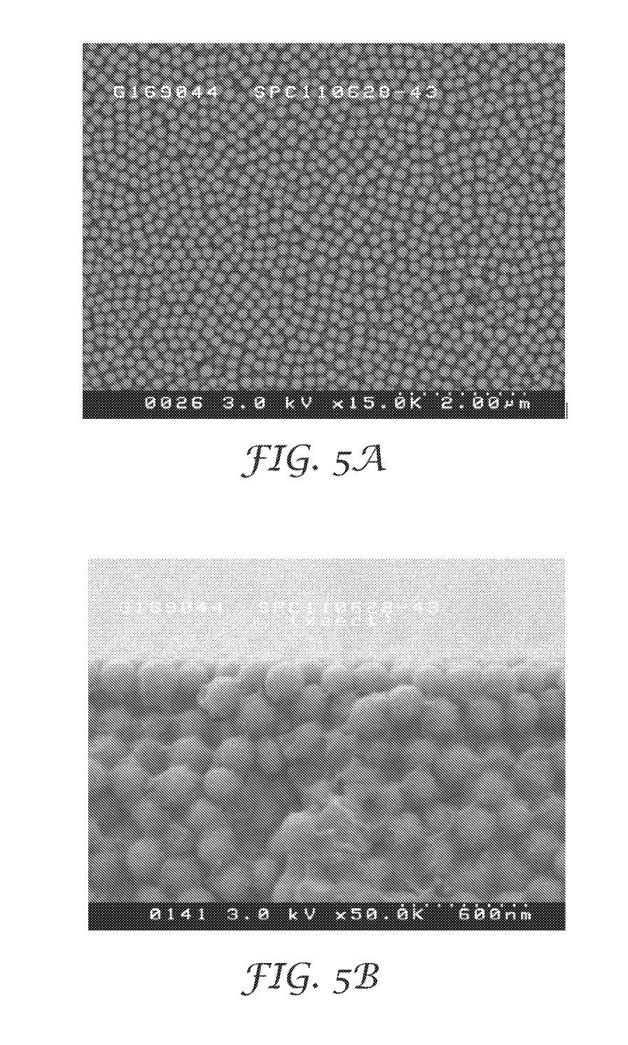

FIG. 4 shows SEM images including both top surface (FIG. 4A) and cross-section (FIG. 4B) of Comparative Example 1-1 cured without any air injection where the oxygen level was around 10 ppm. FIG. 5 shows SEM images of Example 1-6, FIG. 5A of the top surface, FIG. 5B of the cross-section, of the sample cured at an oxygen level of 10,000 ppm.

In FIG. 4A nanoparticles are covered by polymer binders that were polymerized from the prepolymer blend on the top surface, while the submicrometer particles in FIG. 5A protrude on the surface. In FIG. 4B, the polymer binder is distributed uniformly across the cross-section of the coating, and binders substantially fill spaces among the top layer particles. In FIG. 5B, the binder is below the necks of top layer particles, and distributed uniformly among the particles underneath.

The % reflection of the coating surfaces were measured using Test Method 1. The transmission, haze and clarity were measured by Test Method 2. The steel wool abrasion resistance was measured by Test Method 3. The results are summarized in Table 3, above.

### Example 2

A coating solution of radiation curable material and silica nanoparticles (NISSAN 2040) modified with MPS was used to make coatings with different reflections and optical properties (i.e. transmission, haze, clarity) at different oxygen levels in the range of 50 ppm to 10,000 ppm.

### Preparation of Radiation Curable Coating Formulations

### 0:100 Particle:Prepolymer Weight Ratio

A prepolymer blend of pentaerythritol triacrylate, 1,6 hexanediol diacrylate, and isobornyl acrylate (“SR444,” “SR238,” “SR506,” respectively) in a 40:40:20 weight ratio was prepared. The above prepolymer blend (40.04 grams), a 50:50 mixture of 1-methoxy-2-propanol:IPA (60.01 grams) and IR 184 (0.40 gram) were mixed together to form the coating solution (about 40 wt. % total solids and 1 wt. % PI, based on total solids).

### 10:90 Particle:Prepolymer Weight Ratio

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particle dispersion to form a 10:90 particle:prepolymer weight ratio. The functionality of the prepolymer blend was 2.09. The MS190-1 modified particle solution (7.01 grams @ 42.79 wt. % solids), the above prepolymer blend (26.97 grams), a 50:50 mixture of 1-methoxy-2-propanol:IPA (40.93 grams) and IR 184 (0.297 gram) were mixed together to form the coating solution (about 40 wt. % total solids and 1 wt. % PI, based on total solids).

### 30/70 Particle:Prepolymer Weight Ratio

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particle dispersion to form a 30:70 particle:prepolymer weight ratio. The functionality of the prepolymer blend was 2.09. The MS190-1 modified particle solution (20.01 grams @ 42.79 wt. % solids), the above prepolymer blend (19.98 gram), a 50/50 mixture of 1-methoxy-2-propanol:IPA (31.35 grams) and IR 184 (0.285 gram) were mixed together to form the coating solution (about 40 wt. % total solids and 1 wt. % PI, based on total solids).

### 50:50 Particle:Prepolymer Weight Ratio

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particle dispersion to form a 50:50 particle:prepolymer weight ratio. The functionality of the prepolymer blend was 2.09. The MS 190-1 modified particle solution (35.04 grams @ 42.79 wt. % solids), the above prepolymer blend (15.00 grams), a 50:50 mixture of 1-methoxy-2-propanol:IPA (124.96 grams) and IR 184 (0.299 gram) were mixed together to form the coating solution (about 40 wt. % total solids and 1 wt. % PI, based on total solids).

### 65:35 Particle:Prepolymer Weight Ratio

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particle dispersion to form a 65:35 particle:prepolymer weight ratio. The functionality of the prepolymer blend was 2.09. The MS190-1 modified particle solution (43.02 grams @ 42.79 wt. % solids), the above prepolymer blend (10.60 grams), a 50:50 (weight ratio) mixture of 1-methoxy-2-propanol:IPA (17.87 grams) and IR 184 (0.287 gram) were mixed together to form the coating solution (about 40 wt. % total solids and 1 wt. % PI, based on total solids).

### 70:30 Particle:Prepolymer Weight Ratio

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particle dispersion to form a 70:30 particle:prepolymer weight ratio. The functionality of the prepolymer blend was 2.09. The MS190-1 modified particle solution (47.00 grams @ 42.79 wt. % solids), the above prepolymer blend (8.62 grams), a 50:50 (weight ratio) mixture of 1-methoxy-2-propanol:IPA (16.21 grams) and IR 184 (0.285 gram) were mixed together to form the coating solution (about 40 wt. % total solids and 1 wt. % PI, based on total solids).

### 75:25 Particle:Prepolymer Weight Ratio

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particle dispersion to form a 75:25 particle:prepolymer weight ratio. The functionality of the prepolymer blend was 2.09. The MS 190-1 modified particle solution (50.03 grams @ 42.79 wt. % solids), the above prepolymer blend (7.14 grams), a 50:50 mixture of 1-methoxy-2-propanol:IPA (14.18 grams) and IR 184 (0.283 gram) were mixed together to form the coating solution (about 40 wt. % total solids and 1 wt. % PI, based on total solids).

The general process followed the schematic drawing in FIG. 3A. The coating solution was supplied at a rate of 5.25 cm³/min. to a 4 inch (10.2 cm) wide slot type coating die. After the solution was coated on a 0.002 inch (0.051 mm) thick primed polyester (obtained under the trade designation “MELINEX 617”), the coated web travelled a 10 ft. (3 m) span in the room environment, and passed through two 5 ft. (1.5 m) long zones of small gap drying with plate temperatures set at 170° F. (77° C.). The substrate was moving at a speed of 10 ft./min. (305 cm/min.) to achieve a wet coating thickness of about 10 micrometers. Finally the dried coating entered a UV chamber equipped with a UV light source (Model I300P from Fusion UV Systems Inc.) where H-bulb was used. The UV chamber was purged by a gas stream pre-mixed with nitrogen and a small volume of air. The flow rate of nitrogen was fixed at 314 liters/min. (11 scfm). When the flow rate of compressed air was adjusted in the range of 2 liters/min. to 24 liters/min. (4 scfh to 50 scfh), an oxygen concentration in the range of 700 ppm to 10,000 ppm was achieved. The oxygen concentration in the cure chamber was measured using an oxygen analyzer (Series 3000 Trace Oxygen Analyzer).

Various process conditions and test results are provided in Table 4, below.

TABLE 4

| | | | Oxygen | | | | | | |
|---|---|---|---|---|---|---|---|---|---|
| | Particle:pre- | Air | concentration | | | | | | |
| | polymer | Flow Rate | in UV chamber | Reflection | Transmission | Haze | Clarity | Steel Wool | Refractive |
| Example | Ratio | (liters/min.) | (ppm) | (%) | (%) | (%) | (%) | Rating | Index |
| Comp. 2A-1 | 0:100 | 0 | 10 | 4.47 | 91.7 | 0.68 | 99.8 | 5.0 | 1.5125 |
| Comp. 2A-2 | 0:100 | 2 | 690 | 4.45 | 92.4 | 0.58 | 100 | NA | NA |
| Comp. 2A-3 | 0:100 | 5 | 1800 | 4.47 | 92.4 | 0.59 | 100 | NA | NA |
| Comp. 2A-4 | 0:100 | 10 | 4200 | 4.46 | 92.4 | 0.6 | 100 | NA | NA |
| Comp. 2A-5 | 0:100 | 14 | 6500 | 4.45 | 92.3 | 0.61 | 99.8 | NA | NA |
| Comp. 2A-6 | 0:100 | 19 | 8400 | 4.47 | 92.4 | 0.59 | 100 | NA | NA |
| Comp. 2A-7 | 0:100 | 24 | 10,000 | 4.47 | 92.4 | 0.59 | 100 | 4.7 | 1.5132 |
| Comp. 2B-1 | 10:90 | 0 | 25 | 4.49 | 92.1 | 0.82 | 99.8 | 5.0 | 1.5101 |
| 2B-1 | 10:90 | 2 | 700 | 4.14 | 92 | 1.17 | 99.8 | NA | NA |
| 2B-2 | 10:90 | 5 | 1900 | 3.81 | 92.3 | 1.19 | 99.8 | NA | NA |
| 2B-3 | 10:90 | 10 | 4200 | 3.66 | 92.4 | 1.17 | 99.8 | NA | NA |
| 2B-4 | 10:90 | 14 | 6500 | 3.52 | 92.8 | 1.22 | 100 | NA | NA |
| 2B-5 | 10:90 | 19 | 8900 | 3.51 | 92.2 | 1.3 | 100 | NA | NA |
| 2B-6 | 10:90 | 24 | 10,000 | 3.48 | 92.5 | 1.22 | 99.8 | 2.7 | 1.5110 |
| Comp. 2C-1 | 30:70 | 0 | 10 | 4.88 | 91.6 | 0.97 | 99.8 | 4.7 | 1.5039 |
| 2C-1 | 30:70 | 2 | 700 | 3.31 | 92.7 | 1.64 | 99.8 | NA | NA |
| 2C-2 | 30:70 | 5 | 1800 | 3.36 | 92.7 | 1.29 | 99.8 | NA | NA |
| 2C-3 | 30:70 | 10 | 4100 | 3.13 | 92.8 | 2.85 | 99.6 | NA | NA |
| 2C-4 | 30:70 | 14 | 6400 | 2.95 | 92.9 | 2.26 | 99.5 | NA | NA |
| 2C-5 | 30:70 | 19 | 8800 | 2.78 | 93.1 | 1.72 | 97.4 | NA | NA |
| 2C-6 | 30:70 | 24 | 10,000 | 2.73 | 93.1 | 2.55 | 98.1 | 4.3 | 1.5031 |
| Comp. 2D-1 | 50:50 | 0 | 15 | 4.55 | 92 | 0.86 | 99.8 | 4.7 | 1.4952 |
| 2D-1 | 50:50 | 2 | 650 | 3.39 | 91.9 | 1.17 | 99.8 | NA | NA |
| 2D-2 | 50:50 | 5 | 1800 | 2.88 | 92.9 | 1.46 | 99.7 | NA | NA |
| 2D-3 | 50:50 | 10 | 4000 | 2.70 | 93.4 | 1.76 | 99.6 | NA | NA |
| 2D-4 | 50:50 | 14 | 6400 | 2.36 | 93 | 1.53 | 99.7 | NA | NA |
| 2D-5 | 50:50 | 19 | 8500 | 2.25 | 93.6 | 2.46 | 99.4 | NA | NA |
| 2D-6 | 50:50 | 24 | 10,000 | 2.12 | 93.3 | 2.4 | 98.9 | 5.0 | 1.4956 |
| Comp. 2E-1 | 65:35 | 0 | 8 | 4.37 | 92.4 | 0.87 | 99.6 | 4.7 | 1.4884 |
| 2E-1 | 65:35 | 2 | 700 | 3.02 | 93 | 1.27 | 99.6 | NA | NA |
| 2E-2 | 65:35 | 5 | 1800 | 2.42 | 93.2 | 1.43 | 99.5 | NA | NA |
| 2E-3 | 65:35 | 10 | 4200 | 2.10 | 93.7 | 1.98 | 99.4 | NA | NA |
| 2E-4 | 65:35 | 14 | 6400 | 1.94 | 93.5 | 1.75 | 99.4 | NA | NA |
| 2E-5 | 65:35 | 19 | 8700 | 1.80 | 93.9 | 2.28 | 99.3 | NA | NA |
| 2E-6 | 65:35 | 24 | 10,000 | 1.78 | 93.7 | 2.59 | 99.3 | 5.0 | 1.4891 |
| Comp. 2F-1 | 70:30 | 0 | 6 | 4.30 | 92.4 | 1.01 | 99.4 | 4.5 | 1.4845 |
| 2F-1 | 70:30 | 2 | 700 | 2.64 | 93.2 | 1.43 | 99.2 | NA | NA |
| 2F-2 | 70:30 | 5 | 1800 | 2.05 | 93.9 | 1.92 | 98.9 | NA | NA |
| 2F-3 | 70:30 | 10 | 4200 | 1.84 | 93.8 | 2.27 | 98.7 | NA | NA |
| 2F-4 | 70:30 | 14 | 6400 | 1.80 | 93.9 | 2.99 | 98.4 | NA | NA |
| 2F-5 | 70:30 | 19 | 8800 | 1.82 | 93.2 | 3.04 | 98.2 | NA | NA |
| 2F-6 | 70:30 | 24 | 10,000 | 2.03 | 93.8 | 3 | 98.3 | NA | 1.4801 |
| Comp. 2G-1 | 75:25 | 0 | 16 | 4.10 | 92.5 | 0.95 | 98.9 | 4.7 | 1.4808 |
| 2G-1 | 75:25 | 2 | 700 | 1.76 | 94.3 | 1.52 | 97.3 | 4.5 | 1.4805 |
| 2G-2 | 75:25 | 5 | 1800 | 1.93 | 93.7 | 2.66 | 97.4 | NA | NA |
| 2G-3 | 75:25 | 10 | 4100 | 2.03 | 93.6 | 5.64 | 96.6 | NA | NA |
| 2G-4 | 75:25 | 14 | 6300 | 2.12 | 93.2 | 9.1 | 96.4 | NA | NA |
| 2G-5 | 75:25 | 19 | 8800 | 2.18 | 92.7 | 12.6 | 96.1 | NA | NA |
| 2G-6 | 75:25 | 24 | 10,000 | 2.22 | 93.4 | 15.8 | 96.2 | NA | NA |

### Example 3

### 0:100 Particle:Prepolymer Weight Ratio

A prepolymer blend of pentaerythritol tetracrylate, 1,6 hexanediol diacrylate, and isobornyl acrylate (“SR295,” “SR238,” “SR506,” respectively) in a 40:40:20 weight ratio was prepared. The above prepolymer blend (60.0 grams), a 50:50 mixture (weight ratio) of 1-methoxy-2-propanol:IPA (40.0 grams) and IR 184 (1.80 gram) were mixed together to form the coating solution (about 60 wt. % total solids and 1 wt. % PI, based on total solids).

### 10:90 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with a silane modified (50:50 MPS:A1230) 75 nm silica particle dispersion to form 10:90 particle:prepolymer weight ratio. The functionality of the prepolymer blend was 2.34. The MS75-4 modified particle solution (11.07 grams @ 44.98 wt. % solids), the above prepolymer blend (44.98 grams), a 50:50 mixture (weight ratio) of 1-methoxy-2-propanol:IPA (68.60 grams) and IR 184 (1.35 gram) were mixed together to form the coating solution (about 40 wt. % total solids and 3 wt. % PI, based on total solids).

### 30:70 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with a silane modified (50:50 MPS:A1230) 75 nm silica particle dispersion to form 30:70 particle:prepolymer weight ratio. The functionality of the prepolymer blend was 2.34. The MS75-4 modified particle solution (30 grams @ 44.98 wt. % solids), the above prepolymer blend (31.49 grams), a 50:50 (weight ratio) mixture of 1-methoxy-2-propanol:IPA (50.96 grams) and IR 184 (1.35 gram) were mixed together to form the coating solution (about 40 wt. % total solids and 3 wt. % PI, based on total solids).

### 50:50 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with a silane modified (50:50 MPS:A1230) 75 nm silica particle dispersion to form 50:50 particle:prepolymer weight ratio. The functionality of the prepolymer blend was 2.34. The MS75-4 modified particle solution (50 grams @ 44.98 wt. % solids), the above prepolymer blend (22.49 grams), a 50:50 (weight ratio) mixture of 1-methoxy-2-propanol:IPA (39.96 grams) and IR 184 (1.35 gram) were mixed together to form the coating solution (about 40 wt. % total solids and 3 wt. % PI, based on total solids).

### 70:30 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with a silane modified (50:50 MPS:A1230) 75 nm silica particle dispersion to form 70:30 particle:prepolymer weight ratio. The functionality of the prepolymer blend was 2.34. MS75-4 The modified particle solution (70 grams @ 44.98 wt. % solids), the above prepolymer blend (13.49 grams), a 50:50 (weight ratio) mixture of 1-methoxy-2-propanol:IPA (28.96 grams) and IR 184 (1.35 gram) were mixed together to form the coating solution (about 40 wt. % total solids and 3 wt. % PI, based on total solids).

### 80:20 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with a silane modified (50:50 MPS:A1230) 75 nm silica particle dispersion to form 80:20 particle:prepolymer weight ratio. The functionality of the prepolymer blend was 2.34. The MS75-4 modified particle solution (80 grams @ 44.98 wt. % solids), the above prepolymer blend (9.00 grams), a 50:50 (weight ratio) mixture of 1-methoxy-2-propanol:IPA (23.45 grams) and IR 184 (1.35 gram) were mixed together to form the coating solution (about 40 wt. % total solids and 3 wt. % PI, based on total solids).

The general process for coating and processing the solution followed the schematic drawing in FIG. 3A. The coating solution was supplied at a rate of 5.25 cm³/min. to a 4 inch (10.2 cm) wide slot type coating die. After the solution was coated on a 0.002 inch (0.051 mm) thick polyester, the coated web travelled a 10 ft. (3 m) span in the room environment, and passed through two 5 ft. (1.5 m) long zones of small gap drying with plate temperatures set at 170° F. (77° C.). The substrate was moving at a speed of 10 ft./min. (305 cm/min) to achieve a wet coating thickness of about 10 micrometers. Finally the dried coating entered a UV chamber equipped with a UV light source (Model I300P from Fusion UV Systems Inc., Gaithersburg, Md.) where H-bulb was used. The UV chamber was purged by a gas stream pre-mixed with nitrogen and a small volume of air. The flow rate of nitrogen was fixed at 314 liters/min. (11 scfm). When the flow rate of compressed air was adjusted in the range of 2 liters/min. to 24 liters/min. (4 scfh to 50 scfh), an oxygen concentration in the range of 700 pm to 10,000 ppm was achieved. The oxygen concentration in the cure chamber was measured using an oxygen analyzer (Series 3000 Trace Oxygen Analyzer).

Reflection, transmission, haze and clarity and refractive index data for six solutions coated and cured at different oxygen levels are provided in Table 5, below.

TABLE 5

| | | | Oxygen | | | | | |
|---|---|---|---|---|---|---|---|---|
| | Particle pre- | Air | concentration | | | | | |
| | polymer | Flow Rate | in UV chamber | Reflection | Transmission | Haze | Clarity | Refractive |
| | Ratio | (liters/min.) | (ppm) | (%) | (%) | (%) | (%) | Index |
| Comp. 3A-1 | 0:100 | 0 | 100 | 4.26 | 94.9 | 1.14 | 99.6 | 1.49 |
| Comp. 3A-2 | 0:100 | 1 | 800 | 4.37 | 95.9 | 0.73 | 99.8 | 1.4979 |
| Comp. 3A-3 | 0:100 | 4 | 1900 | 4.29 | 96.1 | 0.75 | 99.8 | 1.4987 |
| Comp. 3A-4 | 0:100 | 10 | 4100 | 4.29 | 96 | 0.75 | 99.8 | 1.4952 |
| Comp. 3A-5 | 0:100 | 14 | 6400 | 4.36 | 95.9 | 0.78 | 99.8 | 1.4994 |
| Comp. 3A-6 | 0:100 | 19 | 8100 | 4.33 | 95.8 | 0.73 | 99.8 | 1.4984 |
| Comp. 3A-7 | 0:100 | 24 | 10000 | 4.34 | 96.1 | 0.78 | 99.8 | 1.4986 |
| Comp. 3B-1 | 10:90 | 0 | 60 | 4.46 | 95.8 | 1.02 | 99.7 | NA |
| 3B-1 | 10:90 | 1 | 650 | 4.09 | 96 | 1.64 | 99.2 | NA |
| 3B-2 | 10:90 | 4 | 2100 | 4.07 | 96.1 | 2.01 | 99.8 | NA |
| 3B-3 | 10:90 | 10 | 4000 | 4.09 | 96.1 | 2.19 | 99.3 | NA |
| 3B-4 | 10:90 | 14. | 5300 | 4.07 | 96.1 | 2.21 | 99.8 | NA |
| 3B-5 | 10:90 | 19 | 8000 | 4.02 | 96.1 | 2.16 | 99.6 | NA |
| 3B-6 | 10:90 | 24 | 10000 | 4.09 | 96.1 | 2.32 | 99.8 | NA |
| Comp. 3C-1 | 30:70 | 0 | 50 | 4.15 | 96 | 1.07 | 99.8 | NA |
| 3C-1 | 30:70 | 1 | 700 | 3.71 | 96.3 | 2.21 | 99.8 | NA |
| 3C-2 | 30:70 | 4 | 2100 | 3.49 | 96.5 | 3.03 | 99.8 | NA |
| 3C-3 | 30:70 | 10 | 4100 | 3.42 | 96.5 | 3.09 | 99.8 | NA |
| 3C-4 | 30:70 | 14 | 5900 | 3.32 | 96.6 | 3.12 | 99.8 | NA |
| 3C-5 | 30:70 | 19 | 8000 | 3.36 | 96.4 | 3.24 | 99.8 | NA |
| 3C-6 | 30:70 | 24 | 10000 | 3.28 | 96.5 | 3.55 | 99.8 | NA |
| Comp. 3D-1 | 50:50 | 0 | 70 | 4.08 | 96.2 | 0.89 | 99.8 | NA |
| 3D-1 | 50:50 | 1 | 1000 | 3.13 | 96.9 | 1.54 | 99.8 | NA |
| 3D-2 | 50:50 | 4 | 2000 | 2.69 | 96.9 | 1.91 | 99.8 | NA |
| 3D-3 | 50:50 | 10 | 4200 | 2.66 | 97.3 | 2.02 | 100 | NA |
| 3D-4 | 50:50 | 14 | 6200 | 263 | 97.3 | 2 | 99.8 | NA |
| 3D-5 | 50:50 | 19 | 8200 | 2.49 | 97.3 | 1.98 | 100 | NA |
| 3D-6 | 50:50 | 24 | 10000 | 2.42 | 97.4 | 2.01 | 99.8 | NA |
| Comp. 3E-1 | 70:30 | 0 | 70 | 3.79 | 96.3 | 0.8 | 99.8 | 1.4810 |
| 3E-1 | 70:30 | 1 | 1000 | 2.64 | 97.4 | 0.92 | 99.8 | 1.4810 |
| 3E-2 | 70:30 | 4 | 2000 | 1.9 | 97.9 | 0.96 | 99.8 | 1.4808 |
| 3E-3 | 70:30 | 10 | 4200 | 1.82 | 98.1 | 1.24 | 100 | 1.4817 |
| 3E-4 | 70:30 | 14 | 6200 | 1.94 | 97.8 | 1.62 | 99.8 | 1.4820 |
| 3E-5 | 70:30 | 19 | 8000 | 1.92 | 97.6 | 1.9 | 99.8 | 1.4818 |
| 3E-6 | 70:30 | 24 | 10000 | 1.96 | 97.6 | 2.48 | 100 | 1.4818 |
| Comp. 3F-1 | 80:20 | 0 | 80 | 2.35 | 97.2 | 0.98 | 100 | 1.4711 |
| 3F-1 | 80:20 | 1 | 1000 | 2.28 | 97.6 | 10.2 | 99.8 | 1.4720 |
| 3F-2 | 80:20 | 4 | 2000 | 2.38 | 97.5 | 13.3 | 99.8 | 1.4731 |
| 3F-3 | 80:20 | 10 | 4100 | 2.33 | 97.5 | 17 | 99.8 | 1.4385 |
| 3F-4 | 80:20 | 14 | 6000 | 2.46 | 97.4 | 19.5 | 99.8 | 1.4311 |
| 3F-5 | 80:20 | 19 | 8000 | 2.51 | 97.2 | 19.7 | 99.7 | 1.4300 |
| 3F-6 | 80:20 | 24 | 10000 | 2.44 | 97.3 | 18.3 | 99.8 | 1.4225 |

### Example 4

### 10:90 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 20 nm silica particle dispersion to form 10:90 particle:prepolymer weight ratio. The functionality of the prepolymer blend was 2.34. The MS20-1 modified particle solution (8.0 grams @ 50.99 wt. % solids), the above prepolymer blend (36.72 grams), a mixture of 50:50 (weight ratio) 1-methoxy-2-propanol:IPA (57.28 grams) and IR 184 (1.224 gram) were mixed together to form the coating solution (about 40 wt. % total solids and 3 wt. % PI, based on total solids).

### 30:70 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 20 nm silica particle dispersion to form 30:70 particle:prepolymer weight ratio. The functionality of the prepolymer blend was 2.34. The MS20-1 modified particle solution (25.0 grams @ 50.99 wt. % solids), the above prepolymer blend (29.75 grams), a mixture of 50:50 (weight ratio) 1-methoxy-2-propanol:IPA (51.50 g) and IR 184 (1.275 grams) were mixed together to form the coating solution (about 40 wt. % total solids and 3 wt. % PI, based on total solids).

### 50:50 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 20 nm silica particle dispersion to form 50:50 particle:prepolymer weight ratio. The functionality of the prepolymer blend was 2.34. The MS20-1 modified particle solution (40.0 grams @ 50.99 wt. % solids), the above prepolymer blend (20.40 grams), a mixture of 50:50 (weight ratio) 1-methoxy-2-propanol:IPA (41.6 grams) and IR 184 (1.224 grams) were mixed together to form the coating solution (about 40 wt. % total solids and 3 wt. % PI, based on total solids).

### 70:30 Particle:Prepolymer Weight Ratio

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 20 nm silica particle dispersion to form 70:30 particle:prepolymer weight ratio. The functionality of the prepolymer blend was 2.34. The MS20-1 modified particle solution (55.0 grams @ 50.99 wt. % solids), the above prepolymer blend (12.02 grams), a mixture of 50:50 (weight ratio) 1-methoxy-2-propanol:IPA (33.16 grams) and IR 184 (1.202 gram) were mixed together to form the coating solution (about 40 wt. % total solids and 3 wt. % PI, based on total solids).

### 80:20 Particle:Prepolymer Weight Ratio

A prepolymer blend of pentaerythritol tetraacrylate 1,6 hexanediol diacrylate, and isobornyl acrylate, (“SR295,” “SR238,” “SR506,” respectively) in a 40:40:20 weight ratio was blended with the MPS modified 20 nm silica particle dispersion to form 80:20 particle:prepolymer weight ratio. The functionality of the prepolymer blend was 2.34. The MS20-1 modified particle solution (65.0 grams @ 50.99 wt. % solids), the above prepolymer blend (8.29 grams), a mixture of 50:50 (weight ratio) 1-methoxy-2-propanol:IPA (30.31 grams) and IR 184 (1.243 gram) were mixed together to form the coating solution (about 40 wt. % total solids and 3 wt. % PI, based on total solids).

The general process for coating and processing the solution followed the schematic drawing in FIG. 3A. The coating solution was supplied at a rate of 5.25 cm³/min. to a 4 inch (10.2 cm) wide slot type coating die. After the solution was coated on a 0.002 inch (0.051 mm) thick polyester, the coated web travelled a 10 ft. (3 m) span in the room environment, and passed through two 5 ft. (1.5 m) long zones of small gap drying with plate temperatures set at 170° F. (77° C.). The substrate was moving at a speed of 10 ft./min. (305 cm/min.) to achieve a wet coating thickness of about 10 micrometers. Finally the dried coating entered a UV chamber equipped with a UV light source (Model I300P from Fusion UV Systems) where H-bulb was used. The UV chamber was purged by a gas stream pre-mixed with nitrogen and a small volume of air. The flow rate of nitrogen was fixed at 314 liters/min. (11 scfm). When the flow rate of compressed air was adjusted in the range of 2 liters/min to 24 liters/min. (4 scfh to 50 scfh), an oxygen concentration in the range of 700 ppm to 10,000 ppm was achieved. The oxygen concentration in the cure chamber was measured using an oxygen analyzer (Series 3000 Trace Oxygen Analyzer).

Results of various tests are provided in Table 6 (below) for various compositions and oxygen levels.

TABLE 6

| | | | Oxygen | | | | |
|---|---|---|---|---|---|---|---|
| | Particle:Pre- | Air | concentration | | | | |
| | polymer | Flow Rate | in UV chamber | Reflection | Transmission | Haze | Clarity |
| Example | Ratio | (liters/min.) | (ppm) | (%) | (%) | (%) | (%) |
| Comp. 4A-1 | 10:30 | 0 | 100 | 4.3 | 95 | 1.24 | 100 |
| 4A-1 | 10:30 | 1 | 700 | 4.37 | 95.1 | 1.26 | 100 |
| 4A-2 | 10:30 | 4 | 2100 | 4.38 | 94.9 | 1.26 | 100 |
| 4A-3 | 10:30 | 8 | 3900 | 4.21 | 95 | 1.25 | 100 |
| 4A-4 | 10:30 | 10 | 5300 | 4.27 | 95 | 1.28 | 100 |
| Comp. 4B-1 | 30:70 | 0 | 100 | 4.48 | 94.9 | 1.25 | 100 |
| 4B-1 | 30:70 | 1 | 700 | 4.14 | 95.1 | 1.23 | 100 |
| 4B-2 | 30:70 | 4 | 2100 | 4.19 | 95.2 | 1.29 | 100 |
| 4B-3 | 30:70 | 8 | 4000 | 4.09 | 95.1 | 1.25 | 100 |
| 4B-4 | 30:70 | 14 | 6400 | 4.1 | 95.2 | 1.3 | 100 |
| 4B-5 | 30:70 | 19 | 8200 | 3.93 | 95.3 | 1.24 | 100 |
| 4B-6 | 30:70 | 24 | 10000 | 4.18 | 95.1 | 1.27 | 100 |
| Comp. 4C-1 | 50:50 | 0 | 100 | 4.27 | 94.9 | 1.29 | 100 |
| 4C-1 | 50:50 | 1 | 800 | 3.85 | 95 | 1.28 | 100 |
| 4C-2 | 50:50 | 4 | 2000 | 3.75 | 95.3 | 1.25 | 100 |
| 4C-3 | 50:50 | 8 | 4100 | 3.7 | 95.3 | 1.24 | 100 |
| 4C-4 | 50:50 | 14 | 6100 | 3.48 | 95.6 | 1.25 | 100 |
| 4C-5 | 50:50 | 19 | 8000 | 3.49 | 95.7 | 1.29 | 100 |
| 4C-6 | 50:50 | 24 | 10000 | 3.62 | 95.4 | 1.26 | 100 |
| Comp. 4D-1 | 70:30 | 0 | 100 | 4.11 | 95 | 1.28 | 100 |
| 4D-1 | 70:30 | 1 | 700 | 3.89 | 95.4 | 1.26 | 100 |
| 4D-2 | 70:30 | 4 | 2100 | 2.94 | 95.8 | 1.26 | 100 |
| 4D-3 | 70:30 | 8 | 4200 | 3.06 | 96.3 | 1.23 | 100 |
| 4D-4 | 70:30 | 14 | 6000 | 2.76 | 96.2 | 1.2 | 100 |
| 4D-5 | 70:30 | 19 | 8000 | 3 | 96.3 | 1.23 | 100 |
| 4D-6 | 70:30 | 24 | 10000 | 2.63 | 96.2 | 1.29 | 100 |
| Comp. 4E-1 | 80:20 | 0 | 100 | 4.08 | 95.1 | 1.24 | 100 |
| 4E-1 | 80:20 | 1 | 800 | 3.75 | 95.6 | 1.24 | 100 |
| 4E-2 | 80:20 | 4 | 2200 | 2.63 | 96.3 | 1.26 | 100 |
| 4E-3 | 80:20 | 8 | 4200 | 2.94 | 96.2 | 1.28 | 100 |
| 4E-4 | 80:20 | 14 | 5900 | 2.91 | 96.1 | 1.34 | 100 |
| 4E-5 | 80:20 | 19 | 8300 | 2.62 | 96.1 | 1.37 | 100 |
| 4E-6 | 80:20 | 24 | 10000 | 2.83 | 96.2 | 1.44 | 100 |

### Example 5

### Preparation of Curable Resin Coating Composition without Particles

A prepolymer blend of pentaerythritol tetraacrylate, 1,6 hexanediol diacrylate, and isobornyl acrylate (“SR295,” “SR238,” “SR506,” respectively) in a 40:40:20 weight ratio was prepared. The functionality of the prepolymer blend was 2.34. The above prepolymer blend (40.04 grams), a 50:50 (weight ratio) mixture of 1-methoxy-2-propanol:IPA (60.01 grams) and IR 184 (1.2 gram) were mixed together to form the coating solution (about 40 wt. % total solids and 3 wt. % PI, based on total solids).

### Preparation of Surface Modified 20 nm Silica Curable Resin Coating Composition

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 20 nm silica particle dispersion to form 70:30 particle:prepolymer weight ratio. The functionality of the prepolymer blend was 2.34. The MS20-1 modified particle solution (55.0 grams @ 50.99 wt. % solids), the above prepolymer blend (12.02 grams), a mixture of 50:50 (weight ratio) 1-methoxy-2-propanol:IPA (33.16 grams) and IR 184 (1.202 gram) were mixed together to form the coating solution (about 40 wt. % total solids and 3 wt. % PI, based on total solids).

### Preparation of Surface Modified 75 nm Silica Curable Resin Coating Composition

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the silane modified (50:50 MPS:A1230) 75 nm silica particle dispersion to form 70:30 particle:prepolymer weight ratio. The functionality of the prepolymer blend was 2.34. The MS75-4 modified particle solution (70 grams @ 44.98 wt. % solids), the above prepolymer blend (13.49 grams), a 50:50 (weight ratio) mixture of 1-methoxy-2-propanol:IPA (28.96 grams) and IR 184 (1.35 gram) were mixed together to form the coating solution (about 40 wt. % total solids and 3 wt. % PI, based on total solids).

### Preparation of Surface Modified 190 nm Silica Curable Resin Coating Composition

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 190 nm silica particles dispersion to form 65:35 particle:prepolymer weight ratio. The functionality of the prepolymer blend was 2.34. The MS 190-2 modified particle solution (300 grams @ 41.02 wt. % solids), the above prepolymer blend (66.31 grams), 1-methoxy-2-propanol (107.04 grams) and IR 184 (1.8971 grams) were mixed together to form the coating solution (about 40 wt. % total solids and 1 wt. % PI, based on total solids).

### Preparation of Surface Modified 440 nm Silica Curable Resin Coating Composition

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 440 nm silica particle dispersion to form 75:25 particle:prepolymer weight ratio. The functionality of the prepolymer blend was 2.34. The MS440-1 modified particle solution (70.0 grams @ 44.85 wt. % solids), the above prepolymer blend (10.47 grams), 1-methoxy-2-propanol (24.25 grams) and IR 184 (1.257 gram) were mixed together to form the coating solution (about 40 wt. % total solids and 3 wt. % PI, based on total solids).

The general process followed the schematic drawing in FIG. 3A. The coating solution was supplied at a rate of 5 cm³/min to a 4 inch (10.2 cm) wide slot type coating die. After the solution was coated on a 0.002 inch (0.051 mm) thick polyester, the coated web travelled a 10 ft. (3 m) span in the room environment, and passed through two 5 ft. (1.5 m) long zones of small gap drying with plate temperatures set at 170° F. (77° C.). The substrate was moving at a speed of 10 ft./min. (305 cm/min.) to achieve a wet coating thickness of approximately 10 micrometers. Finally the dried coating entered a UV chamber equipped with a UV light source (Model I300P from Fusion UV Systems Inc.) where H-bulb was used. The UV chamber was purged by a gas stream pre-mixed with nitrogen and a small volume of air. The flow rate of nitrogen was fixed at 314 liters/min. (11 scfm). The flow rate of compressed air and cure chamber oxygen concentration for each coating is listed in Table 7, below, as are results of various tests. The oxygen concentration in the cure chamber was measured using an oxygen analyzer (Series 3000 Trace Oxygen Analyzer).

TABLE 7

| | | Air Flow | Oxygen | | |
|---|---|---|---|---|---|
| | | Rate | concentration | | |
| | Particle | (liters/ | in UV | Reflection | Haze |
| Example | Size | min.) | chamber (ppm) | (%) | (%) |
| Comp. 5A-1 | No | 0 | 80 | 4.3 | 1.14 |
| | Particles | | | | |
| | (control) | | | | |
| 5B-1 | 20 nm | 24 | 10000 | 2.6 | 1.25 |
| 5C-1 | 75 nm | 10 | 4200 | 1.8 | 1.25 |
| 5D-1 | 190 nm | 19 | 8200 | 1.41 | 2.23 |
| 5E-1 | 440 nm | 9 | 5000 | 2.44 | 6.31 |

### Example 6

### Surface Modified 75 nm Particles (MPS)

A prepolymer blend of pentaerythritol tetraacrylate, 1,6 hexanediol diacrylate, and isobornyl acrylate (“SR295,” “SR238,” “SR506,” respectively) in a 40:40:20 weight ratio was mixed with the MPS modified 75 nm silica particle dispersion to form 75:25 particle:prepolymer weight ratio. The functionality of the prepolymer blend was 2.34. The MS75-5 modified particle solution (42.02 grams @ 51.10 wt. % solids), the above prepolymer blend (7.15 grams), 1-methoxy-2-propanol (22.40 grams) and IR 184 (0.859 gram) were mixed together to form the coating solution (about 40 wt. % total solids and 3 wt. % PI, based on total solids).

### Surface Modified 75 nm Particles 75:25 (A174:A1230)

A prepolymer blend, a blend of pentaerythritol tetraacrylate, 1,6 hexanediol diacrylate, and isobornyl acrylate (“SR295,” “SR238,” “SR506,” respectively) in a 40:40:20 weight ratio was mixed with the silane modified (75:25 MPS:A1230) 75 nm silica particle dispersion to form 75:25 particle:prepolymer weight ratio. The functionality of the prepolymer blend was 2.34. The MS75-1 modified particle solution (50.04 grams @ 42.37 wt. % solids), the above prepolymer blend (7.06 grams), 1-methoxy-2-propanol (13.56 grams) and IR 184 (0.847 gram) were mixed together to form the coating solution (about 40 wt. % total solids and 3 wt. % PI, based on total solids).

### Surface Modified 75 nm Particles 50:50 (A174:A1230)

A prepolymer blend, a blend of pentaerythritol tetraacrylate, 1,6 hexanediol diacrylate, and isobornyl acrylate (“SR295,” “SR238,” “SR506,” respectively) in a 40:40:20 weight ratio was mixed with the silane modified (50:50 MPS:A1230) 75 nm silica particle dispersion to form 75:25 particle:prepolymer weight ratio. The functionality of the prepolymer blend was 2.34. The MS75-3 modified particle solution (48.02 grams @ 45.10 wt. % solids), the above prepolymer blend (7.22 grams), 1-methoxy-2-propanol (16.95 grams) and IR 184 (0.866 gram) were mixed together to form the coating solution (about 40 wt. % total solids and 3 wt. % PI, based on total solids).

The general process for coating and processing the solution followed the schematic in FIG. 3. The first coating solution was delivered at a rate of 2.65 cm³/min. to a 4 inch (10.2 cm) wide slot-type coating die. After the solution was coated on a 0.002 inch (0.051 mm) thick primed polyester (“MELINEX 617”), the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft./min (305 cm/min.) to achieve a wet coating thickness of about 10 micrometers. Finally the dried coating entered a UV chamber equipped with a UV light source (Model I300P from Fusion UV Systems Inc.) where H-bulb was used. The UV chamber was purged by a gas stream pre-mixed with nitrogen and a small volume of air. The flow rate of nitrogen was fixed at 314 liters/min. (11 scfm), and the flow rate of compressed air was adjusted to achieve the oxygen concentrations listed in Table 8, below. The oxygen concentration in the cure chamber was measured using an oxygen analyzer (Series 3000 Trace Oxygen Analyzer). Results of various tests are provided in Table 8, below.

TABLE 8

| | | | Oxygen | |
|---|---|---|---|---|
| | Solution | | concentration in | Reflection |
| Example | ID | MPS:A1230 | UV chamber (ppm) | (%) |
| Comp. 6A-1 | 1 | 100:0 | 32 | 3.93 |
| 6A-1 | 1 | 100:0 | 2175 | 2.94 |
| 6A-2 | 1 | 100:0 | 5176 | 2.61 |
| 6A-3 | 1 | 100:0 | 9695 | 2.54 |
| 6B-1 | 2 | 75:25 | 335 | 3.25 |
| 6B-2 | 2 | 75:25 | 2334 | 1.67 |
| 6B-3 | 2 | 75:25 | 5356 | 1.71 |
| 6B-4 | 2 | 75:25 | 9485 | 1.9 |
| Comp. 6C-1 | 3 | 50:50 | 44 | 3.7 |
| 6C-1 | 3 | 50:50 | 2196 | 1.85 |
| 6C-2 | 3 | 50:50 | 5258 | 2.11 |
| 6C-3 | 3 | 50:50 | 9432 | 2.19 |

### Example 7

### 100% Propoxylated Trimethylolpropane Triacrylate (SR492)

The prepolymer propoxylated trimethylolpropane triacrylate, “SR492” was blended with the MPS modified 190 nm silica particle dispersion to form 65:35 particle:prepolymer weight ratio. The functionality of the prepolymer was 3. The MS 190-5 modified particle solution (45.00 grams @ 44.27 wt. % solids), the above prepolymer (10.73 grams), 1-methoxy-2-propanol (20.89 grams) and IR 184 (0.31 gram) were mixed together to form the coating solution (about 40 wt. % total solids and 1 wt. % PI, based on total solids). This is Solution 7A.

### Prepolymer Blend with 40% SR295:40% SR238:20% SR506

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 190 nm silica particle dispersion to form 65:35 particle:prepolymer weight ratio. The functionality of the prepolymer blend was 2.34. The MS 190-5 modified particle solution (42.0 grams @ 44.27 wt. % solids), the above prepolymer blend (10.01 grams), 1-methoxy-2-propanol (19.50 grams) and IR 184 (0.286 gram) were mixed together to form the coating solution (about 40 wt. % total solids and 1 wt. % PI, based on total solids). This is Solution 7B.

### Prepolymer Blend with 40% SR295:40% SR238:20% SR440

A prepolymer blend of pentaerythritol tetraacrylate, 1,6 hexanediol diacrylate, and isooctyl acrylate (“SR295,” “SR238,” “SR440,” respectively) in a 40:40:20 weight ratio was blended with the MPS modified 190 nm silica particle dispersion to form 65:35 particle:prepolymer weight ratio. The functionality of the prepolymer blend was 2.30. The MS 190-5 modified particle solution (45.03 grams @ 44.27 wt. % solids), the above prepolymer blend (10.73 grams), 1-methoxy-2-propanol (20.92 grams) and IR 184 (0.306 gram) were mixed together to form the coating solution (about 40 wt. % total solids and 1 wt. % PI, based on total solids). This Solution 7C.

### Prepolymer Blend with 40% SR295:40% SR238:20% SR256

A prepolymer blend of pentaerythritol tetraacrylate, 1,6 hexanediol diacrylate, and 2(2-ethoxyethoxy) ethyl acrylate (“SR295,” “SR238,” “SR256,” respectively) in a 40:40:20 weight ratio was blended with the MPS modified 190 nm silica particle dispersion to form 65:35 particle:prepolymer weight ratio. The functionality of the prepolymer blend was 2.30. The MS 190-5 modified particle solution (45.06 grams @ 44.27 wt. % solids), the above prepolymer blend (10.73 grams), 1-methoxy-2-propanol (20.87 grams) and IR 184 (0.306 gram) were mixed together to form the coating solution (about 40 wt. % total solids and 1 wt. % PI, based on total solids). This is Solution 7D.

### Prepolymer Blend with 40% SR492:40% SR238:20% SR440

A prepolymer blend of propoxylated trimethylolpropane triacrylate, 1,6 hexanediol diacrylate, and isooctyl acrylate (“SR492,” “SR238,” “SR440,” respectively) in a 40:40:20 weight ratio was blended with the MPS modified 190 nm silica particle dispersion to form 65:35 particle:prepolymer weight ratio. The functionality of the prepolymer blend was 1.94. The MS 190-5 modified particle solution (42.02 grams @ 44.27 wt. % solids), the above prepolymer blend (10.01 grams), 1-methoxy-2-propanol (19.47 grams) and IR 184 (0.286 gram) were mixed together to form the coating solution (about 40 wt. % total solids and 1 wt. % PI, based on total solids). This is Solution 7E.

### Prepolymer Blend with 20% SR492:20% SR350:10%5R295:20% SR239:30% SR440

A prepolymer blend of propoxylated trimethylolpropane triacrylate, trimethylolpropane trimethacrylate, pentaerythritol tetraacrylate, 1,6 hexanediol dimethacrylate, and isooctyl acrylate (“SR492,” “SR350,” “SR295,” “SR239,” “SR440,” respectively) in a 20:20:10:20:30 weight ratio was blended with the MPS modified 190 nm silica particle dispersion to form 65:35 particle:prepolymer weight ratio. The functionality of the prepolymer blend was 1.99. The MS 190-5 modified particle solution (40.02 grams @ 44.27 wt. % solids), the above prepolymer blend (9.54 grams), 1-methoxy-2-propanol (18.58 grams) and IR 184 (0.273 gram) were mixed together to form the coating solution (about 40 wt. % total solids and 1 wt. % PI, based on total solids). This is Solution 7F.

### Prepolymer of 100% 1,6 Hexanediol Diacrylate (SR238)

The prepolymer 1,6 hexanediol diacylate (“SR238”) was mixed with the MPS modified 190 nm silica particle dispersion to form 65:35 particle:prepolymer weight ratio. The functionality of the prepolymer was 2. The modified particle solution (50.02 grams @ 43.99 wt. % solids), the above prepolymer (11.88 grams), 1-methoxy-2-propanol (22.75 grams) and IR 184 (0.339 gram) were mixed together to form the coating solution (about 40 wt. % total solids and 1 wt,% PI, based on total solids). This solution is Solution 7G.

### Prepolymer of 100% Trimethylolpropane Trimethacrylate (SR350)

The prepolymer trimethylolpropane trimethacrylate (“SR350”) was mixed with the MPS modified 190 nm silica particle dispersion to form 65:35 particle:prepolymer weight ratio. The functionality of the prepolymer was 3. The modified particle solution (50.05 grams @ 43.99 wt % solids), the above prepolymer (11.87 grams), 1-methoxy-2-propanol (22.76 grams) and IR 184 (0.338 gram) were mixed together to form the coating solution (about 40 wt. % total solids and 1 wt. % PI, based on total solids). This is Solution 7H.

### Prepolymer of 100% Ethoxylated Pentaerythritol Triacrylate (SR494)

The prepolymer ethoxylated pentaerythritol triacrylate (“SR494”) was mixed with the MPS modified 190 nm silica particle dispersion to form 65:35 particle:prepolymer weight ratio. The functionality of the prepolymer was 4. The modified particle solution (50.05 grams @ 43.99 wt. % solids), the above prepolymer (11.87 grams), 1-methoxy-2-propanol (22.77 grams) and IR 184 (0.339 gram) were mixed together to form the coating solution (about 40 wt. % total solids and 1 wt. % PI, based on total solids). This is Solution 71.

### Prepolymer Blend with 40% SR295:40% SR238:20% SR350

A prepolymer blend of pentaerythritol tetraacrylate, 1,6 hexanediol diacrylate, and trimethylolpropane trimethacrylate (“SR295,” “SR238,” “SR350,” respectively) in a 40:40:20 weight ratio was mixed with the MPS modified 190 nm silica particle dispersion to form 65:35 particle:prepolymer weight ratio. The functionality of the prepolymer blend was 2.82. The modified particle solution (50.01 grams @ 43.99 wt. % solids), the above prepolymer blend (11.87 grams), 1-methoxy-2-propanol (22.75 grams), and IR 184 (0.340 gram) were mixed together to form the coating solution (about 40 wt. % total solids and 1 wt. % PI, based on total solids). This is Solution 7J.

### Prepolymer Blend with 40% SR494:40% SR238:20% SR506

A prepolymer blend of ethoxylated pentaerythritol triacrylate, 1,6 hexanediol diacrylate, and isobornyl acrylate (“SR494,” “SR238,” “SR506,” respectively) in a 40:40:20 weight ratio was mixed with the MPS modified 190 nm silica particle dispersion to form 65:35 particle:prepolymer weight ratio. The functionality of the prepolymer blend was 2.16. The modified particle solution (50.07 grams @ 43.99 wt. % solids), the above prepolymer blend (11.89 grams), 1-methoxy-2-propanol (22.75 grams), and IR 184 (0.340 gram) were mixed together to form the coating solution (about 40 wt. % total solids and 1 wt. % PI, based on total solids). This is Solution 7K.

The general process for coating and processing the solution followed the schematic in FIG. 3A. The first coating solution was delivered at a rate of 2.65 cm³/min. to a 4 inch (10.2 cm) wide slot-type coating die. After the solution was coated on a 0.002 inch (0.051 mm) thick primed polyester (“MELINEX 617”), the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft./min (305 cm/min.) to achieve a wet coating thickness of about 5 micrometers. Finally the dried coating entered a UV chamber equipped with a UV light source (Model I300P from Fusion UV Systems Inc.) where H-bulb was used. The UV chamber was purged by a gas stream pre-mixed with nitrogen and a small volume of air. The flow rate of nitrogen was fixed at 314 liters/min. (11 scfm), and the flow rate of compressed air was adjusted to achieve the oxygen concentrations listed in Table 9, below. The oxygen concentration in the cure chamber was measured using an oxygen analyzer (Series 3000 Trace Oxygen Analyzer). The oxygen levels used and results of various tests are provided in Table 9, below.

TABLE 9

| | | | Oxygen con- | Re- | Trans- | |
|---|---|---|---|---|---|---|
| | Solu- | Air | centration in | flec- | mis- | |
| | tion | flow rate | UV chamber | tion | sion | Haze |
| Example | ID | (liters/min.) | (ppm) | (%) | (%) | (%) |
| Comp. 7A-1 | 7A | 0 | 43 | 4.05 | 93.2 | 0.55 |
| 7A-1 | 7A | 2 | 755 | 3.91 | 93.3 | 0.65 |
| 7A-2 | 7A | 5 | 1965 | 3.73 | 92.9 | 0.72 |
| 7A-3 | 7A | 9 | 4040 | 3.71 | 93.4 | 0.76 |
| 7A-4 | 7A | 14 | 6120 | 3.64 | 93.1 | 0.70 |
| 7A-5 | 7A | 19 | 8715 | 3.56 | 93.4 | 0.79 |
| Comp. 7B-1 | 7B | 0 | 47 | 4.04 | 93.1 | 0.69 |
| 7B-1 | 7B | 2 | 730 | 2.56 | 93.9 | 1.41 |
| 7B-2 | 7B | 5 | 1960 | 1.88 | 94.5 | 1.36 |
| 7B-3 | 7B | 9 | 3990 | 1.70 | 94.6 | 1.56 |
| 7B-4 | 7B | 14 | 6540 | 1.59 | 94.2 | 1.87 |
| 7B-5 | 7B | 19 | 8750 | 1.50 | 94.7 | 1.88 |
| Comp. 7C-1 | 7C | 0 | 46 | 3.75 | 93.3 | 0.74 |
| 7C-1 | 7C | 2 | 760 | 2.07 | 94.4 | 1.05 |
| 7C-2 | 7C | 5 | 2030 | 1.68 | 94.8 | 1.57 |
| 7C-3 | 7C | 9 | 4060 | 1.49 | 94.8 | 1.86 |
| 7C-4 | 7C | 14 | 6145 | 1.36 | 95.0 | 1.83 |
| 7C-5 | 7C | 19 | 8970 | 1.37 | 94.9 | 2.15 |
| Comp. 7D-1 | 7D | 0 | 51 | 3.99 | 93.2 | 0.64 |
| 7D-1 | 7D | 2 | 750 | 2.34 | 94.3 | 1.24 |
| 7D-2 | 7D | 5 | 1920 | 2.00 | 94.7 | 1.37 |
| 7D-3 | 7D | 9 | 4140 | 1.69 | 94.8 | 1.39 |
| 7D-4 | 7D | 14 | 5975 | 1.69 | 94.8 | 1.52 |
| 7D-5 | 7D | 19 | 8949 | 1.59 | 94.8 | 1.74 |
| Comp. 7E-1 | 7E | 0 | 44 | 3.84 | 93.0 | 0.72 |
| 7E-1 | 7E | 2 | 715 | 2.06 | 94.2 | 1.18 |
| 7E-2 | 7E | 5 | 1910 | 1.35 | 94.7 | 1.30 |
| 7E-3 | 7E | 9 | 3980 | 1.29 | 94.6 | 1.54 |
| 7E-4 | 7E | 14 | 6230 | 1.35 | 94.4 | 1.84 |
| 7E-5 | 7E | 19 | 8470 | 1.67 | 94.6 | 2.08 |
| Comp. 7F-1 | 7F | 0 | 50 | 3.57 | 93.6 | 0.80 |
| 7F-1 | 7F | 2 | 900 | 1.35 | 95.2 | 1.51 |
| 7F-2 | 7F | 5 | 2400 | 1.52 | 94.9 | 2.28 |
| 7F-3 | 7F | 9.5 | 4600 | 1.42 | 94.7 | 3.17 |
| 7F-4 | 7F | 14 | 7400 | 1.65 | 94.6 | 4.84 |
| 7F-5 | 7F | 19 | 9600 | 1.62 | 94.6 | 4.58 |
| Comp. 7G-1 | 7G | 0 | 50 | 4.07 | 94.4 | 0.63 |
| 7G-1 | 7G | 2 | 500 | 1.61 | 96.3 | 1.78 |
| 7G-2 | 7G | 5 | 2000 | 1.61 | 96 | 2.92 |
| 7G-3 | 7G | 9.5 | 4000 | 1.5 | 95.9 | 4.06 |
| 7G-4 | 7G | 14 | 7000 | 1.59 | 95.8 | 4.98 |
| 7G-5 | 7G | 19 | 9500 | 1.64 | 95.7 | 5.24 |
| Comp. 7H-1 | 7H | 0 | 50 | 4.25 | 94.2 | 0.6 |
| 7H-1 | 7H | 2 | 500 | 2.28 | 95.4 | 1.96 |
| 7H-2 | 7H | 5 | 2000 | 1.95 | 95.6 | 2.47 |
| 7H-3 | 7H | 10 | 4000 | 1.61 | 96 | 2.76 |
| Comp. 7I-1 | 7I | 0 | 50 | 4.28 | 93.9 | 0.51 |
| 7I-1 | 7I | 2 | 500 | 4.04 | 94.3 | 0.79 |
| 7I-2 | 7I | 5 | 2000 | 3.95 | 94.2 | 1.07 |
| 7I-3 | 7I | 10 | 4000 | 4.02 | 94.3 | 0.91 |
| 7I-4 | 7I | 14 | 7000 | 3.88 | 94.1 | 1.04 |
| 7I-5 | 7I | 19 | 9500 | 3.94 | 94.2 | 0.83 |
| Comp. 7J-1 | 7J | 0 | 50 | 4.19 | 94.2 | 0.61 |
| 7J-1 | 7J | 2 | 500 | 2.96 | 95.3 | 2.03 |
| 7J-2 | 7J | 5 | 2000 | 2 | 95.8 | 1.79 |
| 7J-3 | 7J | 10 | 4000 | 1.82 | 95.5 | 1.9 |
| 7J-4 | 7J | 14 | 7000 | 1.72 | 95.6 | 1.92 |
| 7J-5 | 7J | 19 | 9500 | 1.77 | 95.2 | 2.01 |
| Comp. 7K-1 | 7K | 0 | 50 | 4 | 93.8 | 0.64 |
| 7K-1 | 7K | 2 | 500 | 3.3 | 95.2 | 1.29 |
| 7K-2 | 7K | 5 | 2000 | 2.11 | 95.7 | 1.38 |
| 7K-3 | 7K | 10 | 4000 | 1.64 | 95.8 | 1.65 |
| 7K-4 | 7K | 14 | 7000 | 1.5 | 96.3 | 1.88 |
| 7K-5 | 7K | 19 | 9500 | 1.61 | 96.2 | 1.91 |

### Example 8

### Preparation of Curable Resin Coating Composition with 0.5 Wt. % PI

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 190 nm silica particle dispersion to form 65:35 particle:prepolymer weight ratio. The functionality of the prepolymer blend was 2.34. The MS 190-4 modified particle solution (149.99 grams @ 41.86 wt. % solids), the above prepolymer blend (33.9 gram), 1-methoxy-2-propanol (56.65 grams) and IR 184 (0.484 gram) were mixed together to form the coating solution (about 40 wt. % total solids and 0.5 wt. % PI, based on total solids).

### Preparation of Curable Resin Coating Composition with 1.0 Wt % PI

The above 0.5 wt. % PI composition (208.6 grams) was mixed with IR 184 (0.4175 grams) to provide a coating solution with 1 wt. % PI, based on total solids.

### Preparation of Curable Resin Coating Composition with 3.0 Wt. % PI

The above 1.0 wt. % PI composition (162.3 grams) was mixed with IR 184 (1.305 gram) to give a coating solution with 3 wt. % PI, based on total solids.

The general process for coating and processing the solutions followed the schematic drawing in FIG. 3A. The first coating solution was delivered at a rate of 2.5 cm³/min. to a 4 inch (10.2 cm) wide slot-type coating die. After the solution was coated on a 0.002 inch (0.051 mm) thick primed polyester (“MELINEX 618”), the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft./min (305 cm/min.) to achieve a wet coating thickness of about 5 micrometers. Finally the dried coating entered a UV chamber equipped with a UV light source (Model I300P Fusion UV Systems) where H-bulb was used. The UV chamber was purged by a gas stream pre-mixed with nitrogen and a small volume of air. The flow rate of nitrogen was fixed at 314 liters/min. (11 scfm), and the flow rate of compressed air was adjusted to achieve the oxygen concentration in the UV cure chamber listed in Table 10, below. The oxygen concentration in the cure chamber was measured using an oxygen analyzer (Series 3000 Trace Oxygen Analyzer). Results of various tests are provided in Table 10, below.

TABLE 10

| | | | Oxygen | | | |
|---|---|---|---|---|---|---|
| | Photoinitiator | Air | concentration | | | |
| | Concentration | Flow Rate | in UV chamber | Reflection | Transmission | Haze |
| Example | (wt. %) | (liters/min.) | (ppm) | (%) | (%) | (%) |
| Comp. 8A-1 | 0.5 | 0 | 10 | 3.85 | 92.8 | 0.79 |
| 8A-1 | 0.5 | 2 | 700 | 1.74 | 94.3 | 1.69 |
| 8A-2 | 0.5 | 8 | 1900 | 1.37 | 94.5 | 2.28 |
| 8A-3 | 0.5 | 10 | 4200 | 1.36 | 94.5 | 2.84 |
| 8A-4 | 0.5 | 14 | 5400 | 1.25 | 94.4 | 3.1 |
| 8A-5 | 0.5 | 19 | 7400 | 1.32 | 94.4 | 3.53 |
| 8A-6 | 0.5 | 24 | 10000 | 1.37 | 94.3 | 3.72 |
| Comp. 8B-1 | 1.0 | 0 | 10 | 3.92 | 92.8 | 0.69 |
| 8B-1 | 1.0 | 2 | 700 | 1.91 | 94.1 | 1.69 |
| 8B-2 | 1.0 | 8 | 1900 | 1.61 | 94.4 | 2.2 |
| 8B-3 | 1.0 | 10 | 4200 | 1.33 | 94.5 | 2.3 |
| 8B-4 | 1.0 | 14 | 5400 | 1.42 | 94.5 | 2.56 |
| 8B-5 | 1.0 | 19 | 7400 | 1.28 | 94.4 | 2.84 |
| 8B-6 | 1.0 | 24 | 10000 | 1.25 | 94.4 | 2.98 |
| Comp. 8C-1 | 3.0 | 0 | 10 | 4.1 | 92.9 | 0.68 |
| 8C-1 | 3.0 | 2 | 700 | 2.64 | 93.7 | 1.31 |
| 8C-2 | 3.0 | 8 | 1900 | 1.93 | 94.1 | 1.3 |
| 8C-3 | 3.0 | 10 | 4200 | 1.78 | 94.2 | 1.98 |
| 8C-4 | 3.0 | 14 | 5400 | 1.81 | 94.2 | 1.94 |
| 8C-5 | 3.0 | 19 | 7400 | 1.81 | 94.3 | 1.98 |
| 8C-6 | 3.0 | 24 | 10000 | 1.72 | 94.3 | 1.95 |

### Example 9

### Preparation of Curable Resin Coating Composition with No Added Surface Active Agent

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with the MPS modified 190 nm silica particle dispersion to form 65:35 particle:prepolymer weight ratio. The functionality of the prepolymer blend was 2.34. The MS 190-1 modified particle solution (43.02 grams @ 42.79 wt. % solids), the above prepolymer blend (10.60 grams), a 50:50 mixture of 1-methoxy-2-propanol:IPA (17.87 grams) and IR 184 (0.287 gram) were mixed together to form the coating solution (about 40 wt. % total solids and 1 wt. % PI, based on total solids). This is Solution 9A.

### Preparation of Curable Resin Coating Composition with 0.051 Wt % TEGORAD 2250

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 190 nm silica particle dispersion to form 65:35 particle:prepolymer weight ratio. The functionality of the prepolymer blend was 2.34. The MS 190-2 modified particle solution (65.51 grams @ 41.02 wt. % solids), the above prepolymer blend (14.46 grams), 1-methoxy-2-propanol (23.35 grams) and IR 184 (0.4154 gram) were mixed together to form the coating solution (about 40 wt. % total solids and 1.0 wt. % PI, based on total solids). TEGORAD 2250 (0.053 gram) was added to give a concentration of 0.051 wt. % in the coating solution. This is Solution 9B.

### Preparation of Curable Resin Coating Composition with 0.108 Wt % HFPO

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 190 nm silica particle dispersion to form 65:35 article:prepolymer weight ratio. The functionality of the prepolymer blend was 2.34. The MS 190-3 modified particle solution (60 grams @ 42.20 wt. % solids), the above prepolymer blend (13.65 grams), 1-methoxy-2-propanol (23.75 grams) and IR 184 (0.3912 gram) were mixed together to form the coating solution (about 40 wt. % total solids and 1.0 wt. %, PI based on total solids). HFPO at 33 wt. % in ethyl acetate (0.32 gram) and ethyl acetate (4.85 gram) were added to the coating solution. The final concentration of HFPO was 0.108 wt. %, based on total solution weight. This is Solution 9C.

### Preparation of Curable Resin Coating Composition with 0.04 Wt % HFPO

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 190 nm silica particle dispersion to form 65:35 particle:prepolymer weight ratio. The functionality of the prepolymer blend was 2.34. The MS 190-3 modified particle solution (60.13 grams @ 42.20 wt. % solids), the above prepolymer blend (13.44 grams), 1-methoxy-2-propanol (23.60 grams) and IR 184 (0.3905 gram) were mixed together to form the coating solution (about 40 wt. % total solids and 1.0 wt. % PI, based on total solids). HFPO at 33 wt. % in ethyl acetate (0.1125 gram) and ethyl acetate (4.85 gram) were added to the coating solution. The final concentration of HFPO was 0.04 wt. %, based on total solution weight. This is Solution 9D.

The general process for coating and processing the solutions followed the schematic drawing in FIG. 3A. The first coating solution was delivered at a rate of 5 cm³/min. to a 4 inch (10.2 cm) wide slot-type coating die. After the solution was coated on a 0.002 inch (0.051 mm) thick primed polyester, the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft./min. (305 cm/min.) to achieve a wet coating thickness of about 10 micrometers. Finally the dried coating entered a UV chamber equipped with a UV light source (Model I300P from Fusion UV Systems, Gaithersburg, Md.) where H-bulb was used. The UV chamber was purged by a gas stream pre-mixed with nitrogen and a small volume of air. The flow rate of nitrogen was fixed at 314 liters/min. (11 scfm), and the flow rate of compressed air was adjusted to achieve the oxygen concentration in the UV cure chamber listed in Tables 11A and 11B, below. The oxygen concentration in the cure chamber was measured using an oxygen analyzer (Series 3000 Trace Oxygen Analyzer). Results of various tests are provided in Tables 11A, 11B, 11C, and 11D, below.

TABLE 11A
Solution 9A

| | Oxygen concentration | | |
|---|---|---|---|
| Example | in UV chamber (ppm) | Reflection (%) | Haze (%) |
| Comp. 9A-1 | 8 | 4.37 | 0.87 |
| 9A-1 | 700 | 3.02 | 1.27 |
| 9A-2 | 1800 | 2.42 | 1.43 |
| 9A-3 | 4200 | 2.10 | 1.98 |
| 9A-4 | 6400 | 1.94 | 1.75 |
| 9A-5 | 8700 | 1.80 | 2.28 |
| 9A-6 | 10000 | 1.78 | 2.59 |

TABLE 11B
Solution 9B

| | Oxygen concentration | | |
|---|---|---|---|
| Example | in UV chamber (ppm) | Reflection (%) | Haze (%) |
| Comp. 9B-1 | 15 | 3.97 | 0.51 |
| 9B-1 | 700 | 1.61 | 1.63 |
| 9B-2 | 2300 | 1.39 | 2.44 |
| 9B-3 | 4500 | 1.58 | 1.82 |
| 9B-4 | 5600 | 1.26 | 2.20 |
| 9B-5 | 8080 | 1.36 | 2.75 |
| 9B-6 | 10000 | 1.26 | 3.26 |

TABLE 11C
Solution 9C

| | Oxygen concentration | | |
|---|---|---|---|
| Example | in UV chamber (ppm) | Reflection (%) | Haze (%) |
| Comp. 9C-1 | 30 | 4.13 | 0.51 |
| 9C-1 | 680 | 1.95 | 1.25 |
| 9C-2 | 2050 | 1.4 | 2.09 |
| 9C-3 | 4700 | 1.28 | 2.42 |
| 9C-4 | 5500 | 1.43 | 2.51 |
| 9C-5 | 8000 | 1.33 | 2.93 |
| 9C-6 | 10000 | 1.23 | 3.38 |

TABLE 11D
Solution 9D (0.04% TEGORAD)

| | Oxygen concentration | | |
|---|---|---|---|
| Example | in UV chamber (ppm) | Reflection (%) | Haze (%) |
| Comp. 9D-1 | 55 | 3.44 | 0.58 |
| 9D-1 | 730 | 1.46 | 1.93 |
| 9D-2 | 2700 | 1.28 | 2.73 |
| 9D-3 | 4840 | 1.24 | 3.41 |
| 9D-4 | 5830 | 1.29 | 3.62 |
| 9D-5 | 8400 | 1.35 | 3.9 |
| 9D-6 | 10000 | 1.36 | 4.78 |

### Example 10

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 20 nm silica particle dispersion to form a 45:55 particle:prepolymer weight ratio. The functionality of the prepolymer blend was 2.09. The MS20-1 modified particle solution (40.0 grams @ 50.99 wt. % solids), the above prepolymer blend (24.95 grams), 1-methoxy-2-propanol (48.44 grams) and IR 184 (0.454 gram) were mixed together to form the coating solution (about 40 wt. % total solids and 1 wt. % PI, based on total solids).

The general process for coating and processing the solutions followed the schematic drawing in FIG. 3A. The first coating solution was delivered at a rate of 5.25 cm³/min. to a 4 inch (10.2 cm) wide slot-type coating die. After the solution was coated on a 0.002 inch (0.051 mm) thick polyester the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft./min. (305 cm/min.) to achieve a wet coating thickness of about 10 micrometers. Finally the dried coating entered a UV chamber equipped with a UV light source (Model I300P from Fusion UV Systems) where H-bulb was used. The UV chamber was purged by a gas stream pre-mixed with nitrogen and a small volume of air. The flow rate of nitrogen was fixed at 314 liters/min. (11 scfm), and the flow rate of compressed air was adjusted to achieve the oxygen concentration in the UV cure chamber listed in Table 12, below. The oxygen concentration in the cure chamber was measured using an oxygen analyzer (Series 3000 Trace Oxygen Analyzer). Results of various tests are provided in Table 12, below.

TABLE 12

| | | Oxygen | | | | | |
|---|---|---|---|---|---|---|---|
| | Air | concentration | | | | | |
| | flow rate | in UV chamber | Transmission | Haze | Clarity | Reflection | Tackiness |
| Example | (liters/min.) | (ppm) | (%) | (%) | (%) | (%) | rating |
| Comp. 10A-1 | 0 | 40 | 95.1 | 1.81 | 99.8 | 4.38 | 1 |
| 10A-1 | 2 | 450 | 95 | 1.72 | 99.8 | 4.14 | 3 |
| 10A-2 | 8 | 1615 | 95.3 | 1.69 | 100 | 3.76 | 3 |
| 10A-3 | 10 | 4730 | 95.6 | 1.71 | 99.8 | 3.46 | 3 |
| 10A-4 | 14 | 7340 | 95.5 | 1.71 | 100 | 3.23 | 3 |
| 10A-5 | 19 | 9950 | 96.1 | 1.67 | 100 | 3.09 | 3 |

The tackiness of the film is determined by pressing and dragging the coated film, coating in contact with glass slide, over a stationary clean glass microscope slide. For a 1 Rating the coated film does not slip and will not move over the stationary glass slide, for a 2 Rating the coated film moves over the stationary glass slide with some resistance, for a 3 Rating the coated film easily moves over the stationary glass slide with very little resistance.

### Example 11

A prepolymer blend of propoxylated trimethylolpropane triacrylate, 1,6 hexanediol diacrylate, and isooctyl acrylate (“SR492,” “SR238,” “SR440,” respectively) in a 40:40:20 weight ratio was mixed with silane modified (75:25 MPS:A1230) 100 nm silica particles dispersion to form a 67.5:32.5 particle:prepolymer weight ratio. The functionality of the prepolymer blend was 1.94. The MS100-1 modified particle solution (100.04 grams @ 43.84 wt. % solids), the above prepolymer blend (20.28 grams), 1-methoxy-2-propanol (35.72 grams) and IR 184 (1.82 gram) were mixed together to form the coating solution (about 40 wt. % total solids, 3 wt. % PI, based on total solids). HFPO at 30 wt. % in ethyl acetate (0.32 gram) was added to the coating solution. The final concentration of HFPO was 0.06 wt. %, based on total solution weight.

The general process for coating and processing the solutions followed the schematic drawing in FIG. 3A. The first coating solution was delivered at a rate of 10 cm³/min. to a 8 inch (20.32 cm) wide slot-type coating die. After the solution was coated on a 0.003 inch (0.0076 mm) thick one side primed heat stabilized polyester (obtained under the trade designation “ST 580” from Dupont Teijin Films), the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft./min (305 cm/min.) to achieve a wet coating thickness of about 10 micrometers. Finally the dried coating entered a UV chamber equipped with a UV light source (Model I300P from Fusion UV Systems Inc.) where H-bulb was used. The UV chamber was purged by a gas stream pre-mixed with nitrogen and a small volume of air. The flow rate of nitrogen was fixed at 314 liters/min. (11 scfm), and the flow rate of compressed air was adjusted at 2 liters/min. (4.2 scfh) and the oxygen concentration in the UV cure chamber is around 730 ppm. The oxygen concentration in the cure chamber was measured using an oxygen analyzer (Series 3000 Trace Oxygen Analyzer).

The sample had a reflection of 1.66%, transmission of 93.9%, and haze of 1.40%.

### Example 12

A prepolymer blend of pentaerythritol tetraacrylate, 1,6 hexanediol diacrylate, and isobornyl acrylate (“SR295,” “SR238,” “SR506,” respectively) in a 40:40:20 weight ratio was blended with the MPS modified 190 nm silica particle dispersion and silane modified (75:25 MPS:A1230) 5 nm silica particle dispersion to form a 70:30 particle:prepolymer weight ratio. The functionality of the prepolymer blend was 2.34. The MS 190-5 modified particle solution (42 grams @ 44.27 wt. % solids), the MS5-1 modified 5 nm silica particle dispersion (3.38 grams @ 61.1 wt. % solids), the above prepolymer blend (8.85 grams), 1-methoxy-2-propanol (19.55 grams), a 30% solution of HFPO in ethyl acetate (0.22 gram) and IR 184 (0.30 gram) were blended together to form the coating solution (about 40 wt. % total solids and 1 wt. % PI, based on total solids).

The general process of coating and processing the coating solutions followed the schematic drawing in FIG. 3A. The first coating solution was delivered at a rate of 2.65 cm³/min. to a 4 inch (10.2 cm) wide slot-type coating die. After the solution was coated on a 0.004 inch (0.10 mm) thick PVDC primed polyester, the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft/min. (305 cm/min.) to achieve a wet coating thickness of about 5 micrometers. Finally the dried coating entered a UV chamber equipped with a UV light source (Model I300P from Fusion UV Systems Inc.) where H-bulb was used. The UV chamber was purged by a gas stream pre-mixed with nitrogen and a small volume of air. The flow rate of nitrogen was fixed at 328 liters/min. (11.5 scfm), and the flow rate of compressed air was adjusted to achieve the oxygen concentration in the UV cure chamber listed in Table 13, below. The oxygen concentration in the cure chamber was measured using an oxygen analyzer (Series 3000 Trace Oxygen Analyzer). Results of various tests are provided in Table 13, below.

TABLE 13

| | Oxygen | | | |
|---|---|---|---|---|
| | concentration in | Transmission | Haze | Reflection |
| Example | UV chamber | (%) | (%) | (%) |
| Comp 12A-1 | 20 | 93.5 | 18.8 | 3.46 |
| 12A-1 | 750 | 94.5 | 22.2 | 1.59 |
| 12A-2 | 2200 | 94.5 | 26.2 | 1.33 |
| 12A-3 | 4200 | 94.5 | 27.3 | 1.29 |

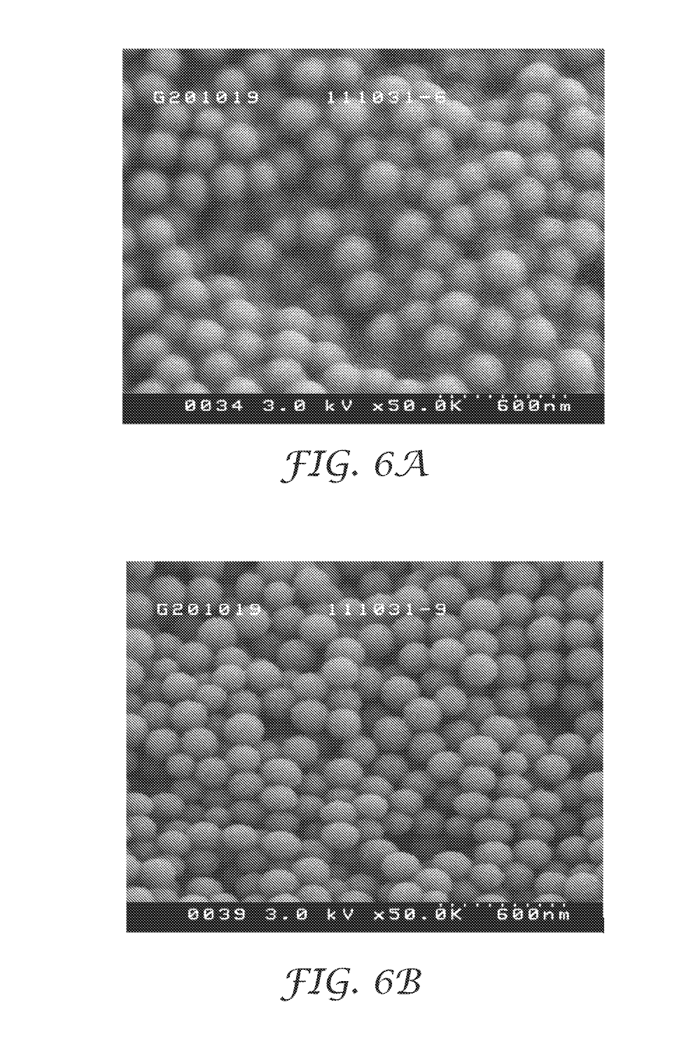

FIG. 6A shows an SEM image of the top surface of Comparative Example 12A-1 cured without any air injection where the oxygen level was around 20 ppm. FIG. 6B shows an SEM image of the top surface of Example 12A-3 cured at an oxygen level of 4,200 ppm. The 5 nm particles in FIG. 6B are assembled on surfaces of individual 190 nm particles.

### Example 13

A prepolymer blend of propoxylated trimethylolpropane triacrylate, 1,6 hexanediol diacrylate, and isooctyl acrylate (“SR492,” “SR238,” “SR440,” respectively) in a 40:40:20 weight ratio was mixed with the MPS modified 190 nm silica particle dispersion to form 65:35 article:prepolymer weight ratio. The functionality of the prepolymer blend was 1.94. The MS 190-7 modified particle solution (599.2 grams @ 46.02 wt. % solids), the above prepolymer blend (148.6 grams), a solvent blend of 1-methoxy-2-propanol (219.3 grams) and MEK (94.2 grams) in a 70:30 weight ratio, and IR 184 (4.28 grams) were mixed together to form the coating solution (about 40 wt. % total solids and 1 wt. % PI, based on total solids). HFPO at 30 wt. % in ethyl acetate (1.15 gram) was added to the coating solution. The final concentration of HFPO was 0.03 wt. %, based on total solution weight.

The first coating solution was delivered at a rate of 7.5 cm³/min to a 4 inch (10.2 cm) wide slot-type coating die. After the solution was coated on a 0.002 inch (0.051 mm) thick primed polyester (“MELINEX 617”), the coated web then travelled about 3 ft. (0.9 m) before entering a 30 ft. (9.1 m) conventional air floatation drier with all 3 zones set at 120° F. (49° C.). The substrate was moving at a speed of 30 ft./min. (9.1 m/min.) to achieve a wet coating thickness of about 5 micrometers. After the drier, the coating was transported through two UV chambers (spaced 2.6 meters apart) sequentially where a UV light source (Model VPS/I600 from Fusion UV Systems Inc.) with H-bulb was used in both chambers. Each UV system is equipped with a variable power output supply. The first chamber was purged by a gas stream pre-mixed with nitrogen and a small volume of air. The flow rate of nitrogen in the first chamber was fixed at 1314 liter/min. The flow rate of compressed air in the first chamber was 31 liter/min. to maintain the oxygen concentration around 6,000 ppm. The flow rate of nitrogen in the second chamber was fixed at 429 liter/min. and no air was injected to the second chamber. The oxygen concentration was about 30 ppm in the second chamber. The oxygen concentration in the cure chamber was measured using an oxygen analyzer (Series 3000 Trace Oxygen Analyzer). Results of various tests are provided in Table 14, below.

TABLE 14

| | UV power | Reflection | Transmission | Haze | Steel Wool |
|---|---|---|---|---|---|
| Example | level (%) | (%) | (%) | (%) | Rating |
| 13A-1 | 25 | 1.79 | 96.1 | 1.40 | 3.3 |
| 13A-2 | 50 | 2.18 | 96.0 | 1.25 | 3.3 |
| 13A-3 | 75 | 2.39 | 95.9 | 1.10 | 3.3 |
| 13A-4 | 100 | 2.43 | 95.8 | 1.13 | 3.7 |

### Example 14

A prepolymer blend of pentaerythritol tetraacrylate, 1,6 hexanediol diacrylate, and isobornyl acrylate (“SR295,” “SR238,” “SR506,” respectively) in a 40:40:20 weight ratio was mixed with the MPS modified 190 nm silica particles dispersion to form 65:35 particle:prepolymer weight ratio. The functionality of the prepolymer blend was 2.34. The MS190-8 modified particle solution (705.6 grams @ 41.79 wt. % solids), the above prepolymer blend (156.9 grams), 1-methoxy-2-propanol (270.2 grams) and IR 184 (4.53 grams) were mixed together to form the coating solution (about 40 wt. % total solids and 1 wt. % PI, based on total solids). HFPO at 30 wt. % in ethyl acetate (1.38 gram) and ethyl acetate (54.74 grams) were added to the coating solution. The final concentration of HFPO was 0.036 wt. %, based on total solution weight.

The first coating solution was delivered at a rate of 7.5 cm³/min to a 4 inch (10.2 cm) wide slot-type coating die. After the solution was coated on a 0.002 inch (0.051 mm) thick primed polyester, the coated web then travelled approximately 3 ft. (0.9 m) before entering a 30 ft. (9.1 m) conventional air floatation drier with all 3 zones set at 120° F. (49° C.). The substrate was moving at a speed of 30 ft./min. (9.14 m/min.) to achieve a wet coating thickness of about 5 micrometers. After the drier, the coating was transported through two sequential UV chambers (spaced 2.6 meters apart) equipped with a UV light source (Model VPS/I600 from Fusion UV Systems Inc.) with a H-bulb in both chambers. The first UV chamber was purged by a gas stream pre-mixed with nitrogen and a small volume of air. “Coupled” mode is defined when the same gas stream is delivered to the second UV chamber, while “uncoupled” mode is used when nitrogen instead of nitrogen and air mixture is supplied to the second chamber. The flow rate of nitrogen in the first and second chambers was 1314 liter/min. and 429 liter/min., respectively. In the “Coupled” mode, the flow rate of compressed air in the first and second chambers was 31 liter/min. and 15 liter/min., respectively. In the “Uncoupled” mode, the flow rate of compressed air in the first and second chambers was 33 liter/min. and 0 liters/min., respectively. The oxygen concentration in the cure chamber was measured using an oxygen analyzer (Series 3000 Trace Oxygen Analyzer). Results of various tests are provided in Table 15, below.

TABLE 15

| | | Chamber one | Chamber two | | | | | | |
|---|---|---|---|---|---|---|---|---|---|
| | | oxygen con- | oxygen con- | Chamber one UV | Chamber two UV | | | | |
| | | centration | centration | power level | power level | Reflection | Transmission | Haze | Steel |
| Example | Mode | (ppm) | (ppm) | (%) | (%) | (%) | (%) | (%) | wool |
| 14A-1 | Coupled | 5,905 | 6,035 | 25 | 100 | 1.36 | 94.4 | 1.96 | 2.7 |
| 14A-2 | Coupled | 5,925 | 6,110 | 50 | 100 | 1.58 | 94.3 | 1.74 | 4 |
| 14A-3 | Uncoupled | 7,310 | 320 | 25 | 100 | 1.45 | 94.4 | 2.00 | 3 |
| 14A-4 | Uncoupled | 6,170 | 200 | 50 | 100 | 1.58 | 94.3 | 1.71 | 3.7 |

### Example 15

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particle dispersion to form a 67.5:32.5 particle:prepolymer weight ratio. The functionality of the prepolymer blend was 2.09. The MS 190-6 modified particle solution (111.84 grams @ 44.45 wt. % solids), the above prepolymer blend (23.93 grams), 1-methoxy-2-propanol (48.38 grams) and IR 184 (0.736 gram) were mixed together to form the coating solution (about 40 wt. % total solids and 1 wt. % PI, based on total solids).

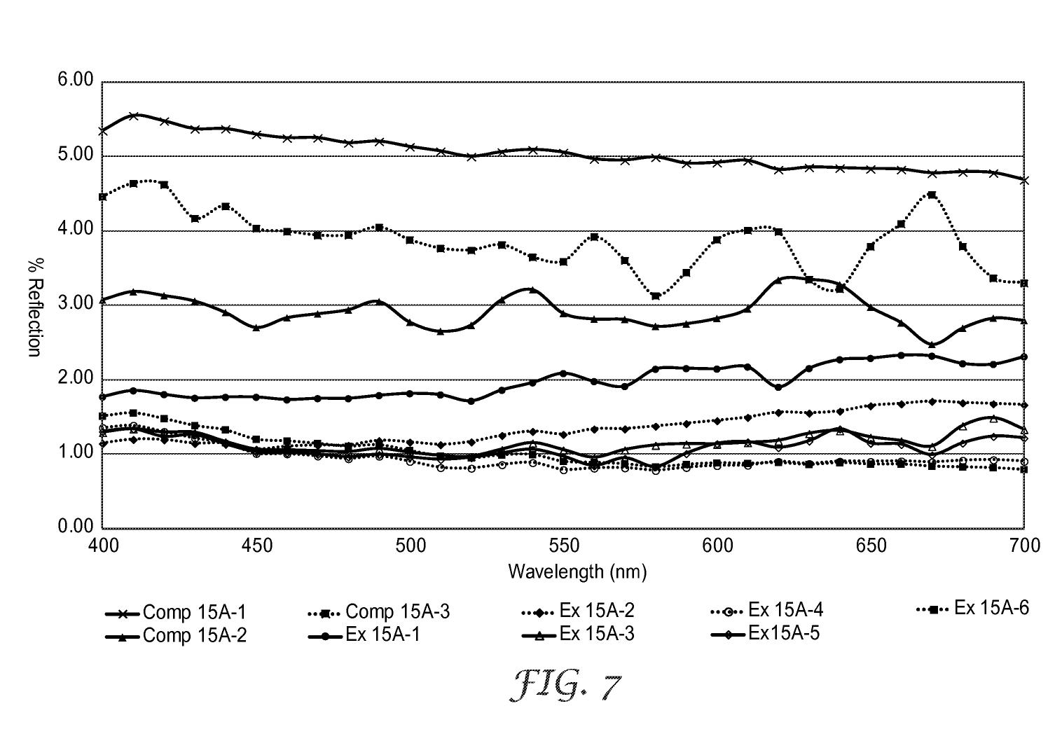

The general process for coating and processing the solutions followed the schematic drawing in FIG. 3A. The first coating solution was delivered to a 4 inch (10.2 cm) wide slot-type coating die. The first coating solution flow rate was adjusted to achieve the levels indicated in Table 10. After the solution was coated on a 0.005 inch (0.128 mm) thick polycarbonate (obtained from Rowland Technologies, Wallingford, Conn.), the coated web travelled a 10 ft. (3 m) span in the room environment, and then passed through two 5 ft. (1.5 m) long zones of small gap drying with plate temperatures set at 145° F. (63° C.). The substrate was moving at a speed of 10 ft./min. (305 cm/min.). Finally the dried coating entered a UV chamber equipped with a UV light source (from Fusion System) where H-bulb was used. The UV chamber was purged by a gas stream pre-mixed with nitrogen and a small volume of air. The flow rate of nitrogen was fixed at 328 liters/min. (11.5 scfm), and the flow rate of compressed air was adjusted to achieve the oxygen concentration in the UV cure chamber listed in Table 16, below. The oxygen concentration in the cure chamber was measured using an oxygen analyzer (Series 3000 Trace Oxygen Analyzer). FIG. 7 shows the percent reflection versus wavelength for the coatings in Table 16 (below) over the visible spectrum of light.

TABLE 16

| Example | Comp 15A-1 | Comp 15A-2 | Comp 15A-3 | 15A-1 | 15A-2 | 15A-3 | 15A-4 | 15A-5 | 15A-6 |
|---|---|---|---|---|---|---|---|---|---|
| Solution Flow | 0 | 4 | 5 | 4 | 5 | 4 | 5 | 4 | 5 |
| Rate (cc/min) | | | | | | | | | |
| Air Flow (lpm) | 0 | 0 | 0 | 9 | 9 | 19 | 19 | 24 | 24 |
| O2 (ppm) | 0 | 40 | 40 | 3900 | 3900 | 8200 | 8300 | 10000 | 10000 |
| Trans | 93 | 93 | 93 | 94.7 | 95.2 | 95.1 | 95.6 | 95.1 | 95.2 |
| Haze | 0.2 | 0.4 | 0.5 | 0.65 | 0.9 | 1.04 | 1.35 | 1.14 | 1.65 |
| Avg % R | 5.05 | 2.92 | 3.87 | 1.99 | 1.35 | 1.16 | 0.95 | 1.09 | 1.03 |
| 400 nm | 5.35 | 3.08 | 4.46 | 1.77 | 1.15 | 1.29 | 1.36 | 1.31 | 1.52 |
| 410 nm | 5.55 | 3.19 | 4.64 | 1.86 | 1.20 | 1.34 | 1.39 | 1.34 | 1.56 |
| 420 nm | 5.48 | 3.13 | 4.62 | 1.81 | 1.20 | 1.30 | 1.31 | 1.24 | 1.48 |
| 430 nm | 5.37 | 3.06 | 4.17 | 1.76 | 1.15 | 1.29 | 1.22 | 1.26 | 1.39 |
| 440 nm | 5.37 | 2.91 | 4.34 | 1.77 | 1.15 | 1.17 | 1.15 | 1.14 | 1.33 |
| 450 nm | 5.30 | 2.71 | 4.04 | 1.77 | 1.07 | 1.07 | 1.01 | 1.03 | 1.20 |
| 460 nm | 5.25 | 2.84 | 4.00 | 1.73 | 1.11 | 1.06 | 1.01 | 1.02 | 1.18 |
| 470 nm | 5.25 | 2.89 | 3.94 | 1.75 | 1.12 | 1.04 | 0.98 | 1.00 | 1.15 |
| 480 nm | 5.18 | 2.94 | 3.95 | 1.75 | 1.12 | 1.03 | 0.94 | 0.97 | 1.11 |
| 490 nm | 5.21 | 3.05 | 4.05 | 1.79 | 1.19 | 1.08 | 0.98 | 1.00 | 1.13 |
| 500 nm | 5.13 | 2.78 | 3.88 | 1.82 | 1.17 | 1.02 | 0.91 | 0.96 | 1.05 |
| 510 nm | 5.07 | 2.65 | 3.77 | 1.80 | 1.13 | 0.98 | 0.82 | 0.93 | 0.98 |
| 520 nm | 5.00 | 2.74 | 3.74 | 1.72 | 1.17 | 0.97 | 0.82 | 0.96 | 0.95 |
| 530 nm | 5.06 | 3.08 | 3.82 | 1.86 | 1.25 | 1.07 | 0.86 | 1.02 | 1.00 |
| 540 nm | 5.09 | 3.21 | 3.65 | 1.96 | 1.31 | 1.15 | 0.89 | 1.07 | 1.00 |
| 550 nm | 5.06 | 2.89 | 3.59 | 2.09 | 1.27 | 1.06 | 0.80 | 0.97 | 0.91 |
| 560 nm | 4.97 | 2.82 | 3.92 | 1.98 | 1.34 | 0.96 | 0.82 | 0.85 | 0.89 |
| 570 nm | 4.95 | 2.81 | 3.61 | 1.91 | 1.34 | 1.06 | 0.82 | 0.95 | 0.88 |
| 580 nm | 4.99 | 2.72 | 3.13 | 2.15 | 1.38 | 1.12 | 0.79 | 0.83 | 0.84 |
| 590 nm | 4.91 | 2.76 | 3.44 | 2.15 | 1.42 | 1.14 | 0.83 | 1.01 | 0.87 |
| 600 nm | 4.92 | 2.83 | 3.89 | 2.15 | 1.45 | 1.14 | 0.85 | 1.14 | 0.89 |
| 610 nm | 4.94 | 2.96 | 4.01 | 2.18 | 1.50 | 1.16 | 0.86 | 1.17 | 0.88 |
| 620 nm | 4.83 | 3.34 | 3.99 | 1.90 | 1.56 | 1.18 | 0.91 | 1.09 | 0.89 |
| 630 nm | 4.86 | 3.35 | 3.35 | 2.15 | 1.56 | 1.28 | 0.88 | 1.18 | 0.87 |
| 640 nm | 4.85 | 3.28 | 3.23 | 2.27 | 1.58 | 1.32 | 0.91 | 1.34 | 0.89 |
| 650 nm | 4.84 | 2.98 | 3.79 | 2.29 | 1.65 | 1.23 | 0.91 | 1.15 | 0.87 |
| 660 nm | 4.83 | 2.77 | 4.10 | 2.33 | 1.68 | 1.18 | 0.91 | 1.13 | 0.87 |
| 670 nm | 4.78 | 2.48 | 4.49 | 2.32 | 1.71 | 1.11 | 0.90 | 0.99 | 0.84 |
| 680 nm | 4.79 | 2.70 | 3.80 | 2.22 | 1.69 | 1.39 | 0.92 | 1.15 | 0.83 |
| 690 nm | 4.78 | 2.83 | 3.37 | 2.21 | 1.68 | 1.49 | 0.93 | 1.24 | 0.82 |
| 700 nm | 4.69 | 2.80 | 3.30 | 2.31 | 1.67 | 1.34 | 0.91 | 1.22 | 0.80 |

### Example 16

A prepolymer blend of pentaerythritol triacrylate, 1,6 hexanediol diacrylate, and isobornyl acrylate (“SR444,” “SR238,” “SR506,” respectively) in a 40:40:20 weight ratio was blended with a MPS modified 190 nm silica particles dispersion to form a 65:35 particle:prepolymer weight ratio. The functionality of the prepolymer blend was 2.09. The MS 190-3 modified particle solution (59.9 grams @ 42.2 wt. % solids), the above prepolymer blend (13.62 grams), 1-methoxy-2-propanol (4.23 grams) and IR 184 (0.3873 gram) were mixed together to form the coating solution (about 50 wt. % total solids and 1 wt. % PI, based on total solids).

Nipping uncured coating (see WO2009/014901 A2 (Yapel et al.), published 29 Jan. 2009, the disclosure of which is incorporated herein by reference) generated primary structure (e.g., micrometer size) and O₂ controlled cure generated secondary structure (e.g., nanostructure) on primary structure. This is an example of an antiglare, antireflection article.

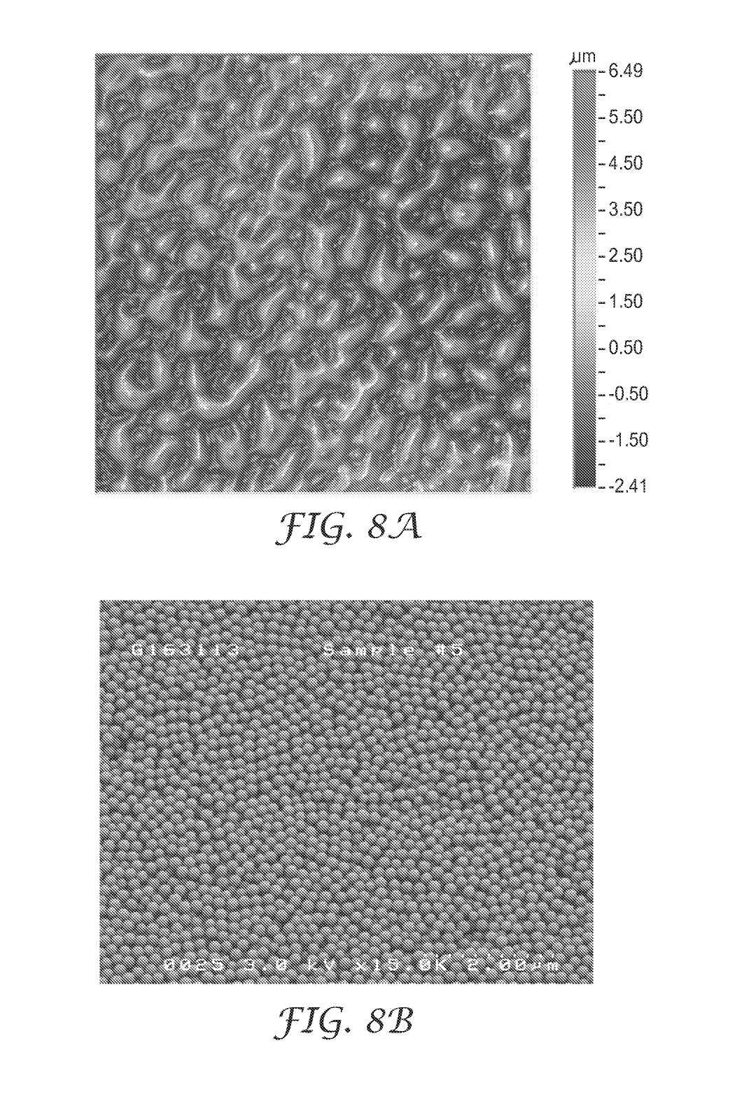

The general process for coating and processing the solutions followed the schematic drawing in FIG. 3A. The first coating solution was delivered at varying flow rates (cc/min.) to a 4 inch (10.2 cm) wide slot-type coating die. After the solution was coated on a 0.002 inch (0.051 mm) thick primed polyester, the coated web travelled a 10 ft. (3 m) span in the room environment, and then passed through two 5 ft. (1.5 m) long zones of small gap drying with plate temperatures set at 170° F. (77° C.). The substrate was moving at a speed of 10 ft./min. (305 cm/min) to achieve a wet coating thickness of about 10 micrometers. After exiting the second 5 ft. (1.5 m) drying zone the primary structure (Example 16A-3 was imaged using a interferometer (obtained under the trade designation “WYKO NT 9800” from Veeco, Plainview, N.Y.) in VSI mode. Stitching was used to obtain a 2 millimeter by 2 millimeter field of view as is shown in FIG. 8A) was formed by a nipping station which nipped the dried uncured coating between metal and rubber rollers, the rubber roller in contact with the coating. Finally the dried and primary patterned coating entered a UV chamber equipped with a UV light source (Model VPS/I600 from Fusion UV Systems Inc.) where H-bulb was used. The UV chamber was purged by a gas stream pre-mixed with nitrogen and a small volume of air. The flow rate of nitrogen was fixed at 314 liters/min. (11 scfm), and the flow rate of compressed air was adjusted to achieve the oxygen concentration in the UV cure chamber listed in Table 17. The oxygen concentration in the cure chamber was measured using an oxygen analyzer (Series 3000 Trace Oxygen Analyzer). The controlled oxygen cure generates a secondary structure (Example 16A-3 SEM photomicrograph is shown in FIG. 8B) on the primary structure.

Results of various tests are provided in Table 17, below. The average roughness, Ra, and root-mean square roughness, Rq, were measured for Examples 16A-3 and 16A-5. For Example 16A-3, Ra=1.1 micrometer and Rq=1.36 micrometer. For Example 16A-5, Ra=0.0151 micrometer and Rq=0.199 micrometer.

TABLE 17

| | | | Oxygen | | | | | |
|---|---|---|---|---|---|---|---|---|
| | Coating | Air | concentration | Nipping | | | | |
| | flow rate | flow rate | in UV chamber | station | Transmission | Haze | Clarity | Reflection |
| Example | (cm³/min.) | (liters/min.) | (ppm) | (on/off) | (%) | (%) | (%) | (%) |
| Comp. 16A-1 | 5 | 0 | 32 | off | 92.4 | 0.55 | 99.6 | 4.16 |
| Comp. 16A-2 | 5 | 0 | 27 | on | 92.7 | 2.93 | 64.6 | 3.95 |
| 16A-1 | 5 | 10 | 4700 | on | 93.7 | 5.31 | 63.7 | 2.01 |
| 16A-2 | 3 | 10 | 5100 | on | 94 | 8.74 | 61.4 | 1.73 |
| 16A-3 | 2 | 10 | 5000 | on | 93.9 | 9.42 | 45.4 | 1.79 |
| 16A-4 | 4 | 10 | 5000 | on | 93.5 | 9.19 | 64 | 1.87 |
| 16A-5 | 1.75 | 10 | 5000 | off | 94 | 3.99 | 99.7 | 1.54 |

Foreseeable modifications and alterations of this disclosure will be apparent to those skilled in the art without departing from the scope and spirit of this invention. This invention should not be restricted to the embodiments that are set forth in this application for illustrative purposes.

1. A material comprising submicrometer particles dispersed in a polymeric matrix, the material having a thickness, at least first and second integral regions across the thickness, the first region having the outer major surface, wherein at least the outer most submicrometer particles are partially conformally coated by the polymeric matrix, wherein the first and second regions have first and second average densities, respectively, and wherein the first average density is less than the average second density.

2. The material of claim 1, wherein, the difference between the first and second average densities is in a range from 0.1 g/cm³ to 0.8 g/cm³.

3. The material of claim 1, wherein the second region is free of substantially closed porosity.

4. The material of claim 1 having a Steel Wool Scratch Test value of at least 1.

5. The material of claim 1, wherein at least the outer most submicrometer particles are partially conformally coated by and covalently bonded to the polymeric matrix.

6. A method of making a material of claim 1, the method comprising:
providing a free radical curable layer having submicrometer particles dispersed therein; and
actinic radiation curing the free radical curable layer in the presence of a sufficient amount of inhibitor gas, to inhibit the curing of a major surface region of the layer
to provide a layer having a bulk region with a first degree of cure and a major surface region having a second degree of cure, wherein the first degree of cure is greater than the second degree of cure, and wherein the material having a structured surface that includes a portion of the submicrometer particles.

7. The method of claim 6, wherein the inhibiting gas has an oxygen content is 100 ppm to 100,000 ppm.

8. The method of claim 6, wherein all actinic radiation curing is conducted in a single chamber.

9. The method of claim 6, wherein a portion of the actinic radiation curing is conducted in a first chamber having a first inhibitor gas and a first actinic radiation level, and a portion of the actinic radiation curing is conducted in a second chamber having a second inhibitor gas and a second actinic radiation level, wherein the first inhibitor gas has a lower oxygen content than the second inhibitor gas, and wherein the first actinic radiation level is higher than the second actinic radiation level.

10. A material comprising submicrometer particles dispersed in a polymeric matrix, the material having a thickness, at least first and second integral regions across the thickness, wherein the first and second regions have first and second average densities, respectively, and wherein the first average density is less than the second average density, and wherein the material has a Steel Wool Scratch Test value of at least 1.

11. The material of claim 10, the first region having the outer major surface wherein at least the outer most submicrometer particles are partially conformally coated with the polymeric matrix.

12. A method of making a material of claim 10, the method comprising:
providing a free radical curable layer having submicrometer particles dispersed therein; and
actinic radiation curing the free radical curable layer in the presence of a sufficient amount of inhibitor gas, to inhibit the curing of a major surface region of the layer
to provide a layer having a bulk region with a first degree of cure and a major surface region having a second degree of cure, wherein the first degree of cure is greater than the second degree of cure, and wherein the material having a structured surface that includes a portion of the submicrometer particles.

13. The method of claim 12, wherein the inhibiting gas has an oxygen content is 100 ppm to 100,000 ppm.

14. The method of claim 12, wherein all actinic radiation curing is conducted in a single chamber.

15. The method of claim 12, wherein a portion of the actinic radiation curing is conducted in a first chamber having a first inhibitor gas and a first actinic radiation level, and a portion of the actinic radiation curing is conducted in a second chamber having a second inhibitor gas and a second actinic radiation level, wherein the first inhibitor gas has a lower oxygen content than the second inhibitor gas, and wherein the first actinic radiation level is higher than the second actinic radiation level.
